(19) United States
(12) Patent Application Publication
(10) Pub. No.: US 2010/0287050 A1
(43) Pub. Date: Nov. 11, 2010

(54) METHOD AND SYSTEM FOR PERSONALLY TARGETED SEARCH MESSAGES

(75) Inventors: Scott A. Jones, Carmel, IN (US); Voeuth Lay, Carmel, IN (US); Mark Gamache, Zionsville, IN (US); Jonathan K. Coulter, Indianapolis, IN (US)

Correspondence Address: STAAS & HALSEY LLP, SUITE 700, 1201 NEW YORK AVENUE, N.W., WASHINGTON, DC, 20005, US

(73) Assignee: ChaCha Search Inc., Carmel, IN (US)

(21) Appl. No.: 12/775,896

(22) Filed: May 7, 2010

Related U.S. Application Data
(60) Provisional application No. 61/166,939, filed on May 7, 2009.
(60) Provisional application No. 61/178,920, filed on May 15, 2009.
(60) Provisional application No. 61/182,323, filed on May 29, 2009.

(51) Int. Cl. G06Q 30/00; G06F 15/16

(52) U.S. Cl. 705/14.58; 705/14.49; 709/206

(57) ABSTRACT

A system and method for delivering peer to peer messaging on a demand basis is implemented. An originating user specifies a message and targeting information for the message. When a target user submits a request for information, a message is delivered to the target user. A message may include compensation for a target user. A message may include information regarding contacting an originator or a recipient of a message. A system and method enables a connection to be established between a user and a provider.

### CROSS-REFERENCE TO RELATED APPLICATIONS

This disclosure is related to and claims the benefit of U.S. patent application Ser. No. 12/275,864, inventor Scott A. Jones et al, entitled, “METHOD AND SYSTEM FOR IMPROVING UTILIZATION OF HUMAN SEARCHERS”, filed Nov. 21, 2008 and U.S. patent application Ser. No. 12/568,293, inventor Thomas E. Cooper, entitled “method and system for MANAGING USER INTERACTION” filed Sep. 28, 2009, and claims priority to U.S. Provisional Application Ser. No. 61/166,939, inventor Jonathan K. Coulter, titled “METHOD AND SYSTEM FOR ESTABLISHING A CONNECTION RESPONSIVE TO AN IDENTIFIER”, filed May 7, 2009, U.S. Provisional Application Ser. No. 61/178,920, inventor Scott A. Jones et al titled “METHOD AND SYSTEM FOR PERSONALLY TARGETED SEARCH MESSAGES”, filed May 15, 2009; and U.S. Provisional Application Ser. No. 61/182,323, inventor Scott A. Jones et al titled “METHOD AND SYSTEM FOR PERSONALLY TARGETED SEARCH MESSAGES”, filed May 29, 2009; the contents of all which are incorporated herein by reference in their entirety.

### BACKGROUND

1. Field of the Invention

Various embodiments described herein relate to search advertising systems and specifically to a method and system for targeting personal messages to a number of search service users.

2. Description of the Related Art

Generally, search engine technology has been very successful in providing information to people in various situations. Desktop search has become a dominant form of information delivery and access. Search services performed over 300 million searches per day in 2008. The need for information wherever a user is located has created a market for mobile search using various technologies. Some users opt for a traditional browser using a sophisticated device and a high bandwidth network, which is a reasonable approximation of a desktop experience. But due to the complexity and cost of a direct translation of desktop search to mobile search, other options have emerged. Search services such as Google® SMS, ChaCha's 242242® text search and others take advantage of the ubiquitous presence of Simple Messaging Service (SMS) to access a large consumer base.

Commercially successful search systems have generally been advertising supported. Advertising supported systems have been in use from the earliest sponsored telephone listings. Likewise, newspapers have traditionally defrayed part of the cost of publishing with advertising revenue. But in the case of search advertising, it is difficult to target a specific user or group of users. Advertisers select keywords in order to direct advertising to users who are requesting information regarding the keyword, in hopes that a product related to the keyword will be of interest. Because of the need for a large revenue stream, it is difficult for current advertising systems to appeal to small businesses and individuals.

Peer to peer (P2P) messaging systems have found popularity recently. The Twitter™ P2P messaging service allows a user to follow other users (or allow other users to follow the user). Similarly, messages may be exchanged through social networking sites such as the Facebook® or Linked-In® services. But such messages may arrive asynchronously and at times when it is inconvenient to receive the messages. The negligible cost of text messaging and emailing often leads to nuisance messaging or ‘Spam’.

Due to these problems, what is needed is a method and system whereby a search advertising message from an originating user may be targeted to a recipient user which is delivered during interaction with a search service. Because a recipient user has already made the decision to engage in a search, it is likely that they are more open to receiving other messages as well, including advertisements, personals, ‘shout-outs’, classified ads, and other messages.

### SUMMARY

According to an embodiment a method of delivering personalized advertising includes receiving a message for delivery from an originator and triggering the delivery of the message to a recipient in response to receiving a request from the recipient. An embodiment is directed to a system of delivery a message and/or personalized advertising.

Another embodiment is directed to enabling a communication between a user and a provider including based on a message submitted by the user which may cause a live connection to be established between the user and the provider identified by the message.

Additional aspects and/or advantages will be set forth in part in the description which follows and, in part, will be apparent from the description, or may be learned by practice of the invention. These together with other aspects and advantages which will be subsequently apparent, reside in the details of construction and operation as more fully hereinafter described, reference being had to the accompanying drawings forming a part hereof, wherein like numerals refer to like parts throughout.

### BRIEF DESCRIPTION OF THE DRAWINGS

Aspects and advantages of the disclosure will become apparent and more readily appreciated from the following description of the embodiments, taken in conjunction with the accompanying drawings, of which:

FIG. 1 is a block diagram of an exemplary system embodiment.

FIG. 2 illustrates a database for a target user.

FIG. 3 illustrates a database for a guide.

FIG. 4 illustrates a database for an advertiser.

FIG. 5 illustrates a database for an advertisement.

FIG. 6 illustrates a database for an originating user.

FIG. 7 illustrates a database for a personal advertisement.

FIG. 8 illustrates a database for a request.

FIG. 9 illustrates a database for a category.

FIG. 10 illustrates a database for a profile.

FIG. 11 is a flowchart of processing an information request.

FIG. 12 is a flowchart of processing a personal advertising campaign request.

FIG. 13 is a flowchart of processing an advertisement request.

FIG. 14 illustrates a graphical user interface (GUI) for individual targeting.

FIG. 15 illustrates a GUI for group targeting.

FIG. 16 illustrates a GUI for billing.

FIG. 17 illustrates a GUI for payment.

FIG. 18 illustrates a message flow for an originator to single user personal message.

FIG. 19 illustrates a message flow for an originator to multiple user and response personal message.

FIGS. 20A and 20B illustrate message flows for a personal message activity and frequently asked questions (FAQ) which may be provided to users.

FIG. 21 is a block diagram of an exemplary system embodiment.

FIG. 22 illustrates a database for a user.

FIG. 23 illustrates a database for a guide.

FIG. 24 illustrates a database for an advertiser.

FIG. 25 illustrates a database for an advertisement.

FIG. 26 illustrates a database for an information request.

FIG. 27 illustrates a database for a connection request.

FIG. 28 is a flowchart of processing an information request.

FIG. 29 is a flowchart of processing a connection request.

FIG. 30 illustrates an exemplary sequence of messages and connections.

FIG. 31 is a flowchart of a process of responding to a request.

FIG. 32 illustrates an exemplary sequence of messages which may establish a connection between a user system and a provider system.

### DETAILED DESCRIPTION OF THE PREFERRED EMBODIMENTS

Reference will now be made in detail to the present embodiments discussed herein, examples of which are illustrated in the accompanying drawings, wherein like reference numerals refer to the like elements throughout. The embodiments are described below to explain the disclosed system and method by referring to the figures. It will nevertheless be understood that no limitation of the scope is thereby intended, such alterations and further modifications in the illustrated device, and such further applications of the principles as illustrated therein being contemplated as would normally occur to one skilled in the art to which the embodiments relate. As used herein words importing the singular shall include the plural and vice versa unless specifically counter indicated.

A message or advertisement may be targeted to a user and/or group of users based upon user profiles which might include information of location, age, gender, user identifiers, and/or other data. When a user interacts with a search service, a targeted message or advertisement is delivered to the user (the ‘recipient user’, ‘target user’ or ‘recipient’) based on targeting information. The message or advertisement may be unrelated to a subject matter of a request received from the recipient of the message. A user originating a message or advertisement (the ‘originator’) may compensate a search service for sending a number of targeted messages to recipient users (which might include the originating user). A recipient user associated with a targeted message may receive compensation for accepting the message. A targeted message may include a response instruction. If a recipient user responds to a targeted message, compensation, discounts, and/or offers may be provided to the recipient. If a recipient user responds to a targeted message, an anonymous message may be sent to the originating user of the targeted message. A facility may be provided to allow a message to be targeted to a single target user. A facility may be provided to allow a message to be targeted to users who meet a set of criteria including location, age, gender, and/or other personal characteristics and/or a category and/or a keyword of a search request.

A system is provided whereby a user or information seeker may submit a request for information or search request, query, or “request” to a search system which determines whether a human assistant, and/or “guide”, is required to provide a response to the search request. If a guide is required to respond to a request, the guide may be selected based on keyword(s), categories, profiles, and/or other information associated with the request and/or the guide. Information resources or search resources, or “resources”, which may assist a guide in obtaining a search result may be matched to a search request and may be provided to the guide to facilitate a search. A search result, or “result”, which may include any type of media, information, software, etc., which may be provided to the user responsive to a search request. A search result may include an advertisement. An advertiser may provide advertising media to a search system, and may provide payment(s) to the search system responsive to delivery of advertisements to users. An advertising server may be provided to store and serve advertising materials submitted by users and/or advertisers.

A database is provided which includes records associated with various items which may include internal information of a search system such as keywords, categories, profiles, etc., and/or external objects or entities such as users, guides, advertisers, resources, and/or systems and/or devices associated with an object, person or entity. Information indicated in a database may be used to track, record, and optimize usage of any items identified in the database. For example, ratings of guides associated with a category may be used to rank the guides to select a guide to respond to a query associated with the category. Likewise, ratings associated with advertisements might be used to select an advertisement to be presented to a user responsive to a query in order to optimize user response rate and revenue for a search system or publisher.

A sponsored message may be delivered as part of a response to a request for information. A first user, or “originator”, may select targeting information which may allow a personal message or advertisement to be delivered to a qualified recipient associated with the targeting information when the recipient receives a response to a request for information or search result. As a message or advertisement may be delivered in response to a request by a recipient, the recipient is not flooded with unwanted messages that might be considered a nuisance. This mechanism allows a recipient user to receive search result(s), message(s), and advertisement(s) at a time when the recipient user chooses. A barrier to unwanted messaging may be created as a message may be delivered on a cost per message basis. For example, if a message costs $0.10 to be delivered, nuisance messages may be discouraged by the cost for delivery, while an originator desiring to contact a particular user may be less concerned with cost.

A system is provided whereby a search system may receive requests from users, and may provide a search result to the (recipient) user. An originating user may elect to provide a secondary or “personal ad” message to a user or group of users, (i.e., target users). A personal ad may be delivered to a target user based on a phone number, login ID, or other communication service information associated with the target user. A personal ad may be targeted to a group of users based on information such as area code, zip (postal) code, neighborhood, gender, or other affiliation (such as high school, college, neighborhood, interest group, etc.) which may be known to a search service. Such a system may allow a group to receive a message such as ‘today is Coach Tony's birthday’ or ‘happy Mother's Day to all the moms in Riverdale’ based on group targeting information. Likewise, location based targeting could be used to send a message to a neighborhood about a lost pet, etc.

A system includes a target user device submitting queries and receiving a result, a network connecting the components of the system, a personal advertisements database storing and retrieving personal ads and targeting information, an originating user system for creating and targeting a personal ad, (optionally) a guide system receiving a request, a search system providing a search result, a search service enabling communication between the other components of the system, and a database storing information used to select items and establish communication between elements of the system.

An originating user connects to a search system to create a personal advertising account using an originating user system, which may utilize a web browser functionality of the originating user system. Alternatively, an originating user may perform those functions by being connected to a call center and providing that information via voice. Alternatively, this information could be provided via email, instant message, or other forms of communication. An originating user provides ‘campaign’ information for delivery of personal messages or personal advertisement(s) which may include targeting information for a personal ad, content of the personal ad, response information, payment information, and a time frame for the personal ad to be delivered. After campaign information is provided, a campaign is reviewed and activated. If a target user submits a search request, a personal advertisement (ad) or message may be delivered to a target user. A target user may receive any suitable type of messaging and/or media as a personal advertisement.

In at least one embodiment, a target user who receives and/or responds to a personal advertising message may receive some type of compensation, discount, points, and/or offer. For example, a target user might receive unlimited search services, a subsidized or free activity, product, or service, and/or other forms of compensation. A target user might accumulate compensation based on a number of personal messages or personal ads received, or a number of responses, etc.

An originating user may elect to send various types of messages. For example, a ‘trailer’ message (i.e., a message appended to a longer message), an ‘interstitial’ message, a picture or video message, or other form of media might be made available to an originating user for purchase and incorporation into a personal advertising message. Likewise, a number of messages might be allocated to various media and messaging types. An originating user may purchase or acquire a block of personal messages which may be used for any purpose. An originating user may elect to change messaging and/or targeting of messages within a block of personal messages. In the case of purchasing or acquiring a block of messages, an originating user may be allowed to change a message based on time and/or based on conditions associated with a target user so that a target user may receive different messages dynamically. A target user may receive different personal messages based on previous messages received and/or responses provided. For example, if a target user positively responds to the question ‘do you want to meet me?’, a second message such as ‘send me a photo of yourself’, might be sent regardless of the date or time of a response. Alternately, a message might be modified or adjusted based on time or calendar information so that a ‘Tom's birthday is Friday’ message might change to ‘Today is Tom's birthday’, ‘Hope Tom had a great birthday!, etc. According to an embodiment, an originating user may be the same as an advertiser, or may be different (independent) of an advertiser. For example, an originating user may use content generated by an advertiser to create a message for a recipient. An originating user is typically an individual, rather than a commercial entity as would be the case with an advertiser. A message from an originating user will typically have higher probability to be delivered than an advertisement from an advertiser. This may be determined based on payment for an advertisement and/or based on a higher priority applied to a personal message or personal advertisement.

An originating user may be offered an opportunity to send a ‘response’ message to any number of target users. For example, an originating user may elect to send a message based on a group of phone numbers from a personal contacts list (e.g., a birth announcement, or graduation, etc.) or to an area code, zip code, and/or any group which has a distinguishing characteristic. A personal advertisement may include a response code, keyword and/or identifier which may cause a secondary action to occur responsive to receipt of the code or keyword from a target user, and/or from any user. For example, an originating user might target an advertisement for a lost dog to persons in a neighborhood and include a reply keyword if a target user has seen the dog with the advertisement. If the keyword (e.g. FOUNDHIM) is received from a target user, a communication session might be arranged between an originating user and the target user. Communication between an originating user and a target user may be anonymous in one and/or both directions in order to preserve privacy and/or for any reason in the same manner as is applied to other forms of personal advertisements. An anonymous connection may occur via a response code that causes an anonymous voice call connection between parties. In at least one embodiment, an originating user may elect to receive responses immediately and may be able to immediately (rather than in a cached mode) contact a target user who has responded to a personal advertisement or advertisement. In at least one embodiment, an originating user may send a personal advertisement to any target users who may have responded to a previous message. Using the example of the lost dog, an originating user might send a message of appreciation to any respondents (i.e., target users who had replied with the response code) if the dog was found.

An alternate form of targeting of personal messages might be used to establish a type of forum. For example, an originating user might send a message based on a zip code, which requested responses (e.g., ‘Who is an Indians fan? Reply Cleveland’) to the zip code 40205. Target users who reply might become a designated target group, which information might be made available (e.g., Indians fans in 40205) to advertisers for targeting.

A user interface (UI) is provided to an originating user in order to provide targeting information, content, timing and payment information. A user interface may be based on text messaging. For example, if an originating user has already established a payment mechanism, the originating user may create a personal advertisement by sending an SMS message to a search system. Similarly if an originating user has an inventory of available personal advertisements or messages, the originating user may create an advertising campaign using the inventory. A web-based interface may be provided which includes controls for selection of a message, a target user, notifications such as delivery, low inventory, etc., using various communication services associated with an originating user. The UI includes payment information and offers for various purchase packages. A user interface may provide templates with pre-determined greeting messages which may be used to make creation of content and the review process easier. Information which defines content, timing, targeting, responses, compensation, and/or other aspects relating to an advertisement may be referred to as a campaign. In at least one embodiment, a review task may be presented to a person as a notification message. For example, a guide and/or a system administrator of a search service might review a personal advertisement.

In at least one embodiment, an originating user may provide registration and payment information by a voice service. For example, a user might receive a text message which includes a response code (e.g. ‘SHOUTME’). If a user sends ‘SHOUTME’ keyword in a text message, a voice connection might be established with the user in order to obtain registration information required for the user to become an originating user. Similarly, if a user is not registered to be an originating user, but sends a message which would be interpreted as a personal advertisement if the user were an originating user, a search system might contact the user by voice service and/or other communication service in order to register the user as an originating user.

Any personal advertising message campaigns may be reviewed prior to being activated. A review process may be applied to enforce various forms of editorial control. Use of templates, blocked word lists, and/or other automation techniques may be applied to decrease the cost of review. A human aided review may be conducted when a campaign is created and/or modified. For example, a guide and/or other resources of a search service may be utilized to provide a review of an advertising campaign. For example, a reviewer may receive a notification message which may include a link to a review page, might receive text of a personal advertising message, or otherwise be informed of a campaign, etc. This may allow review of content to be performed as a micro task by any person who may be contacted by a search service. If a campaign is rejected on review, notification may be provided to an originating user associated with the campaign. For example, an SMS, email, IM, etc., may be sent to an originating user regarding a rejected campaign. An originating user may modify a campaign based on rejection information.

An originating user may pay for a personal message or advertisement in various ways. A credit or debit card, PayPal and/or and form of on-line payment may be used. A user might pay for personal advertising messages using a Mobile Originated (MO) and/or Mobile Terminated (MT) billing from a phone carrier, might use a monthly subscription fee from a mobile phone carrier, a search service, a third party, etc.

An originating user may elect to acquire one message or an unlimited number of messages. An originating user may be allowed to revise content of a message and/or targeting as inventory of messages is utilized, or as conditions change. For example, a birthday message might be supplanted by a holiday message, which is supplanted by an event message.

In at least one embodiment, an originating user may send a message to multiple persons. For example, people associated with a geographic area might be targeted, or people associated with a club or organization might be targeted. An originating user may target a group associated with an existing social network such as a Facebook® or Twitter™ network which may be accessed by the originating user. Targeting to a social network may allow a user to share messaging within a group composed of known members and/or unknown members. A social network may also be created using a personal messaging system. For example, an originating user may send a ‘shout’ which may receive responses from target users which may then allow a responding target user to originate a message which may be directed to target users that responded to a previous personal message.

In at least one embodiment, an originating user may create an advertisement similar to a classified advertisement wherein a service, product, item, etc., is offered and/or requested. As a target user replies, an originating user may respond anonymously and/or directly. An originating user may target to a specific group of respondents, etc. For example, an originating user might request lawn mowing services, which might receive multiple responses. If a first target user to respond is selected and later did not work out, an originating user might send a message to any number of target users who previously responded. Similarly, by responding to a message associated with a particular classification, a target user might elect to receive future messages regarding similar offers. Targeting to a historical group of respondents allows an originating user to more effectively deliver messages to target users who have previously shown interest in a particular type of message.

A personal advertisement is intrinsically personal, so it is also envisioned that dialogue between originating users and target users is likely to be an integral part of the user experience with a personal messaging service. If a target user receives a personal advertising message such as a birthday greeting, or an anniversary message, etc., the target user may desire to ‘shout back’ to the originator, even if the originator is anonymous. In such an embodiment, a search system acts to cache an original message until the message may be delivered with an access to the system by a target user, and subsequently receive a response message from a target user which may be delivered to an originating user immediately and/or on as part of an interaction with the search service.

A personal advertising message may be delivered based on a ranking of messages available for a target user. Any personal advertising messages may be ranked higher than any commercial messages. Any personal advertising message may be ranked based on a bid price associated with the personal ad, and other advertising messages. Any type of inventory information associated with messages available to be delivered to a target user may be used to select an advertising message to be delivered to the target user. For example, if multiple commercial messages are associated with a keyword of a request by a user, a personal advertising message might be ranked higher even if a CPM (Cost per Impression) of the personal advertisement is not as high as the CPM of the commercial messages, or the personal advertising message might be treated equally with any commercial messages, etc.

It may be that an originating user may misuse an advertising service to send unwanted messages to a target user. To avoid this problem, a target user may selectively block personal advertising from any originating user, even if the originating user is unknown to the target user. For example, political, religious and/or any forms of messaging which may be undesired may be blocked by a message from a target user.

A user may acquire a number of credits in various ways. A personal advertising message may allow a target user to receive a service, as previously mentioned. In at least one embodiment, if a user submits a request for information to a search service, the user may be required to pay for the service on a pay-per-use basis, or the user may be permitted a limited number of requests in a time period after which a payment is required, etc. If a user is a target user, an originating user may defray the cost of a request by sending a personal advertising message to the user. Similarly, a target user may accumulate credits for later usage. For example, a target user may respond to a personal advertising message which may send a response to an originating user, who may provide compensation such as a usage credit, etc., to a target user.

A user may allocate credits to other users. For example, a user might purchase or otherwise acquire a number of personal advertisements, which the user could utilize for messages delivered to one or more target users. An originating user might elect to be a target user for a personal message of the originating user in order to have access to a pay per use service. An originating user might control usage of a pay per use service by designated target users. For example, a parent might control a number of uses of a service on a monthly basis by allocating credits to a child's device account.

While the personal advertising service is described in the context of use in a messaging environment such as SMS or MMS, it is foreseen that the system might be used with multiple communication services associated with a target user. If a user is associated with IM, voice, a login ID, email, etc., a targeted personal advertising message which is suitable to the services which provide a search result may be delivered. For example, if a target user submits a request for information using a web portal, a personal advertising message might be delivered to the user using the web portal.

As used herein, a “request” means a request for information, products, and/or services. A request or search request or query may include various types of media, and may be provided by any user system which may establish communication with a server or other devices associated with a search service.

A “user” is a person who submits a request and may receive any type of information responsive to a request. A “guide” or searcher is a human assistant who may perform a task to assist in obtaining a search result. A “transcriber” guide may convert a spoken request into a text request and/or vice versa. An “expediter” guide may categorize, clarify, modify, and/or otherwise process a request, which may assist in the processing of the request. A “generalist” guide may perform a search for information responsive to a request which is broadly categorized. A “specialist” guide may perform an information search responsive to a request which is narrowly categorized. Any guide may perform any tasks associated with various designations of guides who perform a task to assist in processing a request. In at least one embodiment, guide roles may be partially mutually exclusive. For example, an expediter might not be allowed to function as a specialist, but might be allowed to function as a transcriber.

A “merchant” is a person and/or entity which may supply a product and/or service. A “provider” is a person and/or entity which may obtain a service and/or product for a user. A provider may be a merchant, and/or may be an intermediary who may conduct a transaction on behalf of a user. For example, a guide acting in a concierge role might obtain a product and/or service from a website responsive to a user request in which case the guide is a provider and a provider of the website is a merchant. Likewise, a user might be directly connected to a merchant in which case the merchant is a provider.

An “advertiser” is any person and/or entity which may provide promotional information or “advertisements” to be delivered to a user or published. An advertisement may be an announcement, declaration, notice, endorsement, etc. An advertisement may take various forms and/or may include media of any sort which can be delivered to a user device. A “resource” or search resource may be an automated system, a person, a database, and/or any other source of information which may be used to obtain a “result” or search result. A search result is any information which has been determined to be a response to a request. A search result may include an advertisement.

The terms “voice” and “speech” are used interchangeably herein. A user, a resource, an advertiser, a provider and/or a guide may establish a communication session using a voice service, a messaging service such as Short Messaging Service (SMS), Enhanced Messaging Service (EMS), Multi-media Messaging Service (MMS), Instant Messaging (IM), email, an internet portal or web page, regular mail and/or any other type of communication. A connection or communication session may be established using any device which is capable of utilizing a communication service. For example, a wireless device such as a cell phone, PDA, smart phone, etc., might be used to establish a communication session using voice, SMS, IM, email and/or internet protocols. A desktop, laptop or server system might be used to establish a communication session. A landline phone, a specialized communication terminal, or any other communication device might be used to establish a communication session.

Communication between a guide, a user, an advertiser, a provider, a resource and/or a search system may include conversion of text to speech and speech to text. Any type of conversion and/or other processing of information which may facilitate communication between a user, a guide, an advertiser, a provider, a resource and/or a search system may be performed. Any type of media which can be sent and/or received using a communication system may be part of a communication session. A communication session may be conducted using any or all communication services associated with a user, an advertiser, a provider, a resource and/or a guide. Any communication session may include communication via multiple services and/or devices. For example, a request may be submitted as a voice query, which might indicate an image located on a resource accessible to a user and/or a guide, the voice query might be converted to a text message, the image might be processed in order to associate a tag and/or other images with the image, and a response might be provided as a spoken reply to a mobile phone associated with a user, and a video presentation which is accessible via a high-speed connection, which might be delivered to a browser functionality of a different user device.

An advertisement may be transmitted including during any or all communication sessions. A resource, a guide, an advertiser, a user and/or an advertisement may be rated. Rating information may be obtained from a user, a guide, an advertiser, a resource and/or a search system. Rating information may be used to select a resource, a guide, a provider, an advertisement and/or any item based on information associated with an item indicated in a database. A search service may be compensated by advertising revenue. Advertising and/or content may be delivered to a user, an advertiser, a provider, and/or guide using any service associated with a user, an advertiser and/or a guide.

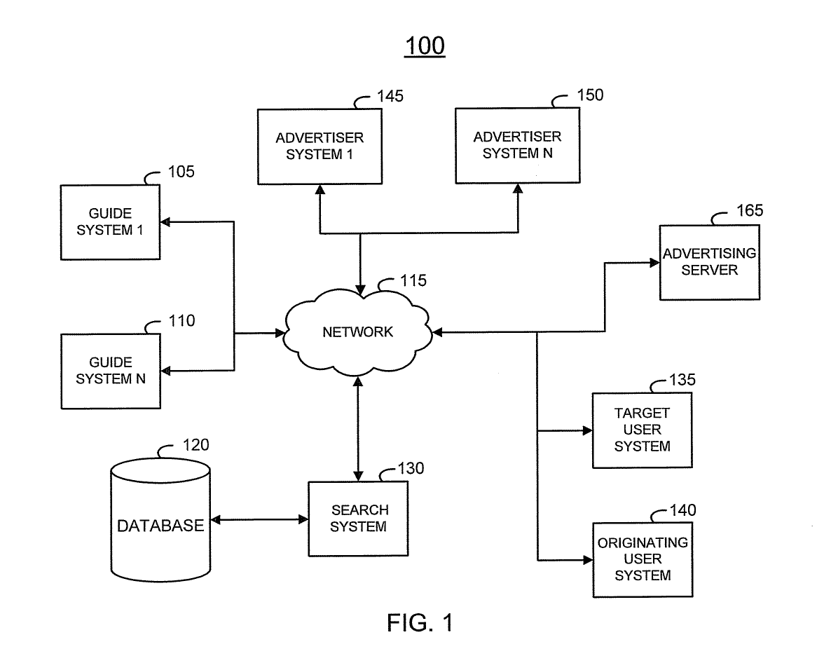

As illustrated in FIG. 1, system 100 may include guide systems 105, 110, a network 115 such as the Internet, a search system 130, a target user system 135, an originating user system 140, a database 120 which may comprise various records, advertiser systems 145, 150, and advertising server 165.

While only a few systems associated with a guide, user, advertiser, advertising server, and as a search system are depicted in FIG. 1, it is within the scope of the disclosure for multiple systems for guide, user, advertiser, advertisement server and search systems to be utilized. In particular it is envisioned that many guide, user, and advertiser systems may be implemented. The search system 130 may be a composed of any number components as described further herein.

Any user system (e.g. the target user system 135 or the originating user system 140) can be used to submit a search request to the search system 130, receive a search result, and/or other information. Any guide system (e.g., the guide system 105) can be operated by a human searcher to obtain a search result responsive to a request which may have been submitted by an information seeker located at a user system (e.g., the target user system 135).

The network 115 may be a global public network of networks (the Internet) and/or may consist in whole or in part of one or more private networks. The network 115 communicatively couples the guide systems 105, 110, the user systems 135, 140, the advertiser systems 145, 150, and the advertising server 165 with the other components of the system 100 such as the search system 130, and the database 120. The network 115 may include one or more wireless networks which may enable wireless communication between the various elements of the system 100. A wireless service carrier may receive messages from a user device via a wireless network which is a part of the network 115 and provide the messages to a wireless messaging aggregator via an internet connection which is part of the network 115. A wireless messaging aggregator may provide user messages to the search system 130 via an Internet Protocol (IP) connection. The same routing might be used in reverse in order that the search system 130 may provide a message to the target user system 135 using the network 115. Similarly a voice communication via wired and/or wireless communication might be established between any elements of the system 100 using the network 115.

The search system 130 allows interaction to occur among the guide systems 105, 110, the user systems 135, 140, the advertiser systems 145, 150, and the advertising server 165. For example, an information search query or request can be transmitted from the target user system 135 to the search system 130, where a search query can be accessed by the guide system 105. Similarly, a search result produced using the guide system 105 in response to a search query submitted by the target user system 135 may be transmitted to the search system 130, where it may be stored by the search system 130 and/or may be transmitted to the target user system 135. An advertisement might be obtained from the advertising server 165 and transmitted to the target user system 135 as an SMS or MMS message. Any type of communication between a user, a guide, and an advertiser may be mediated and/or facilitated by the search system 130, and/or other elements of the system 100.

The search system 130 is communicatively coupled with the database 120. As will be described herein in further detail below, the database 120 may include persistently stored information that is processed in association with operation of the embodiments. Although FIG. 1 illustrates the database 120 as a separate component of the system 100, the database 120 may be integrated with the search system 130. Further, the records maintained in the database 120 may be stored in any typical manner, including in a Network Attached Storage (NAS), a Storage Area Network (SAN), etc., using any typical or proprietary database software such as DB2®, Informix®, Microsoft® SQLServer™, MySQL®, Oracle®, etc., and may also be a distributed database on more than one server. Elements of the database 120 may reside in any suitable elements of the system 100. Any or all elements of the system 100 may include any part or the entirety of the database 120.

The guide systems 105, 110, the user systems 135, 140, the advertiser systems 145, 150, and the advertising server 165 may include equipment, software, systems and personnel required to send and/or receive messages between a user system, a guide system, an advertiser system, and/or the search system using the network 115. The database 120 includes information which may allow the search system 130 to establish communication between any or all of the elements of the system 100.

A user system, a guide system, an advertiser system, an advertising server and/or a resource may be a desktop or portable PC or Mac®, a mobile phone, a smart phone, a PDA, a server system, a landline phone, a specialized communication terminal, a terminal connected to a mainframe, or any other communication device and/or system. The search system 130 may include one or more servers, computers, etc. For example, servers such as the PowerEdge® 2900 by Dell, or the BladeCenterJS22 by IBM, or equivalent systems might be used to implement elements of the search system 130. The search system 130 may utilize an operating system (OS) such as Microsoft Windows XP, or Linux, etc. Voice routing and packet switching may be accomplished using well established technologies such as those provided by Cisco, or other networking companies. After being presented with the disclosure herein, one of ordinary skill in the relevant art will immediately realize that any viable computer systems or communication devices known in the art may be used as user systems, guide systems, advertiser systems, advertising servers, resources, voice routing systems, message routing systems, and/or to implement the search system 130.

A guide may be required to register with the search system 130. As part of a registration process, at least one communication method is associated with a guide. In at least one embodiment, a guide may register with the search system 130 and establish a username and password which are associated with the guide. A guide may login to the search system 130 using a web browser functionality of the guide system 105 in order to communicate with the search system 130. Multiple communication services may be associated with a guide and may allow a communication session to be established between a guide system such as the guide system 105 and a user system, a resource and/or the search system 130. Multiple identifiers of a guide may be associated with each other. Information such as IM credentials, an email address, a phone number, a URL, a username, etc., of a guide may be identified which may allow the search system 130 to establish a communication session between a guide system and a user system, a resource, an advertiser system, and/or the search system 130.

When a guide registers with the search system 130, the guide may be associated with one or more keywords, categories, and/or other information. For example a keyword or category may be selected by a guide, or may be associated with a guide based on a test administered to a guide and/or other information provided during and/or after a registration process. Information associated with a guide may be stored in the database 120 and may be used for purposes such as matching a guide to a user request, determining and/or providing compensation for a guide, communicating with a guide, etc., as will be described further herein below. A guide may be associated with one or more advertisers. Registration and/or other information of a guide may be provided by an advertiser and/or other third party.

A user may be identified by the search system 130. When a user system such as the target user system 135 establishes a communication session with the search system 130, an identifier of a user system is determined. An identifier of a user system may be associated with other information regarding a user. A user system may be identified using an email address, a telephone number, an IM credential, a username, an IP address, a ‘cookie’ and/or any other identifier which may be used to associate information with a user. Multiple identifiers of a user may be associated with each other. Using information of communication services associated with a user, a communication session may be established between a user system such as the target user system 135 and a guide system, an advertiser system, a resource and/or the search system 130. Information such as a keyword, a category, a user profile, a previous search request, a search result etc., may be associated with a user. Information of a user may be stored in the database 120.

A resource, which may be a person, an entity, a search engine, a database, a software application, a corpus of one or more types of media such as text or printed information, images, audio, video, etc., or a combination thereof, may be identified by the search system 130. Any source of information may be a resource within the context of the disclosure herein. Information of at least one method of communication is associated with a resource which allows a communication session to be established between the search system 130, the user systems 135, 140, the advertisement server 165 and/or the guide system 105, 110 and the resource. An identifier of a resource may be associated with other information regarding a resource. A resource may be identified using an email address, a telephone number, an IM credential, a resource username, a URL or other persistent identifier which may be used to associate information with a resource. Multiple identifiers of a resource may be associated with each other. Using information of communication services associated with a resource, a communication session may be established between a resource and a user system, a guide system, an advertiser system, and/or the search system 130. Information such as a keyword, a category, a profile, and/or other information may be associated with a resource. Information of a resource may be stored in the database 120.

A resource may include any systems, software, hardware, personnel and/or other facilities which may provide information to a guide, a user, an advertiser and/or the search system 130. For example, a resource may be a search engine, a database system, a library, a personal hard drive and/or other local storage, printed materials, recordings of any sort, a software program, a person or persons, an organization, etc. A resource may be freely accessible to any user, advertiser, system, and/or guide and/or may be available on a restricted basis. A resource may include resources which are available on an unrestricted and/or restricted basis. A resource may not be accessible using the network 115, but may be accessible to a selected guide, user, and/or advertiser.

An advertiser may be required to register with the search system 130. As part of a registration process, at least one communication method is associated with an advertiser. In at least one embodiment, an advertiser may register with the search system 130 and establish a username and password which are associated with the advertiser. An advertiser may login to the search system 130 using a web browser functionality of the advertiser system 145 in order to communicate with the search system 130. Multiple communication services may be associated with an advertiser and may allow a communication session to be established between an advertiser system such as the advertiser system 145 and a user system, a guide system, an advertising server, a resource system and/or the search system 130. Multiple identifiers of an advertiser may be associated with each other. Information such as IM credential, an email address, a phone number, a URL, a username, etc., of an advertiser may be identified which may allow the search system 130 to establish a communication session between an advertiser system and a user system, a guide system, an advertising server, a resource, and/or the search system 130.

When an advertiser registers with the search system 130 the advertiser may be associated with one or more keywords, categories, and/or other information. For example a keyword or category may be selected by an advertiser, or may be associated with an advertiser based on activities of an advertiser and/or persons associated with an advertiser and/or other information provided during and/or after a registration process. Information associated with an advertiser may be stored in the database 120 and may be used for purposes such as matching an advertiser to a request, a user, a guide, etc., determining and/or obtaining compensation from and/or for an advertiser, communicating with an advertiser, etc., as will be described further herein below. An advertiser may be associated with one or more guides. Registration and/or other information of an advertiser may be provided by a guide and/or other person. An advertiser may provide information of a resource which may be associated with the advertiser, and/or may provide access information for a resource.

An advertiser system may provide information of any type of content and/or other information which may be associated with sponsorship information. For example, audio, video, web pages, interactive games, software, etc. which might be sponsored by an advertiser may be provided by an advertiser system such as the advertiser systems 145, 150.

The advertising server 165 may be provided by a third party advertising service such as DoubleClick or other similar services. An advertising server may provide advertisements approved and/or created by advertisers to publishers. In at least one embodiment, the advertising server 165 provides advertisements to the search system 130. Advertisements may be obtained from multiple advertising servers. Advertisements which are indicated in the database 120 may be compared to advertisements provided by an advertising server. A URL, login ID and password, and/or other information associated with an advertising server may be stored in the database 120. An advertiser may designate information of an advertising server which is to be used to provide advertisements. Multiple communication services may be associated with an advertising server and may allow a communication session to be established between an advertising server such as the advertising server 165 and a user system, a guide system, an advertiser system, a resource system and/or the search system 130. Multiple identifiers of an advertising server may be associated with each other. Information such as IM credential, an email address, a phone number, a URL, a username, etc., of an advertising server may be identified which may allow the search system 130 to establish a communication session between an advertising server and a user system, a guide system, an advertiser system, a resource, and/or the search system 130.

The search system 130 may establish a communication session between any user system, guide system, advertiser system or resource using information indicated in the database 120. For example, the target user system 135 may establish a voice communication session with the search system 130, the search system 130 may establish a voice communication session between the target user system 135 and the guide system 105, and the search system 130 may establish a voice communication session between the target user system 135 and the advertiser system 150. While a voice communication session is used in this example, any type of communication session using one or more services such as SMS, EMS, MMS, email, IM, chat, web based communication, etc., may be established between any user system, guide system, advertiser system, advertising server and/or resource and/or the search system 130.

Information associated with a user, a guide, an advertiser, an advertising server and/or a resource may be obtained in various ways. For example, a registration process may be performed using a web form provided by the search system 130, and/or information may be obtained from an external database, and/or information may be obtained based on analysis of information indicated by a user, a guide, an advertiser, and/or a resource.

A ‘profile’ is one or more characteristics and/or information which may be associated with a number of individuals and/or entities. A profile may include geographic data such as a street address, latitude and longitude, etc., may include demographic information such as age, gender, race, income, family size, political affiliations, etc., may include personality information such as results of psychometric testing, subjective evaluations of an individual, etc., may include affiliation information such as employment, club, activity, societal membership information, information of a device, service, transaction and/or any information which might be associated with a user, a guide, and/or an advertiser.

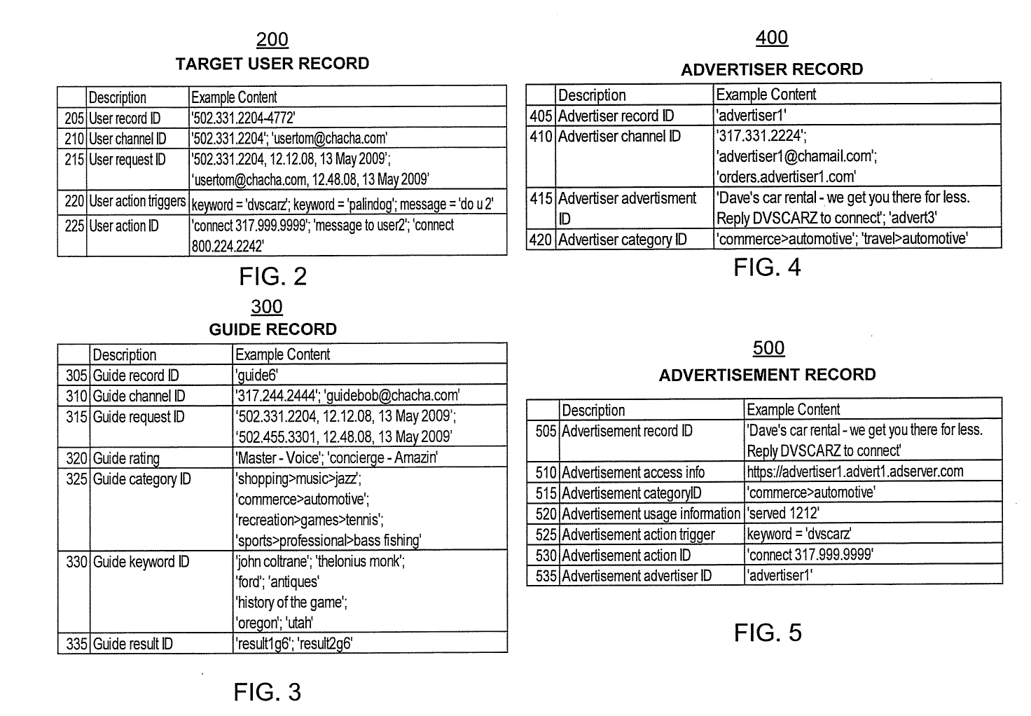

As illustrated in FIG. 2 an exemplary target user record 200 of which one or more may be associated with or resident in the database 120 (FIG. 1) is provided. The target user record 200 may include a user record ID field 205, a user channel ID field 210, a user request ID field 215, a user action triggers field 220, and a user action ID field 225. Any user may be a target user.

The user record ID field 205 includes an identifier of a user which is preferably unique and is preferably used consistently. The user record ID serves to distinguish a user record associated with a user from a user record associated with a different user. Any number of characters, numbers, and/or other indicators may be used to indicate a user record ID. In at least one embodiment, a username associated with a user is included in the user record ID field 205. In at least one embodiment, a phone number associated with a user device is indicated in the user record ID field. Using the example in FIG. 2, ‘502.331.2204-4772’ is the user record ID associated with the user record 200.

The user channel ID field 210 may include information a number of communication services associated with a user. Any information which may be used to establish communication with a user may be indicated in the used channel ID field 210. For example, a telephone number, an email address, an IM credential, a URL, a username, a password, and/or other communication information may be indicated in the user channel ID field 210. Using the example in FIG. 2, the phone number ‘502.331.2204’ and the email ‘usertom@chacha.com’ are associated with the user ID ‘502.331.2204-4772’.

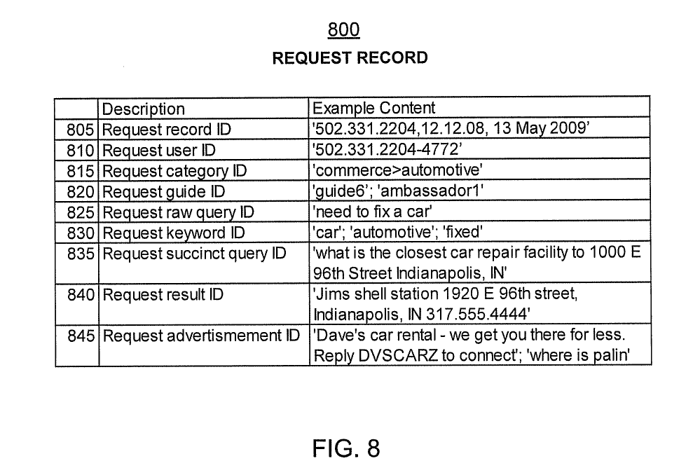

The user request ID field 215 may include information of a number of requests associated with a user. A user request ID may be for example a pointer to a request record such as the request record 800 (FIG. 8). If a user submits a request to the search system 130 (FIG. 1), a request ID may be added to the user request ID field 215 (FIG. 2). Using the example illustrated in FIG. 2, ‘502.331.2204, 12.12.08, 13 May 2009’ and ‘usertom@chacha.com, 12.48.08, 13 May 2009’ are associated with ‘502.331.2204-4772’.

The user action triggers field 220 may include information of a number of trigger events associated with a user. If a user takes an action which is indicated in the user action triggers field 220, an associated response indicated in the user action ID field 225 may be performed. An action may be added to and/or removed from the user action triggers field 220 based on various criteria. For example, if a user receives a particular advertising message, an action trigger may be associated with the user as further described in the related U.S. patent application Ser. No. 12/568,293, previously mentioned. Using the example in FIG. 2, the user action triggers keyword=‘dvscars’, keyword=‘palindog’ and message=‘do u 2’ are the trigger actions associated with the user ‘502.331.2204-4772’.

The user action ID field 225 may include information of an action to be taken responsive to a trigger identified in the user action triggers field 220. Any sort of action may be initiated responsive to an action identified in the user action triggers field 220. In at least one embodiment, a detection of a trigger event may cause a corresponding action to be initiated by the search system 130 (FIG. 1). Using the example illustrated in FIG. 2, detection of the keyword ‘dvscarz’ in a message received from the user ‘502.331.2204-4772’ may cause a connection to be established between the user and the phone number ‘317.999.9999’ and detection of the keyword ‘palindog’ in a message from the user ‘502.331.2204-4772’ may cause a message to be delivered to ‘user2’. As an action associated with a user action ID is not explicitly provided to a user, a user action may effect communication between users without the exchange of personally identifying information of the users. For example, a user may be connected to a different user by voice, text, IM, etc., without knowing how to originate the connection. This may be advantageous in the case of personal advertisements. An originating user may contact a target user without revealing contact information, and a target user may contact the originating user without revealing contact information. Selective control of information may be desired by an originating user and a target user.

While particular fields are illustrated using FIG. 2, the present invention is not limited to these fields. For example, a user profile information may be provided to the target user record identifying characteristic information of the user and/or the target user record 200 may be linked with the profile record 1000 described in detail with respect to FIG. 10.

As illustrated in FIG. 3, an exemplary guide record 300 is provided, of which one or more may be associated with or resident in the search database 120 (FIG. 1). The guide record 300 (FIG. 3) may include a guide record ID field 305, a guide channel ID field 310, a guide request ID field 315, a guide rating field 320, a guide category ID field 325, a guide keyword ID field 330, and a guide result ID field 335.

The guide record ID field 305 preferably contains a unique identifier of a guide, which is preferably used consistently. For example, in at least one embodiment, the guide record ID field 305 can include a randomly generated numerical code, and/or a text string indicating a name associated with a guide. A guide ID serves to distinguish the guide record associated with a guide from a guide record associated with other guides. Other unique identifiers of a guide may be utilized without departing from the spirit and scope of the embodiments. Using the example illustrated in FIG. 3, ‘guide6’ is the guide ID associated with the guide record 300.

The guide channel ID field 310 may include information of a device and/or service associated with a guide. Content of the guide channel ID field 310 may be modified based on actions of a guide. If a guide establishes communications with the search system using a device and/or service information regarding the device and/or service, the communication information may be included in the guide channel ID field 310. Any type of communication service and/or system may be indicated in the guide channel ID field 310. For example, a username and/or password associated with a guide may be indicated in the guide channel ID field 310. Communication services such as Instant Messaging (IM), e-mail, SMS, MMS, EMS, telephone, wireless or wired communication, etc., may be indicated in the guide channel ID field 310. A telephone number, an email address, an IM provider and login ID, a keyword associated with a service, an IP address, a MAC address, etc., may be indicated in the guide channel ID field 310. Using the example illustrated in FIG. 3, the phone number ‘317.244.2444’ and the email ‘guidebob@chacha.com’ are associated with the guide ‘guide6’.

The guide request ID field 315 may include information of a number of requests associated with a guide. Content of the guide request ID field 315 may be modified based on actions of a guide. If a guide produces a search result responsive to a search request, an identifier of the search request may be included in the guide request ID field 315. A rating and/or ranking associated with a search request associated with a guide may affect compensation for a guide. A request may be associated with a guide based on an opinion or vote indicated by a guide regarding items associated with the search request. Using the example illustrated in FIG. 3, the requests ‘502.331.2204, 12.12.08, 13 May 2009’, and ‘502.455.3301, 12.48.08, 13 May 2009’ are associated with ‘guide6’. This may indicate that ‘guide6’ has responded to the requests ‘502.331.2204, 12.12.08, 13 May 2009’, and ‘502.455.3301, 12.48.08, 13 May 2009’.

The guide rating field 320 may include information of a number of ratings associated with a guide. A guide may perform various types of tasks, and may be rated regarding the tasks. For example, a guide may have a rating and/or ranking associated with tasks such as transcribing a query from voice to text, responding to requests regarding a particular advertiser or merchant, searching for information, categorizing a query, determining a previous result, etc. As illustrated in FIG. 3, ‘guide6’ has the rating ‘Master—Voice’ and ‘concierge—Amazin’. This may indicate that ‘guide6’ may be a preferred guide for performing a voice transcription task, and may be able to act as a concierge guide for interactions with the merchant ‘Amazin’. Any guide may perform any type of task.

The guide category ID field 325 may include information of a number of categories associated with a guide. Content of the guide category ID field 325 may be modified based on actions of a guide. A guide and/or other person may select a category and/or keyword associated with a guide. A category may be associated with a guide based on testing of a guide. A category may be associated with a guide based on an affiliate group associated with a guide. For example, if a guide has chosen to be affiliated with affiliate groups associated with a type of music, a category associated with the type of music might be associated with the guide. A category associated with a guide may be used to select items which are to be presented to the guide. For example, if a search request is associated with a category, a guide with a high rating associated with the category may be more likely to be selected to respond to the request. Using the example illustrated in FIG. 3, the categories ‘shopping>music>jazz’, ‘commerce>automotive’, ‘recreation>games>tennis’ and ‘sports>professional>bass fishing’ are associated with ‘guide6’.

The guide keyword ID field 330 may include information of a topic or “interest” or keyword associated with a guide. Content of the guide keyword ID field 330 may be modified based on actions of a guide. A person may select an interest associated with a guide. For example, a guide may select a topic or keyword to be associated with the guide before, during and/or after a registration process. A topic may be associated with a guide based on testing and/or analysis of a guide. For example, a guide may be required to demonstrate knowledge of a category and/or topic in order to be associated with the topic. Content indicated in the guide keyword ID field 330 may be compared to content of a search request in order to determine a ranking of a guide for responding to a search request. Using the example illustrated in FIG. 3, the topics ‘John coltrane’, ‘thelonius monk’, ‘ford’, ‘antiques’, ‘history of the game’, ‘oregon’, and ‘utah’ are associated with ‘guide6’. This may for example indicate that ‘guide6’ has indicated an interest in those topics, and may be more likely to be selected to respond to a query including those keywords than a guide associated with a category related to the keywords.

The guide result ID field 335 may include information of a number of results associated with a guide. Content of the guide result ID field 335 may be modified based on actions of a guide. If a guide produces a search result responsive to a search request, an identifier of the search result may be included in the guide result ID field 335. A rating and/or ranking associated with a search result associated with a guide may affect compensation for a guide. Likewise a usage indicator associated with a search result provided by a guide may affect a rating and/or ranking associated with a guide. Using the example illustrated in FIG. 3, the results ‘result1g6’ and ‘result2g6’ are associated with ‘guide6’.

As illustrated in FIG. 4, an exemplary advertiser record 400 of which one or more may be associated with or resident in the database 120 (FIG. 1) is provided. The advertiser record 400 (FIG. 4) may include an advertiser record ID field 405, an advertiser channel ID field 410, an advertiser advertisement ID field 415, and an advertiser category ID field 420.

The advertiser record ID field 405 includes an identifier of an advertiser which is preferably unique and is preferably used consistently. An advertiser record ID serves to distinguish an advertiser record associated with an advertiser from an advertiser record associated with a different advertiser. Any number of characters, numbers, and/or other indicators may be used to indicate an advertiser record ID. In at least one embodiment, a username associated with an advertiser is included in the advertiser record ID field 405. In at least one embodiment, a phone number associated with an advertiser device is indicated in the advertiser record ID field. Using the example in FIG. 4, ‘advertiser1’ is the advertiser record ID associated with the advertiser record 400.

The advertiser channel ID field 410 may include information a number of communication services associated with an advertiser. Any information which may be used to establish communication with an advertiser may be indicated in the advertiser channel ID field 410. For example, a telephone number, an email address, an IM credential, a URL, a username, a password, and/or other communication information may be indicated in the advertiser channel ID field 410. Using the example in FIG. 4, the phone number ‘317.331.2224’, the email ‘advertiser1@chamail.com’, and the URL ‘orders.advertiser1.com’ are associated with ‘advertiser1’.

The advertiser advertisement ID field 415 may include information of a number of advertisements associated with an advertiser. An advertiser advertisement ID may be, for example, a pointer to an advertisement record such as the advertisement record 500 (FIG. 5). An advertisement may be provided directly by a merchant or advertiser, by an advertising agency or service, may be created by a search service, etc. Using the example in FIG. 4, ‘Dave's car rental—we get you there for less. Reply DVSCARZ to connect’ and ‘advert3’ are associated with ‘advertiser1’.

The advertiser category ID field 420 may include information of a number of categories associated with an advertiser. Content of the advertiser category ID field 425 may be modified based on actions of an advertiser. An advertiser and/or other person may select a category and/or keyword associated with an advertiser. For example, a guide, an agency and/or a user might select a category associated with an advertiser. A category associated with an advertiser may be used to select items which are to be presented to a person such as a guide, a user, etc. For example, if a search request is associated with a category, an advertisement of an advertiser with a high rating associated with the category may be more likely to be selected and presented responsive to the request. Using the example illustrated in FIG. 4, the categories ‘commerce>automotive’ and ‘travel>automotive’ are associated with ‘advertiser1’.

As illustrated in FIG. 5, an exemplary advertisement record 500 of which one or more may be associated with or resident in the database 120 (FIG. 1) is provided. The advertisement record 500 may include an advertisement record ID field 505, an advertisement access information field 510, an advertisement category ID field 515, an advertisement usage info field 520, an advertisement action trigger field 525, an advertisement action ID field 530, and an advertisement advertiser ID field 535. An advertisement record may indicate any type of advertisement.

The advertisement record ID field 505 includes an identifier of an advertisement which is preferably unique and is preferably used consistently. An advertisement record ID serves to distinguish an advertisement record associated with an advertisement from an advertisement record associated with a different advertisement. Any number of characters, numbers, and/or other indicators may be used to indicate an advertisement record ID. In at least one embodiment, a name selected by an advertiser associated with an advertisement is included in the advertisement record ID field 505. Using the example in FIG. 5, ‘Dave's car rental—we get you there for less. Reply DVSCARZ to connect’ is the advertisement record ID associated with the advertisement record 500.

The advertisement access information field 510 may include information regarding how an advertisement may be accessed. For example, the advertisement access information may indicate a server, URL, password, etc., which may be used to obtain information of an advertisement. Using the example in FIG. 5, the URL <https://advertiser1.advert1.adserver.com> is associated with the advertisement record 500.

The advertisement category ID field 515 may include information of a number of categories associated with an advertisement. Content of the advertisement category ID field 515 may be modified based on actions of an advertiser. An advertisement and/or other person may select a category and/or keyword associated with an advertisement. For example, a guide and/or a user might select or influence a category associated with an advertisement. A category associated with an advertisement may be used to select items which are to be presented to a person such as a guide, a user, etc. For example, if a search request is associated with a category, an advertisement with a high rating associated with the category may be more likely to be selected and presented responsive to the request. Using the example illustrated in FIG. 5, the category ‘commerce>automotive’ is associated with the advertisement record 500.

The advertisement usage info field 520 may include information regarding usage of an advertisement. For example, if an advertisement has been provided to a user, information regarding a number of times the advertisement has been supplied may be indicated in the advertisement usage info field 520. Any type of usage indication may be used. Using the example in FIG. 5, ‘served 1212’ may indicate that the advertisement associated with the advertisement record 500 has been served one thousand two hundred and twelve times. Usage information may be used for various purposes such as determining efficacy, inventory, etc., of advertising, compensation for a guide and/or the search system 130, etc.

The advertisement action trigger field 525 may include information of a response or event or trigger associated with an advertisement. For example, if an advertisement includes a keyword which may be used to trigger an action responsive to a message including the keyword, the keyword may be indicated in the advertisement action trigger field 525. Using the example in FIG. 5, the keyword ‘dvscarz’ is associated with the advertisement ‘Dave's car rental, we get you there for less. Reply DVSCARZ to connect’.

The advertisement action ID field 530 may include information of an action which is to be associated with a user responsive to an advertisement being provided to the user. Using the example illustrated in FIG. 5, if the advertisement ‘Dave's car rental—we get you there for less. Reply DVSCARZ to connect’ is presented or provided to a user, the action ‘connect 317.999.9999’ may be executed responsive to a message from the user including the keyword ‘dvscarz’.

The advertisement advertiser ID field 535 may include information of an advertiser associated with an advertisement. For example, the advertisement advertiser ID field 535 may include a pointer to a number of advertiser records such as the advertiser record 400 (FIG. 4). Using the example in FIG. 5, ‘advertiser1’ is associated with the advertisement ‘Dave's car rental—we get you there for less. Reply DVSCARZ to connect’.

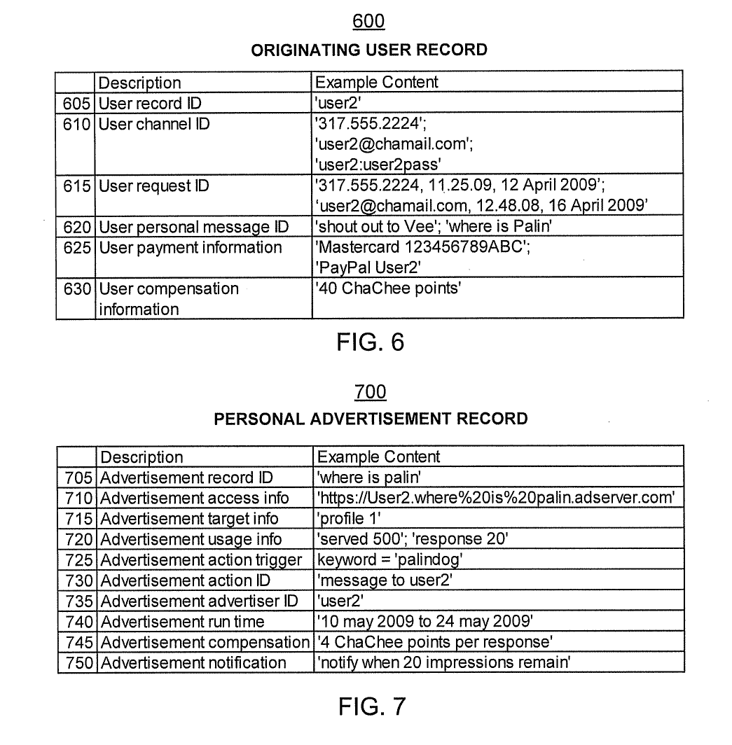

As illustrated in FIG. 6, an exemplary originating user record 600 of which one or more may be associated with or resident in the database 120 (FIG. 1) is provided. The originating user record 600 may include a user record ID field 605, a user channel ID field 610, a user request ID field 615, a user personal message ID field 620, a user payment information field 625, and a user compensation information field 630.

The user record ID field 605 includes an identifier of a user which is preferably unique and is preferably used consistently. The user record ID serves to distinguish a user record associated with a user from a user record associated with a different user. Any number of characters, numbers, and/or other indicators may be used to indicate a user record ID. In at least one embodiment, a username associated with a user is included in the user record ID field 605. In at least one embodiment, a phone number associated with a user device is indicated in the user record ID field. Using the example in FIG. 6, ‘user2’ is the user record ID associated with the originating user record 600.

The user channel ID field 610 may include information of a number of communication services associated with a user. Any information which may be used to establish communication with a user may be indicated in the user channel ID field 610. For example, a telephone number, an email address, an IM credential, a URL, a username, a password, and/or other communication information may be indicated in the user channel ID field 610. Using the example in FIG. 6, the phone number ‘317.555.2224’, the email ‘user2@chamail.com’, and the user login ‘user2’ and the password ‘user2pass’ are associated with ‘user2’.

The user request ID field 615 may include information of a number of requests associated with a user. A user request ID may be, for example, a pointer to a request record such as the request record 800 (FIG. 8). If a user submits a request to the search system 130 (FIG. 1), a request ID may be added to the user request ID field 615 (FIG. 6). Using the example illustrated in FIG. 6, the requests ‘317.555.2224, 11.25.09, 12 April 2009’ and ‘user2@chamail.com, 12.48.08, 16 April 2009’ are associated with ‘user2’.

The user personal message ID field 620 may include information of a number of personal advertisements originated by a user. If a user creates a personal advertisement campaign, an identifier of the personal advertisement campaign may be indicated in the user personal advertisements ID field. Content of the user personal message ID field 620 may, for example, include a pointer to a personal advertisement record such as the personal advertisement record 700 (FIG. 7). Using the example in FIG. 6, ‘shout out to Vee’ and ‘where is Palin’ are personal advertisements associated with the user ‘user2’.

The user payment information field 625 may include information of payment methods which have been provided by a user. Any type of payment information such as a debit or credit card, payment system account, communication services account, etc., may be indicated in the user payment information field 625. Using the example in FIG. 6, ‘Mastercard 123456789ABC’ and ‘PayPal User2’ are payment information associated with the user ‘user2’. Content of the user payment information field 625 may be used to obtain payment from a user.

The user compensation info field 630 may include information of credits accumulated by a user. Any type of credits may be indicated in the user compensation info field 630. In at least one embodiment, a credit or ‘points’ system may be used to purchase services such as search services, personal advertising, item such as ringtones, electronic media, etc., which may allow users to exchange credits by sending messages. For example, a user might respond to a personal ad and receive a credit which might be used to download a musical composition. This may, for example, allow a first user to send an electronic gift to a second user using a personal message or advertisement. Using the example in FIG. 6, ‘user2’ has ‘40 ChaChee points’ available.

As illustrated in FIG. 7 an exemplary personal advertisement record 700 of which one or more may be associated with or resident in the database 120 (FIG. 1) is provided. The advertisement record 700 may include an advertisement record ID field 705, an advertisement access info field 710, an advertisement target info field 715, an advertisement usage info field 720, an advertisement action trigger field 725, an advertisement action ID field 730, an advertisement advertiser ID field 735, an advertisement run time field 740, an advertisement compensation field 745, and an advertisement notification field 750.

The advertisement record ID field 705 includes an identifier of an advertisement which is preferably unique and is preferably used consistently. An advertisement record ID serves to distinguish an advertisement record associated with a personal advertisement from an advertisement record associated with a different personal advertisement. Any number of characters, numbers, and/or other indicators may be used to indicate an advertisement record ID. In at least one embodiment, a name selected by a user associated with a personal advertisement is included in the advertisement record ID field 705. Using the example in FIG. 7, ‘where is palin’ is the advertisement record ID associated with the personal advertisement record 700.

The advertisement access info field 710 may include information regarding how a personal advertisement may be accessed. For example, advertisement access information may indicate a server, URL, password, etc., which may be used to obtain information of an advertisement. Using the example in FIG. 7, the URL <https://User2.where%20is%20palin.adserver.com> is associated with the personal advertisement record 700.

The advertisement target info field 715 may include information of a target user and/or profile associated with a personal advertisement or personal message. Content of the advertisement target info field 715 may be modified based on action(s) of a person. An originating user may determine targeting information associated with a personal advertisement. Target information associated with a personal advertisement may be used to select items which are to be presented to a person such as a guide, a user, etc. For example, if a request is associated with a target, an advertisement with a high rating associated with the target may be more likely to be selected be presented responsive to the request. Using the example illustrated in FIG. 7, the target ‘profile1’ is associated with the personal advertisement record 700.

The advertisement usage info field 720 may include information regarding usage of a personal advertisement. For example, if an advertisement has been provided to a user, information regarding a number of times the advertisement has been supplied may be indicated in the advertisement usage info field 720. Any type of usage information may be indicated. Using the example in FIG. 7, ‘served 500’, ‘response 20’ may indicate that the advertisement associated with the personal advertisement record 700 has been served to user(s) five hundred and one times and has received a response action twenty times. Usage information may be used for various purposes. For example usage information may be used for determining efficacy of advertising, compensation for a guide, a user, a provider of a search service or publisher, etc.

The advertisement action trigger field 725 may include information of a response or trigger associated with an advertisement. For example, if an advertisement indicates a keyword which may be used to trigger an action responsive to a message including the keyword, the keyword may be indicated in the advertisement action trigger field 725. Using the example in FIG. 7, the keyword ‘palindog’ is associated with the advertisement ‘where is palin’.

The advertisement action ID field 730 may include information of an action which is to be associated with a user responsive to an advertisement being provided to the user. Using the example illustrated in FIG. 7, if the advertisement ‘where is palin’ is presented to a user, the action ‘message to user2’ may be executed responsive to a message from the user including the keyword ‘palindog’.

The advertisement advertiser ID field 735 may include information of a user or advertiser associated with a personal advertisement. For example, the advertisement advertiser ID field 735 may include a pointer to a number of user records such as the originating user record 600 (FIG. 6). Using the example in FIG. 7, ‘user2’ is associated with the advertisement ‘where is palin’.

The advertisement run time field 740 may include information of a time interval during which a campaign is to be conducted. For example, a start and end date for a campaign may be specified during which a target user is to receive a personal advertisement. Using the example in FIG. 7, the time interval ‘10 may 2009 to 24 may 2009’ is associated with the personal advertisement ‘where is palin’. While a time interval is used for purposes of illustration, no limitation is implied. Any condition may be used to determine whether an advertisement is available to be served. For example, a number of responses, a number of advertisements served, a number of unique target users, a number of recorded actions by target users, etc, may be used as conditions for a campaign. According to an embodiment, a message and/or an advertisement may be set to be delivered on a recurring condition such as a date, a time, an event, etc.

The advertisement compensation field 745 may include information of compensation associated with a personal advertisement. The advertisement compensation field 745 may include information of a type and/or amount of compensation to be provided to a target user based on a receipt of and/or a response to a personal advertisement. For example, a reward and/or incentive for a sighting of a lost pet which includes a picture of the pet might be provided using ‘points’ and/or other form of credit or compensation. Using the example in FIG. 7, ‘4 ChaChee points per response’ is associated with the advertisement ‘where is palin’.

The advertisement notification field 750 may include information of a notification condition or event associated with a personal advertisement. The advertisement notification field 750 may include information of a number of conditions and/or combinations of conditions which may cause a user associated with a personal advertisement to receive a notification. For example, a number of advertisements remaining, a number of responses, a type of response, a time interval, etc., might be indicated in the advertisement notification field 745. Using the example in FIG. 7, ‘notify when 20 impressions remain’ is associated with the advertisement ‘where is palin’.

As illustrated in FIG. 8 an exemplary request record 800 of which one or more may be associated with or resident in the database 120 (FIG. 1) is provided. A request record may be used to record information related to processing a request, including providing a search result and/or other item to a user responsive to a request. The request record 800 may include a request record ID field 805, a request user ID field 810, a request category ID field 815, a request guide ID field 820, a request raw query ID field 825, a request keyword ID field 830, a request succinct query ID field 835, a request result ID field 840, and a request advertisement ID field 845.

The request record ID field 805 includes an identifier of a request which is preferably unique and is preferably used consistently. A request record ID serves to distinguish a request record associated with a request from a request record associated with a different request. Any number of characters, numbers, and/or other indicators may be used to indicate a request record ID. In at least one embodiment, user ID and a time stamp with a request is included in the request record ID field 805. Using the example in FIG. 8, ‘502.331.2204, 12.12.08, 13 May 2009’ is the request record ID associated with the request record 800.

The request user ID field 810 may include an identifier of a number of users associated with a request. For example, the request user ID field may include a pointer to a user record such as the user record 200 (FIG. 2) which may be used to obtain information regarding a user. Using the example in FIG. 8, the user ‘502.331.2204-4772’ is associated with the query ‘502.331.2204, 12.12.08, 13 May 2009’.

The request category ID field 815 may include an identifier of a category associated with a request. A category may be associated with a request in various ways. For example, a category may be associated with a request based on an automated and/or human assisted analysis of information of a query such as a keyword, a profile, a history, a user, etc., which may be used to determine a number of categories to be associated with a query. In at least one embodiment, an automated analysis may be performed, followed by a human assisted analysis. An ambassador or expediter guide, who may be a specialist in query processing, may be provided with information of a request in order to determine, select and/or define a category associated with a request. Using the example in FIG. 8, the category ‘commerce>automotive’ is associated with the request ‘502.331.2204, 12.12.08, 13 May 2009’.

The request guide ID field 820 may include information of a number of guides associated with a request. Any number of guides may be associated with a request. For example a guide may be associated with a request if the guide is selected to respond to the request. Using the example in FIG. 8, ‘guide6’ and ‘ambassador1’ are associated with ‘502.331.2204, 12.12.08, 13 May 2009’. This may indicate that ‘ambassador1’ has expedited the request ‘502.331.2204, 12.12.08, 13 May 2009’, and ‘guide6’ has provided a search result responsive to the request.

The request raw query ID field 825 may include information of a raw query associated with a request. A “raw query” may include any information provided by a user. A guide may process a raw query, which may assist in providing a search result. Any type of information such as audio, video, image, text, or other media may be indicated in the raw query ID field 825. Using the example in FIG. 8, ‘need to fix a car’ is the raw query ID associated with the request ‘502.331.2204, 12.12.08, 13 May 2009’.

The request keyword ID field 830 may include information of a number of keywords associated with a request. A keyword may be determined automatically and/or using the assistance of a guide. A keyword may be an explicit and/or implicit element of a raw query and/or a succinct query. A keyword may include multiple words up to and including the entire content of a query. Using the example in FIG. 8, the keywords ‘car’, ‘automotive’, and ‘fixed’ are associated with the request ‘502.331.2204, 12.12.08, 13 May 2009’.

The request succinct query ID field 835 may include information of a succinct query associated with a request. A “succinct query” is a query which is based at least in part on a raw query provided by a user. A succinct query may be used to more efficiently index, formulate, indicate, tokenize, and/or provide a raw query for a resource, a guide, an advertisement, and/or recipient. An ambassador guide or expediter may generate and/or select a succinct query to be associated with a request, and/or an automated process may associate a succinct query with a request. Using the example in FIG. 8, the succinct query ‘what is the closest car repair facility to 1000 E 96^{th} Street, Indianapolis, IN’ is the succinct query associated with the request ‘502.331.2204, 12.12.08, 13 May 2009’.

The request result ID field 840 may include information of a number of results associated with a request. For example, text, a URL, audio, video, images, and/or other information which may provide information associated with a request may be indicated in the request result ID field 840. Any number of results may be associated with a request. In at least one embodiment, a text message which indicates a precise, direct, succinct, explicit and/or unambiguous response to a user request may be indicated in the request result ID field 840. Using the example in FIG. 8, ‘Jims shell station 1920 E 96^{th} street, Indianapolis, IN 317.555.4444’ is the result associated with the request ‘502.331.2204, 12.12.08, 13 May 2009’.

The request advertisement ID field 845 may include information of a number of advertisements associated with a request. For example, an interstitial, trailer, and/or follow-on type advertisement may be associated with a request. In at least one embodiment, association of an advertisement with a request may cause an action trigger and/or an action to be associated with a user. Using the example illustrated in FIG. 8, the advertisement ‘Dave's car rental—we get you there for less. Reply DVSCARZ to connect’ is associated with the request ‘502.331.2204, 12.12.08, 13 May 2009’, which may cause the advertisement action trigger ‘keyword=‘dvscarz’’ (FIG. 5) and the advertisement action ‘connect 317.999.9999’ to be associated with the user ‘502.331.2204-4772’.

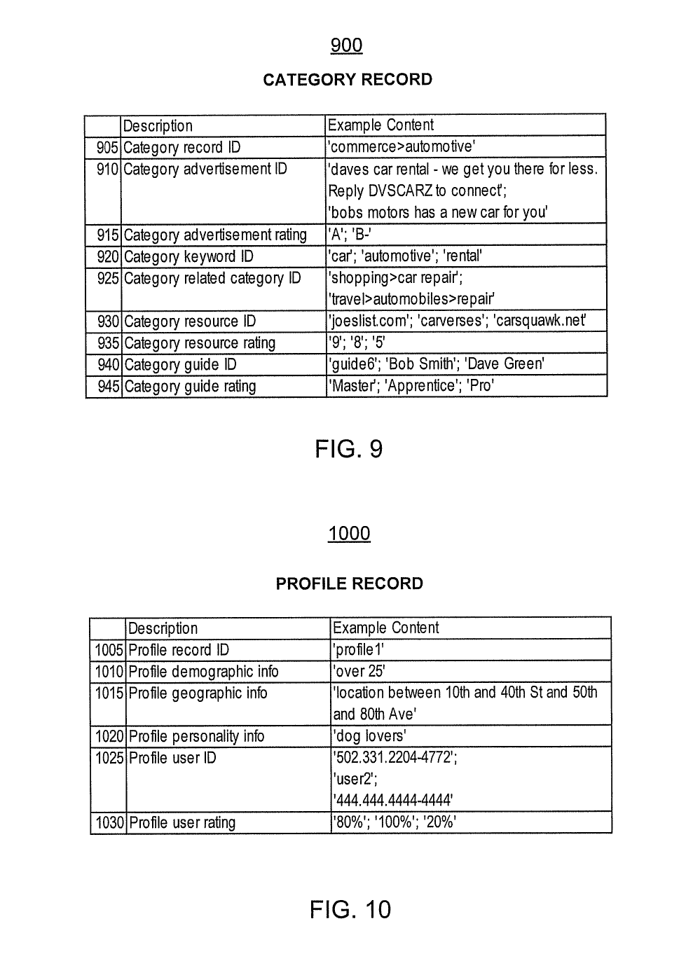

As illustrated in FIG. 9, an exemplary category record 900 is provided, of which one or more may be associated with or resident in the search database 120 (FIG. 1). The category record 900 (FIG. 9) may include a category record ID field 905, a category advertisement ID field 910, category advertisement rating field 915, category keyword ID field 920, category related category ID field 925, category resource ID field 930, category resource rating field 935, category guide ID field 940, and category guide rating field 945.

The category record ID field 905 contains an identifier of a category which is preferably unique and preferably used consistently. In at least one embodiment, the category record ID field 905 can include a randomly generated numerical code and/or a string indicating a category. A category record ID serves to distinguish a category record associated with a category from a category record associated with other categories. Although particular examples of identifiers are described herein, other types of identifiers uniquely indicating a category may be utilized without departing from the spirit and scope of the embodiments. In at least one embodiment, a category record ID is a text string. A category record ID may include a category description, a random number, and/or any other information which uniquely identifies a category. Using the example in FIG. 9, ‘commerce>automotive’ is the category record ID associated with the category record 900.

The category advertisement ID field 910 may include information of an advertisement associated with a category. Content of the category advertisement ID field 910 may be used to select an advertisement to be associated with a request. Using the example in FIG. 9, ‘daves car rental—we get you there for less. Reply DVSCARZ to connect’ and ‘bobs motors has a new car for you’ are associated with the category ‘commerce>automotive’.

The category advertisement rating field 915 may include information of ratings of an advertisement associated with a category. Content of the category advertisement rating field 915 and the category advertisement ID field 910 may be linked by, for example, a pointer. Any type of rating information may be indicated in the category advertisement rating field 915. A higher advertisement rating may increase the probability that an advertisement will be selected to be associated with a request. For example, a list of advertisements to be served responsive to queries or requests associated with a category may be presented to a guide in an order based at least in part on an advertisement rating associated with a category associated with a request. Using the example in FIG. 9, ‘daves car rental—we get you there for less. Reply DVSCARZ to connect’ has a rating of ‘A’, and ‘bobs motors has a new car for you’ has a rating of ‘B−’. Any rating system may be utilized within the scope of this disclosure. A rating may be based on factors such as guide ratings, user ratings, advertiser ratings, an external database, time, proximity, industry or other expert ratings, etc. A ranking of an advertisement may be determined based on ratings associated with an advertisement and information associated with a request such as a keyword, a category, a profile, geographic location information, a user, a guide, etc. A selection of an advertisement may be done automatically and/or using a guide.

The category keyword ID field 920 may include information of a topic or keyword associated with a category. Content of the category keyword ID field 920 may be used to associate a category with a request. For example, text of a raw query and/or a structured query may be compared to any or all content of the category keyword ID field 920 to rate and/or rank a category. Such information may affect the order in which a category is presented responsive to a query. Using the example illustrated in FIG. 9, the keywords ‘car’, ‘automotive’ , and ‘rental’ are associated with the category ‘commerce>automotive’. The category ‘commerce>automotive’ may receive a high ranking associated with a query including the keywords ‘car’, ‘automotive’, and/or ‘rental’.

The category related category ID field 925 may include information of a related category associated with a category. Content of the category related category ID field 925 may be used to associate a category with a request. For example, text of a query may be compared to any or all keywords, topics and/or interests associated with a category identified in the category related category ID field 925 to rate and/or rank a category. Such ranking or rating information may affect the order in which a category is presented responsive to a request. Using the example illustrated in FIG. 9, ‘shopping>car repair’ and ‘travel>automobiles>repair’ are associated with ‘commerce>automotive’. Related categories may be associated with a category in various ways. In at least one embodiment, a system administrator may associate a related category with a category. In at least one embodiment, a guide may recommend a related category to be associated with a category and/or a voting and/or review process may be utilized to approve or reject a recommended addition.

The category resource ID field 930 may include information of a resource associated with a category. Content of the category resource ID field 930 may be used to select a resource to be associated with a request. Using the example in FIG. 9, the resources ‘joeslist.com’, ‘carverses’, and ‘carsquawk.net’ are associated with the category ‘commerce>automotive’.

The category resource rating field 935 may include information of ratings of a resource associated with a category. Content of the category resource rating field 935 and the category resource ID list field 930 may be linked by, for example, a pointer. Any type of rating information may be indicated in the category resource rating field 935. A higher resource rating may increase the probability that a resource will be selected to be associated with a request. For example, a list of resources may be presented to a guide in an order based at least in part on a resource rating associated with a category associated with a request, or a request may be submitted to a resource to produce an automated response based on a ranking of the resource. Using the example in FIG. 9, ‘joeslist.com’ has a rating of ‘9’, ‘carverses’ has a rating of ‘8’, and ‘carsquawk.net’ has a rating of ‘5’. Any rating system may be utilized within the scope of this disclosure. A rating may be based on factors such as guide ratings, user ratings, advertiser ratings, an external database, time, proximity, etc. A ranking of a resource may be determined based on ratings associated with a resource and information associated with a request such as a keyword, a category, a profile, geographic location information, a user, a guide, etc. A selection of a resource may be done automatically and/or using a guide.

The category guide ID field 940 may include information of a guide associated with a category. Content of the category guide ID field 940 may be used to select a guide. Using the example in FIG. 9, ‘guide6’, ‘Bob Smith’, and ‘Dave Green’ are associated with ‘commerce>automotive’.

The category guide rating field 945 may include information of ratings of a guide associated with a category. Content of the category guide rating field 945 and the category guide ID field 940 may be linked by, for example, a pointer. Any type of rating information may be indicated in the category guide rating field 945. A higher guide rating may increase the probability that a guide will be selected. For example, a list of guides may be presented to a user in an order based at least in part on a guide rating associated with a category associated with a request, or a highly ranked guide may be notified first of a request. Using the example in FIG. 9, ‘guide6’ has a rating of ‘Master’, ‘Bob Smith’ has a rating of ‘Apprentice’, and ‘Dave Green’ has a rating of ‘Pro’. Any rating system may be utilized within the scope of this disclosure. A rating may be based on factors such as guide ratings, user ratings, advertiser ratings, an external database, time, proximity, etc. A ranking of a guide may be determined based on ratings associated with a guide and information associated with a request such as a keyword, a category, a profile, geographic location information, a user, a guide, etc. A selection of a guide may be done automatically and/or using a guide.

As illustrated in FIG. 10, an exemplary profile record 1000 is provided, of which one or more may be associated with or resident in the search database 120 (FIG. 1). The profile record 1000 may include a profile record ID field 1005, a profile demographic info field 1010, a profile geographic info field 1015, a profile personality info field 1020, a profile user ID field 1025, and a profile user rating field 1030.

The profile record ID field 1005 contains an identifier of a profile, which is preferably unique and preferably used consistently. For example, in at least one embodiment, the profile record ID field 1005 can include a randomly generated numerical code and/or a string indicating a profile. A profile record ID serves to distinguish a profile record associated with a profile from a profile record associated with other profiles. Although particular examples of identifiers are described herein, other types of identifiers uniquely indicating a profile may be utilized without departing from the spirit and scope of the embodiments. In at least one embodiment, the profile record ID is a text string. A profile record ID may include a profile description, a random number, and/or any other information which uniquely identifies a profile. Using the example in FIG. 10, ‘profile1’ is the profile record ID associated with the profile record 1000.

The profile demographic info field 1010 may include information of a demographic parameter or criterion associated with a profile. For example, age, gender, race, etc., may be indicated in the profile demographic info field 1010. Using the example in FIG. 10, ‘over25’ is associated with ‘profile1’ which may indicate that a user over twenty five years of age may have a higher ranking associated with ‘profile1’.

The profile geographic info field 1015 may include information of a geographic parameter associated with a profile. For example, age, gender, race, etc., may be indicated in the profile geographic info field 1015. Using the example in FIG. 10, ‘location between 10th and 40th St and 50th and 80th Ave’ is associated with ‘profile1’, which may indicate that a user within that location may have a higher ranking associated with ‘profile1’.

The profile personality info field 1020 may include information of a personality parameter associated with a profile. For example, political, social, character, psychometric, organizational, affiliation and/or any information which might differentiate users may be indicated in the profile personality info field 1020. Using the example in FIG. 10, ‘dog lovers’ is associated with ‘profile1’, which may indicate that a user who likes dogs may have a higher ranking associated with ‘profile1’.

The profile user ID field 1025 may include information of a user associated with a profile. Content of the profile user ID list field 1025 may be used to select a user. Using the example in FIG. 10, ‘502.331.2204-4772’, ‘user2’, and ‘444.444.4444-4444’ are associated with the profile ‘profile1’.

The profile user rating field 1030 may include information of ratings of a user associated with a profile. In at least one embodiment, content of the profile user rating field 1030 and the profile user ID field 1025 may be linked by, for example, a pointer. Any type of rating information may be indicated in the profile user rating field 1030. In at least one embodiment, a higher rating may increase the probability that a user will be selected to receive an advertisement associated with a profile. For example, a user with a higher ranking associated with ‘profile1’ may preferentially receive a personal advertisement associated with ‘profile1’. Using the example in FIG. 10, ‘502.331.2204-4772’ has a rating of ‘80%’, ‘user2’ has a rating of ‘100%’, and ‘444.444.4444-4444’ has a rating of ‘20%’. This may indicate that ‘502.331.2204-4772’ would more likely receive ‘where is palin’ than ‘444.444.4444-4444’.

While the category record 900 and the profile record 1000 have been illustrated to include rankings and ratings of guides, advertisements, and users no limitation is implied thereby. Any item indicated in the database 120 (FIG. 1) may be assigned a ranking and/or rating associated with any other item. For example, guides might be ranked for a profile, a category, a keyword, an advertiser, etc. for purposes such as matching and/or selecting a guide to respond to a request associated with the profile, category, keyword, advertiser, etc.

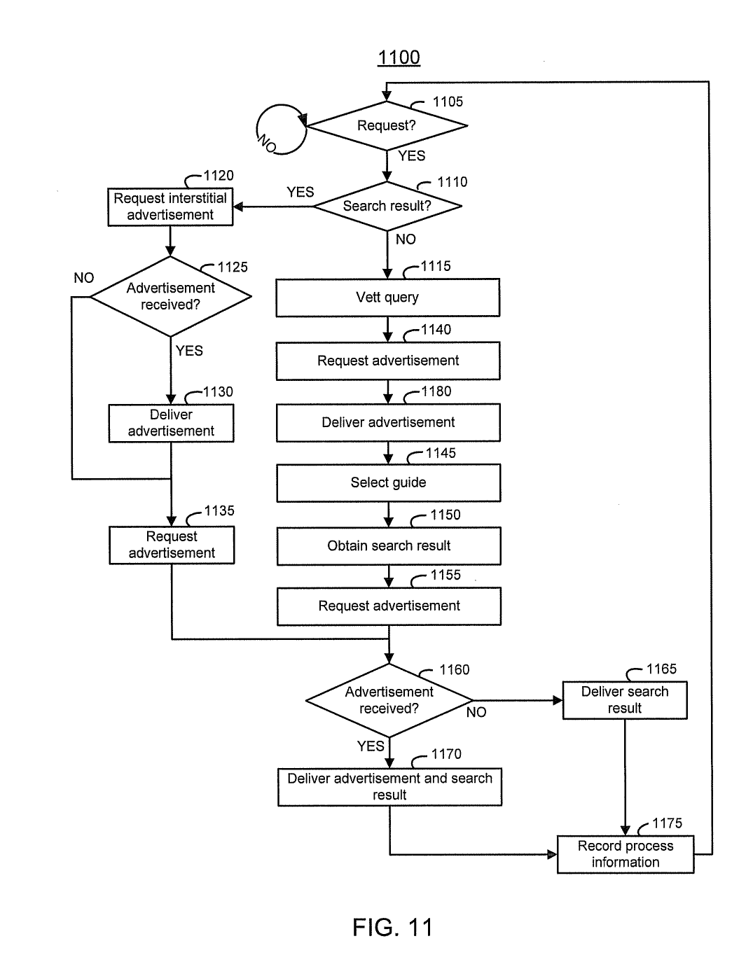

As illustrated in FIG. 11, a process 1100 for processing a request is provided. The process 1100 may be performed in whole or in part by any suitable element of the system 100 (FIG. 1). In at least one embodiment, the process 1100 is operative on a server associated with the search system 130.

In operation 1105 (FIG. 11), a determination is made as to whether a request is received. If it is determined in operation 1105 that a request is not received, control remains at operation 1105 and process 1100 continues. If it is determined in operation 1105 that a request is received, control is passed to operation 1110 and process 1100 continues.

The determination in operation 1105 may be made using various criteria. In at least one embodiment, if a message is received at a server associated with the search system 130 (FIG. 1), it may be determined that a request is received. For example, if an email message, an SMS, EMS, and/or MMS message, an IM, an IP message, and/or a voice message is received at an address associated with the search system 130 it may be determined, decided, established, concluded, identified or discerned that a request is received.

In operation 1110, a determination is made as to whether a search result is available. If in operation 1110 it is determined that a search result is not available, control is passed to operation 1115 and process 1100 continues. If in operation 1110 it is determined that a search result is available, control is passed to operation 1120 and process 1100 continues.

The determination in operation 1110 may be made using various criteria. In at least one embodiment, comparison to a database of previous queries and/or results, automated processing, processing by an external resource and/or any combination thereof may be applied to a query to determine if a search result is available. The operation 1110 may also proceed to operation 1115 when determining that the request at operation 1105 required assistance of a guide.

In operation 1115 a query is vetted. Vetting of a query may include various forms of processing which may be performed automatically and/or using the assistance of a person. The vetting process results in the association of a structured query and/or a category with a request. Control is passed to operation 1140 and process 1100 continues.

In operation 1120 an advertisement is requested. In at least one embodiment, an advertisement is requested. An “interstitial ad” is an advertisement which is generally presented prior to a search result or in between other events of the system 100 (FIG. 1). In at least one embodiment, an interstitial ad may be targeted based on content of a search result identified in operation 1110 and/or content of the request received at operation 1105. Control is passed to operation 1125 and process 1100 continues.

In operation 1125, a determination is made as to whether an advertisement is received. If in operation 1125 it is determined that an advertisement is not received, control is passed to operation 1135 and process 1100 continues. If in operation 1125 it is determined that an advertisement is received, control is passed to operation 1130 and process 1100 continues.

The determination in operation 1125 may be made based on various criteria. In at least one embodiment, if an advertisement is not received at a server associated with the search system 130 from a server associated with an advertiser system (e.g. the advertising server 165) within a pre-determined time interval following a request made in operation 1120 it may be determined that an advertisement is not received. In at least one embodiment, if a user has a status indicator which indicates that interstitial ads are not to be served to the user it may be determined that an advertisement is not received. In at least one embodiment, if an advertisement received has been previously provided to a user, it may be determined that an advertisement is not received.

In operation 1130, an advertisement is delivered. In at least one embodiment, more than one advertisement may be provided or served. Content of an advertisement may be modified based on a time interval, user history, etc. Any service associated with a user may be used to deliver an advertisement to the user. Control is passed to operation 1135 and process 1100 continues.

In operation 1135 an advertisement is requested. A “contextual ad” is an advertisement which is presented simultaneously with a search result. A contextual ad may, for example, be a text message which is appended to a response to a request to create a longer message which is provided as an SMS message response to a user. In at least one embodiment, a contextual ad may be requested in operation 1135. In at least one embodiment a programmatic delay may be executed in operation 1135, which may allow a user sufficient time to process information of an advertisement delivered in operation 1130. Control is passed to operation 1160 and process 1100 continues.

In operation 1140 an advertisement is requested. In at least one embodiment, an interstitial advertisement may be targeted based on results of a query vetting process. Control is passed to operation 1180 and process 1100 continues.

In operation 1180 an advertisement is delivered. In at least one embodiment, multiple advertisements are delivered to a user during a time interval which is required to select a guide and/or obtain a search result. Control is passed to operation 1145 and process 1100 continues.

In operation 1145, a guide is selected to respond to a request. A guide may be selected based on various criteria. For example, a first available guide, a highest ranking guide associated with a category associated with a request, a guide who most closely matches a profile associated with a user associated with a request, and/or a guide meeting combinations of such criteria may be selected to respond to a request. Multiple guides may respond to a request. While specific examples for selecting a guide are described herein, the present invention is not limited to any particular way of selecting a guide to respond to a request. For example, a guide may be selected to handle a request based on the guide's previous assistance to a source of the request. Control is passed to operation 1150 and process 1100 continues.

In operation 1150 a search result is obtained. A search result may be obtained based on any action of a guide. In at least one embodiment, a guide may obtain a text snippet and a reference URL from a web page as a search result. A search result may include any media such as audio, video, text, graphics, computer readable media, scripting language such as Java® or Flash®, etc., which may be indicated to a user. Control is passed to operation 1155 and process 1100 continues.

In operation 1155, an advertisement is requested. In at least one embodiment a contextual ad is requested. In at least one embodiment, the request may include information regarding a result which may be used to select an advertisement. For example, the search system 130 (FIG. 1) may include an indicator of a category, profile, etc. associated with a request and/or search result in a request message provided to the advertising server 165. A category, a profile, a constraint and/or other information associated with a search result may be used to select an advertisement. For example, if a URL associated with a search result is associated with an advertiser, an advertisement from the advertiser may be ranked higher, or if a search result is obtained for resource associated with an age group, an advertisement associated with the age group may be ranked higher. Control is passed to operation 1160 and process 1100 continues.

In operation 1160, a determination is made as to whether an advertisement is received. If in operation 1160 it is determined that an advertisement is not received, control is passed to operation 1165 and process 1100 continues. If in operation 1160 it is determined that an advertisement is received, control is passed to operation 1170 and process 1100 continues.

The determination in operation 1160 may be made based on various criteria. In at least one embodiment, if an advertisement is not received at a server associated with the search system 130 (FIG. 1) from a server associated with an advertiser system (e.g. the advertising server 165) within a pre-determined time interval following a request it may be determined that an advertisement is not received. In at least one embodiment, if a user has a status indicator which indicates that contextual ads are not to be served to the user it may be determined that an advertisement is not received. In at least one embodiment, if an advertisement received has been previously transmitted to a user, it may be determined that an advertisement is not received.

In operation 1165 a search result is delivered to a user. A search result may be transmitted or delivered using any communication service and/or system associated with a user. Control is passed to operation 1175 and process 1100 continues.

In operation 1170, a search result and/or an advertisement is delivered to a user. In at least one embodiment, a contextual ad is provided to a user. A search result and/or a contextual ad may be provided using any service and/or device or system associated with a user. Control is passed to operation 1175 and process 1100 continues.

In operation 1175, process information is recorded. For example, information of a guide, a user, an advertisement and/or other item may be recorded using persistent storage. Information regarding usage of an advertisement, a selection by a guide and/or a selection by a user may be recorded. Information of advertisements delivered to a user, search resources used by a guide, etc., may be recorded in the database 120 (FIG. 1). Control is passed to operation 1105 and process 1100 continues.

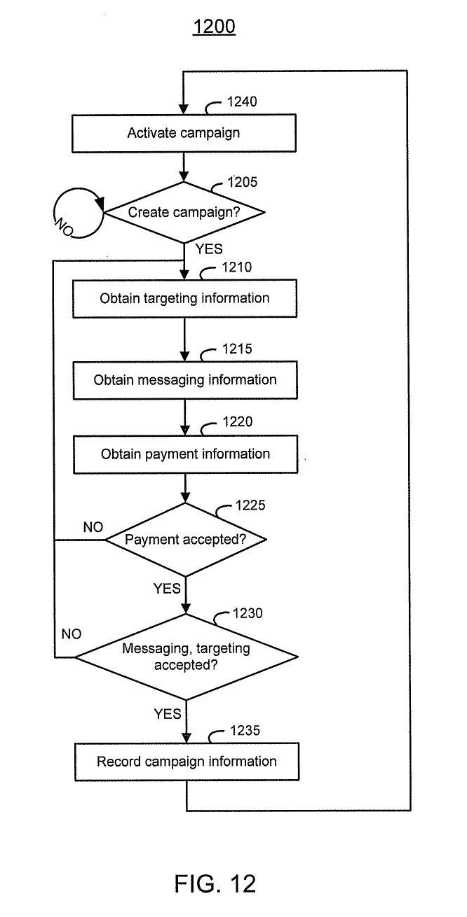

As illustrated in FIG. 12, a process 1200 for creating an advertisement campaign is provided. The process 1200 may be performed in whole or in part by any suitable elements of the system 100 (FIG. 1). In at least one embodiment, the process 1200 is operative on a server associated with the search system 130.

In operation 1205 (FIG. 12), a determination is made as to whether a campaign creation request is received. If it is determined in operation 1205 that a campaign creation request is not received, control remains at operation 1205 and process 1200 continues. If it is determined in operation 1205 that a campaign creation request is received, control is passed to operation 1210 and process 1200 continues.

The determination in operation 1205 may be made using various criteria. In at least one embodiment, if a message is received at a server associated with the search system 130 (FIG. 1), it may be determined that a campaign creation request is received. For example, if an email message, an SMS, EMS, and/or MMS message, an IM, an IP message, and/or a voice message is received at an address associated with the search system 130, it may be determined that a campaign creation request is received.

In operation 1210, targeting information for a campaign is obtained. In at least one embodiment, targeting information may be provided using a web form provided by the search system 130 (FIG. 1). In at least one embodiment, targeting information may be specified using a text or SMS message. Targeting information may include an identifier of a user, a profile of a target user, time information, location information and/or any conditions which may be associated with delivery of a message. Control is passed to operation 1215 (FIG. 12) and process 1200 continues.

In operation 1215, messaging information for a campaign is obtained. In at least one embodiment, messaging information may be provided using a web form provided by the search system 130 (FIG. 1). Messaging information may include media such as text, hyperlinks, audio, video, and/or interactive media. In at least one embodiment, compensation may be associated with a message. In at least one embodiment, an action and response sequence may be associated with a message. Control is passed to operation 1220 (FIG. 12) and process 1200 continues.

In operation 1220, payment information for a campaign is obtained. In at least one embodiment, payment information may be provided using a web form provided by the search system 130 (FIG. 1). Payment information may include credit, debit, payment system, and/or verification information which may be used to provide compensation in return for an advertising campaign. Control is passed to operation 1225 and process 1200 continues.

In operation 1225, a determination is made as to whether payment information of a campaign is accepted. If it is determined in operation 1225 that payment information of a campaign is not accepted, control is passed to operation 1210 and process 1200 continues. If it is determined in operation 1225 that payment information of a campaign is accepted, control is passed to operation 1230 and process 1200 continues.

The determination in operation 1225 may be made in various ways. In at least one embodiment, payment information may be verified by contacting a provider of payment services such as a credit card processing center. In at least one embodiment, a payment service such as the PayPal® service or an Automated Clearing House (ACH) transfer may be used to determine if payment information is accepted. In at least one embodiment, credits available to a user requesting the advertising campaign in an account with the search system 130 (FIG. 1) may be checked to determine whether payment information of a campaign is accepted.

In operation 1230, a determination is made as to whether messaging and targeting of a campaign is accepted. If it is determined in operation 1230 that messaging and targeting of a campaign is not accepted, control is passed to operation 1210 and process 1200 continues. If it is determined in operation 1230 that messaging and targeting of a campaign is accepted, control is passed to operation 1235 and process 1200 continues.

The determination in operation 1230 may be made in various ways. In at least one embodiment, messaging content may be reviewed by automated and/or human assisted methods to determine whether messaging is accepted. Timing, availability, targeting, competition, etc., which may be associated with a campaign may be reviewed and/or validated to determine whether targeting is accepted.

In operation 1235, information of a campaign is recorded. In at least one embodiment, information of a campaign is recorded in the database 120 (FIG. 1). An advertisement, users, messaging, etc., may be ranked and/or recorded using persistent storage. Control is passed to operation 1240 and process 1200 continues.

In operation 1240 a campaign is activated. In at least one embodiment, the search system 130 (FIG. 1) may begin delivering advertising messages to users based on information indicated in the database 120 regarding the campaign. Information indicated in an advertising campaign may be obtained from a server such as the advertising server 165. Control is passed to operation 1205 (FIG. 12) and process 1200 continues.

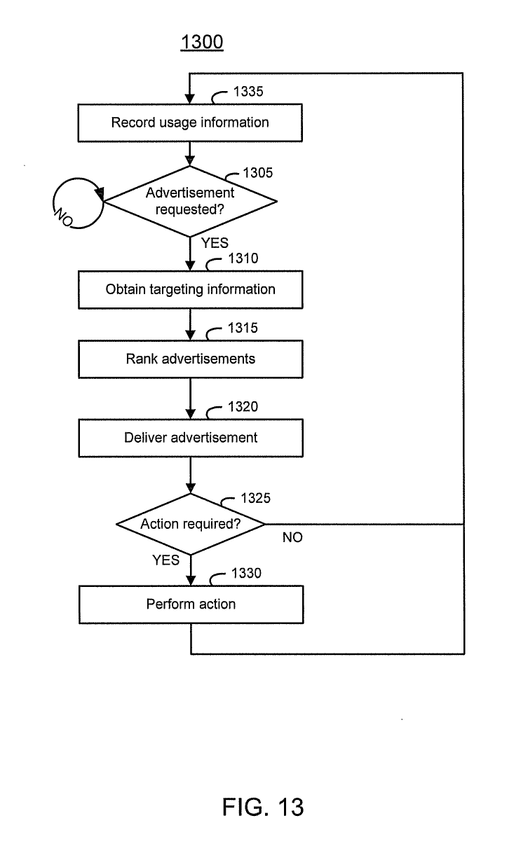

As illustrated in FIG. 13, a process 1300 for delivering an advertisement is provided. The process 1300 may be performed in whole or in part by any suitable elements of the system 100 (FIG. 1). In at least one embodiment, the process 1300 (FIG. 13) is operative on a server associated with the advertising server 165 (FIG. 1).

In operation 1305 (FIG. 13), a determination is made as to whether an advertisement delivery request is received. If it is determined in operation 1305 that an advertisement delivery request is not received, control remains at operation 1305 and process 1300 continues. If it is determined in operation 1305 that an advertisement delivery request is received, control is passed to operation 1310 and process 1300 continues.

The determination in operation 1305 may be made using various criteria. In at least one embodiment, if a message is received at a server associated with the advertising server 165 (FIG. 1), it may be determined that an advertisement delivery request is received. For example, if an email message, an SMS, EMS, and/or MMS message, an IM, an IP message, and/or a voice message is received at an address associated with the advertising server 165, it may be determined that an advertisement delivery request is received.

In operation 1310, targeting information for an advertisement is obtained. In at least one embodiment, targeting information may be provided using an API provided by the advertising server 165 (FIG. 1). In at least one embodiment, targeting information may be specified using a text or SMS message. Targeting information may include an identifier of a user, a profile of a target user, time information, location information and/or any conditions which may be associated with delivery of an advertisement. Control is passed to operation 1315 and process 1300 continues.

In operation 1315, advertisements are ranked. In at least one embodiment, advertisements may be ranked based on a profile. In at least one embodiment, advertisements may be ranked based on compensation provided. In at least one embodiment personal advertisements may be ranked higher than other advertisements. In at least one embodiment, advertisements targeted to an individual user may be ranked higher than other advertisements. Any or all targeting information may be used to rank an advertisement. Control is passed to operation 1320 and process 1300 continues.

In operation 1320, an advertisement is delivered. In at least one embodiment, a personally targeted message is delivered. In at least one embodiment, a web response is provided to the search system 130 (FIG. 1). In at least one embodiment, a message is sent to a server associated with a messaging service such as IM, SMS, EMS, email, etc. Any available communication service may be used to deliver an advertisement. Control is passed to operation 1325 (FIG. 13) and process 1300 continues.

In operation 1325, a determination is made as to whether action is required. If it is determined in operation 1325 that action is not required, control is passed to operation 1335 and process 1300 continues. If it is determined in operation 1325 that action is required, control is passed to operation 1330 and process 1300 continues.

The determination in operation 1325 may be made in various ways. If an advertisement is associated with compensation, or if an advertisement is associated with a notification, or if an advertisement delivery exceeds a predetermined level, it may be determined that an action is required. For example, if an advertisement message is associated with an action such as providing communication information between an originating user and a target user, a message may be sent to provide communication information. If an advertisement is associated with a trigger action, with credits, etc. it may be determined that action is required.

In operation 1330, an action responsive to delivery of an advertisement is performed. In at least one embodiment, an originating user is informed of contact information of a target user to whom an advertisement has been delivered. In at least one embodiment, a message is sent from the advertising server 165 (FIG. 1) to the search system 130. Control is passed to operation 1335 (FIG. 13) and process 1300 continues.

In operation 1335, advertisement usage information is recorded. In at least one embodiment, information is recorded in persistent storage associated with the advertising server 165 (FIG. 1). Inventory, targeting, ranking, delivery, etc., associated with an advertisement may be updated and/or recorded. Information recorded in the advertising server 165 may be recorded in the database 120. Control is passed to operation 1305 and process 1300 continues.

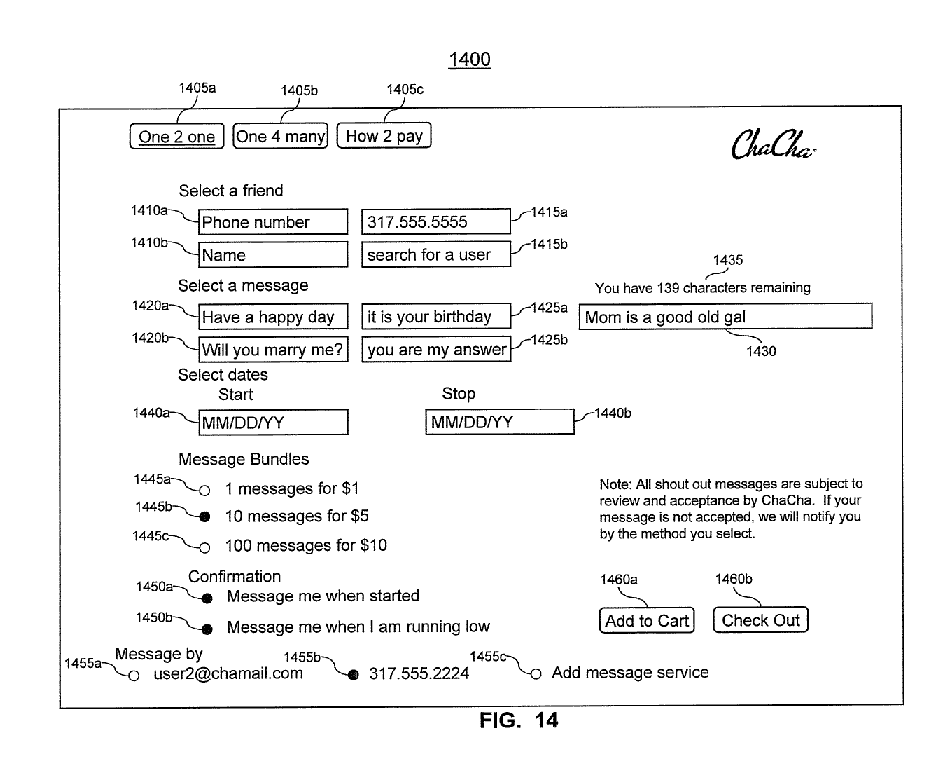

A GUI 1400 for creating a targeted message is illustrated in FIG. 14. The GUI 1400 may be presented on a display device associated with a user system such as the originating user system 140 (FIG. 1). The GUI 1400 may include activity selection controls 1405, target type controls 1410, target value controls 1415, message type controls 1420, message content controls 1425, a messaging box 1430, a constraint indicator 1435, delivery interval controls 1440, package selection controls 1445, confirmation controls 1450, alert controls 1455 and action controls 1460.

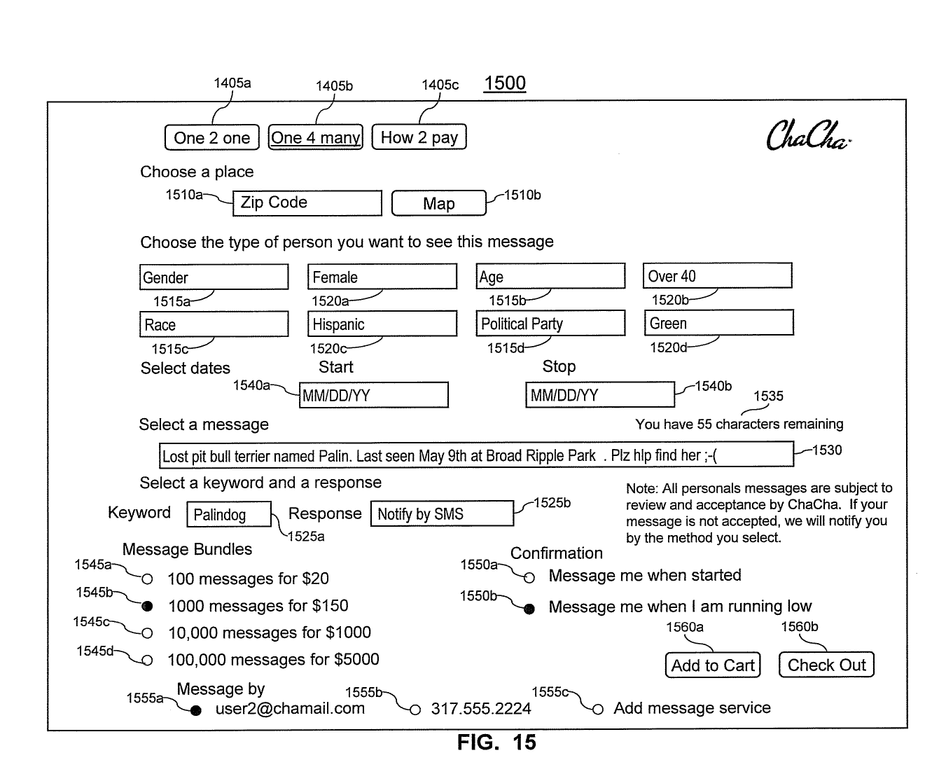

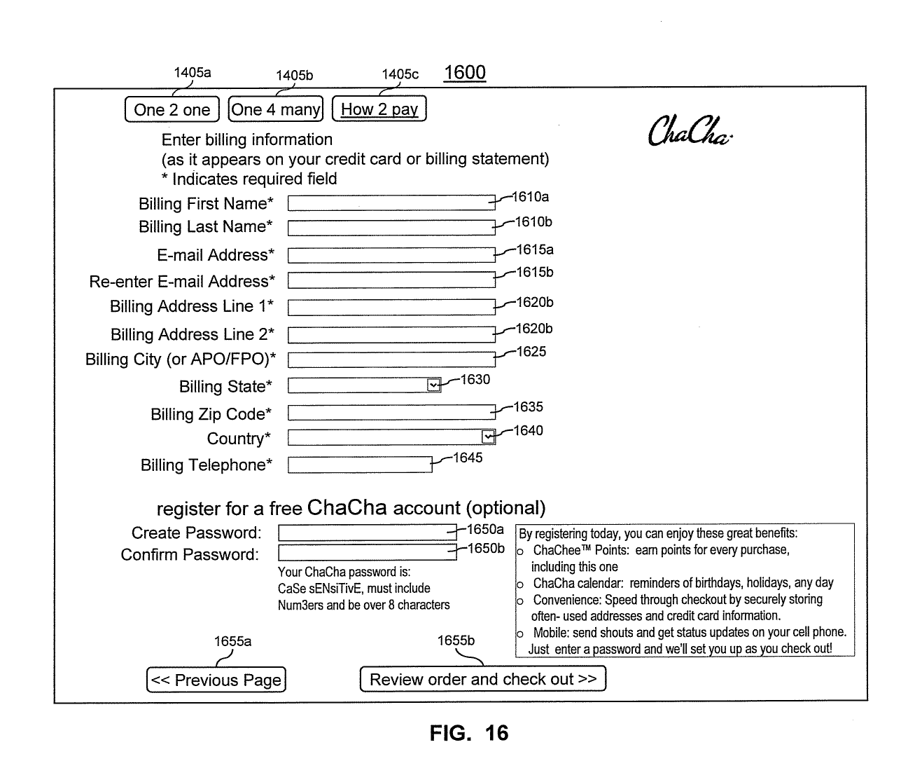

The activity selection controls 1405 may be used to select a messaging activity. The ‘One 2 one’ activity selection control 1405a may cause the GUI 1400 to be provided. The ‘One 4 many’ activity selection control 1405b may cause the GUI 1500 (FIG. 15) to be provided. The ‘How 2 pay’ activity selection control 1405c may cause the GUI 1600 (FIG. 16) to be provided. Activation status of the activity selection controls 1405 may be indicated in any suitable way such as color, shading, etc. Using the example in FIG. 14, the underline indicates that the activity selection control 1405a is active.

The target type controls 1410 may be used to indicate a type of targeting information to be used to select a user to receive a personal message. The target type controls 1410 may be any type of indicator control such as a drop-down list or typing box, etc. The target type control 1410a indicates that a phone number may be provided in the target value control 1415a. The target type control 1410b indicates that a name may be provided in the target value control 1415b which may be searched in a user database.

The message type controls 1420 may be used to select a template message. The message content controls 1425 may be used to add content to a message based on a template selected using the message type controls 1420. The message type control 1420a has selected ‘have a happy day’ and the message content control 1425a selects ‘it is your birthday’. The message type control 1420b has selected ‘will you marry me?’ and the message content control 1425b selects ‘you are my answer’. The messaging box 1430 may be used to enter free-form information for a message. Limitations of messaging, such as the length of a text message, are indicated in the constraint indicator 1435. While a text message is illustrated, it is contemplated that any type of media such as pictures, video, audio, etc., might be indicated using the messaging box 1430.

The delivery interval controls 1440 may be used to indicate a time interval during which a message is to be delivered. The delivery interval control 1440a indicates a start time. The delivery interval control 1440b indicates a stop time. Activation of a delivery interval control may provide a calendar, or other date entry interface as is well known in the art. The package selection controls 1445 may be used to select a package or ‘bundle’ of messages for purchase. The package selection controls 1445 may be ‘radio’ buttons. The package selection control 1445a selects ‘1 message for $1’. The package selection control 1445b selects ‘10 messages for $5’. The package selection control 1445c selects ‘100 messages for $10’. The package selection control 1445b is active as indicated by the ‘spot’.

The confirmation controls 1450 may be used to indicate conditions which will cause a notification to be sent to an originating user. The confirmation control 1450a may be activated to send a notification when a delivery starts. The confirmation control 1450b may be activated to send a notification when a number of remaining messages is low. The alert controls 1455 may be used to specify a service which is to be used to deliver a message regarding a personal advertisement. The alert control 1455a may be activated to send a notification to ‘user2@chamail.com’. The alert control 1455b may be activated to send a notification to ‘317.555.2224’. The alert control 1455c may be activated to send a notification to a new service, which might be added by for example ‘right-clicking’ on the alert control 1455c. The action control 1460a may be used to add items defined using the GUI 1400 to an electronic shopping cart. The action control 1460b may be used to cause a payment GUI such as the GUI 1600 (FIG. 16) to be provided.

A GUI 1500 for creating a targeted message is illustrated in FIG. 15. The GUI 1500 may be presented on a display device associated with a user system such as the originating user system 140 (FIG. 1). The GUI 1500 (FIG. 15) may include the activity selection controls 1405, target geographic controls 1510, target profile controls 1515, target profile value controls 1520, action indicators 1525, a messaging box 1530, a constraint indicator 1535, delivery interval controls 1540, package selection controls 1545, confirmation controls 1550, alert controls 1555 and action controls 1560.

The target geographic controls 1510 may be used to indicate geographic targeting information to be used to select a user to receive a personal message. The target geographic controls 1510a may be any type of indicator control such as a drop-down list or typing box, etc. The target geographic control 1510b may cause a display such as a map to be provided to allow selection of a target area using a map.

The target profile controls 1515 and the target profile value controls 1520 may be used to select a characteristic and a nominal value of a characteristic for targeting a personal message. The target profile control 1515a and the target profile value control 1520a indicate that the ‘gender’ ‘Females’ are selected. The target profile control 1515b and the target profile value control 1520b indicate that persons of age ‘over 40’ are selected. The target profile control 1515c and the target profile value control 1520c indicate that the ‘race’ ‘Hispanics’ are selected. The target profile control 1515d and the target profile value control 1520d indicate that the political party ‘Green’ party is selected. A selection in the target profile controls 1515 may cause the available options in the target profile value controls 1520 to be modified.

The action indicators 1525 may be used to indicate a response and an action associated with a personal message. The ‘keyword’ action indicator 1525a may be used to indicate a keyword or other action which may be used to respond to a personal message such as the keyword ‘Palindog’. The ‘response’ action indicator 1525b may be used to indicate an action which is to be performed responsive to the action indicated in the action indicator 1525a, such as the response ‘Notify by SMS’. The messaging box 1530 may be used enter free-form information for a message. Limitations of messaging, such as the length of a text message, are indicated in the constraint indicator 1535. While a text message is illustrated, it is contemplated that any type of media such as pictures, video, audio, URL's, etc., might be indicated using the messaging box 1530.

The delivery interval controls 1540 may be used to indicate a time interval during which a message is to be delivered. The delivery interval control 1540a indicates a start time. The delivery interval control 1540b indicates a stop time. Activation of a delivery interval control may provide a calendar, or other date entry interface as is well known in the art. The package selection controls 1545 may be used to select a package of messages to purchase. The package selection controls 1545 may be ‘radio’ buttons. The package selection control 1545a selects ‘100 messages for $20’. The package selection control 1545b selects ‘1000 messages for $150’. The package selection control 1545c selects ‘10,000 messages for $1000’. The package selection control 1545d selects ‘100,000 messages for $5000’. The package selection control 1545b is active as indicated by the ‘spot’.

The confirmation controls 1550 may be used to indicate conditions which will cause a notification to be sent to an originating user. The confirmation control 1550a may be activated to send a notification when a delivery starts. The confirmation control 1550b may be activated to send a notification when a number of remaining messages is low. The alert controls 1555 may be used to specify a service which is to be used to deliver a message regarding a personal advertisement. The alert control 1555a may be activated to send a notification to ‘user2@chamail.com’. The alert control 1555b may be activated to send a notification to ‘317.555.2224’. The alert control 1555c may be activated to send a notification to a new service, which might be added by for example ‘right-clicking’ on the alert control 1555c. The action control 1560a may be used to add items defined using the GUI 1500 to an electronic shopping cart. The action control 1560b may be used to cause a payment GUI such as the GUI 1600 (FIG. 16) to be provided.

A GUI 1600 for providing payment information is illustrated in FIG. 16. The GUI 1600 may be presented on a display device associated with a user system such as the originating user system 140 (FIG. 1). The GUI 1600 (FIG. 16) may include the activity selection controls 1405, name indicators 1610, email indicators 1615, address indicators 1620, a city indicator 1625, a state indicator 1630, a zip code indicator 1635, a country indicator 1640, a telephone number indicator 1645, password indicators 1650, and action controls 1655.

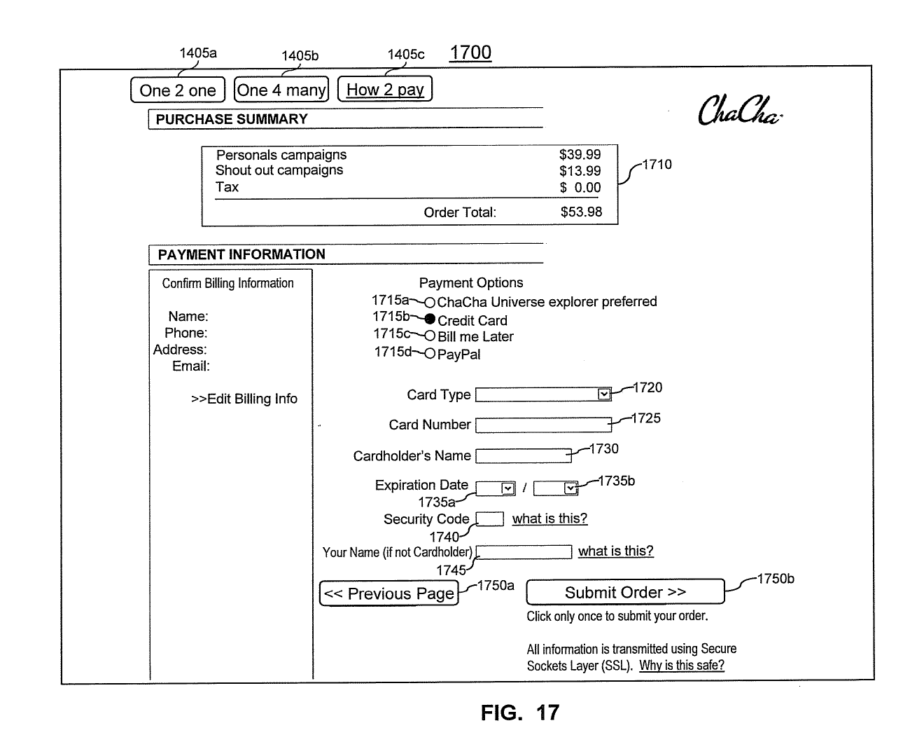

The name indicator 1610a may be used to provide a first name. The name indicator 1610b may be used to provide a last name. The email address indicator 1615a may be used to provide an email address. The email indicator 1615b may be used to confirm an email address. The address indicator 1620a may be used to indicate a street address. The address indicator 1620b may be used to indicate additional address information. The city indicator 1625 may be used to indicate a city, etc. The state indicator 1630 may be a pull-down list to provide state information. The zip code indicator 1635 may be used to provide a zip code. The country indicator 1640 may be a pull-down list to provide country information. The telephone indicator 1645 may be used to provide a telephone number. The password indicator 1650a may be used to provide a password. The password indicator 1650b may be used to confirm a password. The action control 1655a may be used to return to a previous GUI. The action control 1655b may be used to cause a check out GUI such as the GUI 1700 (FIG. 17) to be provided.

A GUI 1700 for confirming a purchase is illustrated in FIG. 17. The GUI 1700 may be presented on a display device associated with a user system such as the originating user system 140 (FIG. 1). The GUI 1700 (FIG. 17) may include the activity selection controls 1405, a purchase summary 1710, payment selection indicators 1715, a card type indicator 1720, a card number indicator 1725, a name indicator 1730, expiration indicators 1735, a security indicator 1740, an alternate name indicator 1745, and action controls 175.

The purchase summary 1710 may provide details of a current purchase. The payment selection indicators 1715 may be used to indicate a selected type of payment service. The payment selection indicator 1715a may be used to select a ChaCha Universe payment method. The payment selection indicator 1715b may be used to select a credit or debit card payment method. The payment selection indicator 1715c may be used to select a delayed billing payment method. The payment selection indicator 1715d may be used to select a PayPal® payment method. The card type indicator 1720 may be used to indicate a credit or debit card type. The card number indicator 1725 may be used to indicate a credit or debit card number. The cardholder's name indicator 1730 may be used to indicate a name. The expiration date indicator 1735a may be a pull-down list to provide month information. The expiration indicator 1735b may be a pull-down list to provide year information. The security code indicator 1740 may be used to provide a security code. The alternate name indicator 1745 may be used to provide an alternate name associated with a payment method. The action control 1750a may be used to return to a previous GUI. The action control 1750b may be used to submit an order for processing and close the GUI 1700.

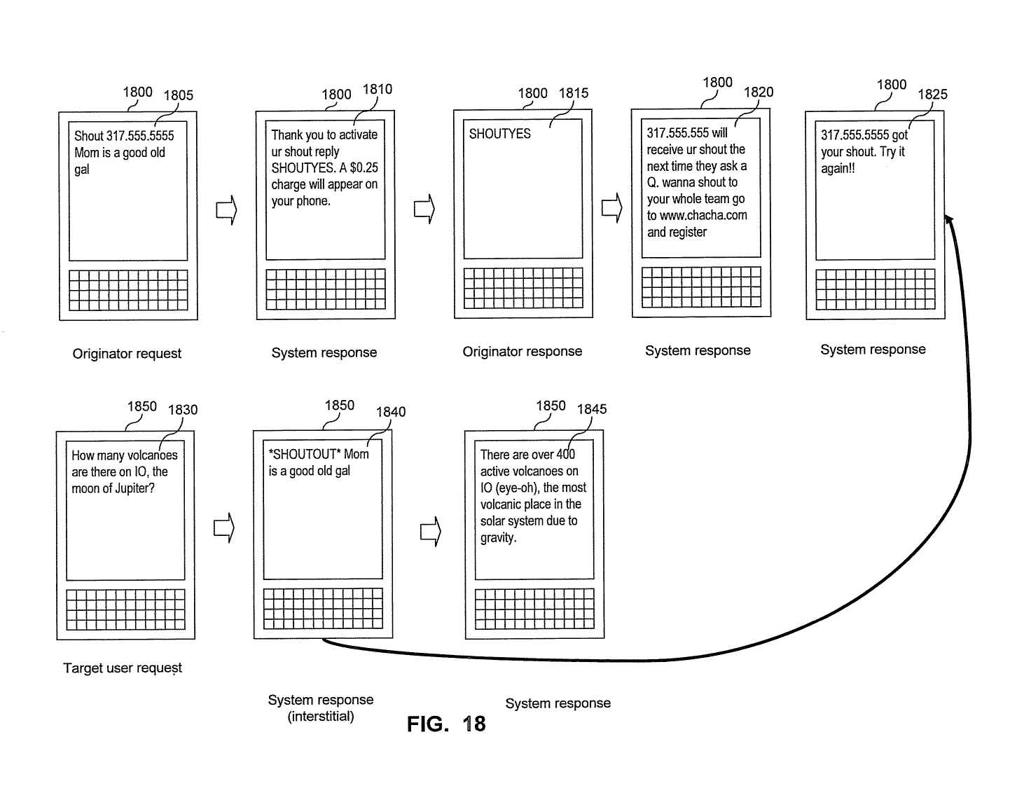

An exemplary message flow for creation of a person to person advertising or messaging campaign using SMS messaging is illustrated in FIG. 18.

An originating user device 1800 may transmit an origination message 1805. A publishing system such as the search system 130 (FIG. 1) may respond with a confirmation request message 1810 (FIG. 18). The originating user device 1800 may respond with a user confirmation message 1815. The search system 130 (FIG. 1) may reply with a system confirmation message 1820 (FIG. 18). If a target user device 1850 accesses a publishing service such as a search service using a request message 1830, the target user device 1850 may receive a ‘shoutout’ personal advertising message 1840. The target user device 1850 may subsequently receive an answer message 1845. Responsive to delivery of the personal advertising message 1840 the originating user device 1800 may receive a confirmation message 1825.

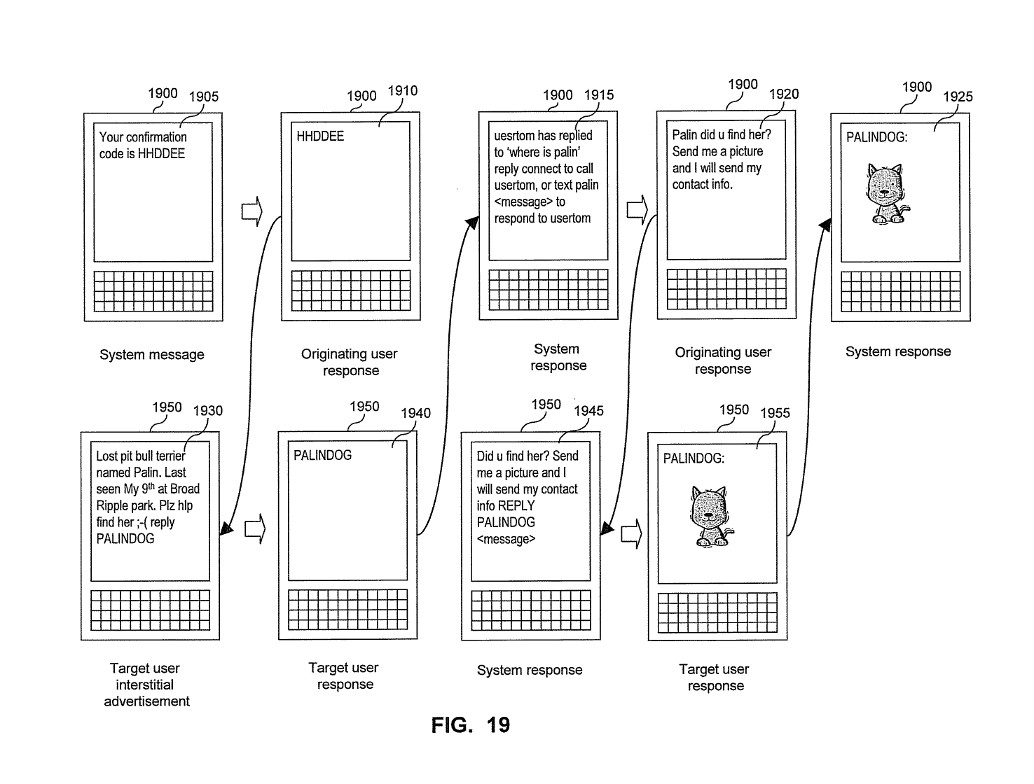

An exemplary message flow for a personal advertisement targeted to an anonymous group (e.g. the ‘where is palin’ campaign illustrated in FIG. 15) is illustrated in FIG. 19.

The originating user device 1900 may receive a confirmation code message 1905 which may be used to verify that a user has placed the subject campaign request. The originating user device 1900 may respond with a confirmation message 1910. A target user device 1950 which is anonymous to the originating user device 1900 may receive a personal advertisement message 1930 which may be associated with a response action (i.e., reply ‘PALINDOG’). If the target user device 1950 responds with an action trigger response message 1940 which includes the action trigger, the originating user device may receive a system response message 1915 which may be associated with an action trigger (i.e., the ‘palin <message>’ response) which may allow the originating user device 1900 to contact the target user device 1950. Any available communication service may be used, as previously mentioned. Responsive to the system response message 1915 the originating user device 1900 may transmit an originating user response message 1920. The target user device 1950 may receive a system communications message 1945 which is based on the originating user response message 1920. The target user device 1950 may respond with a target user response message 1955. The search system 130 (FIG. 1) may cause the originating user device 1900 (FIG. 19) to receive a private response message 1925. Any number of messages may be exchanged, between the originating user device 1900 and the target user device 1950. Communication between an originating user and a target user may be controlled by keywords, historical information, etc. which may be facilitated by a publishing or search service. Any number of target users and originating users may exchange messages. Messages may be exchanged in real time, as with conventional messaging systems, or may be provided when a target user and/or an originating user are engaged with a search or publishing service.

A reward system associated with a message may be used in various ways. For example, an originating user may provide an incentive for a target user to respond to a message, take an action, etc. A target user and an originating user may be the same person. This may allow a user to enjoy services on a pay per use basis. In at least one embodiment, a user may elect to pay for a personal message using billing via a mobile service provider.

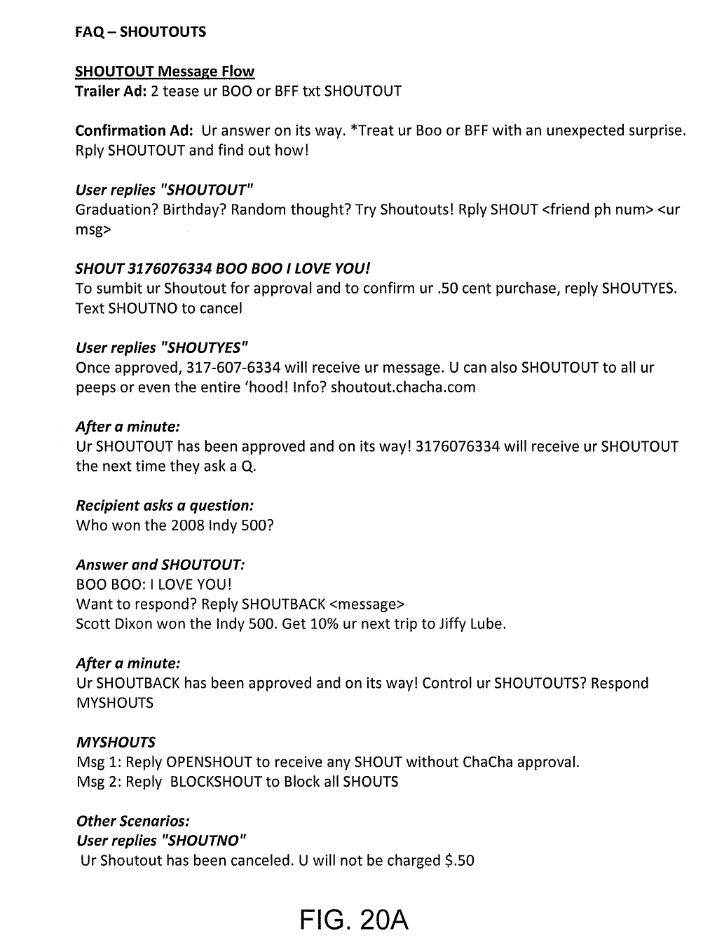

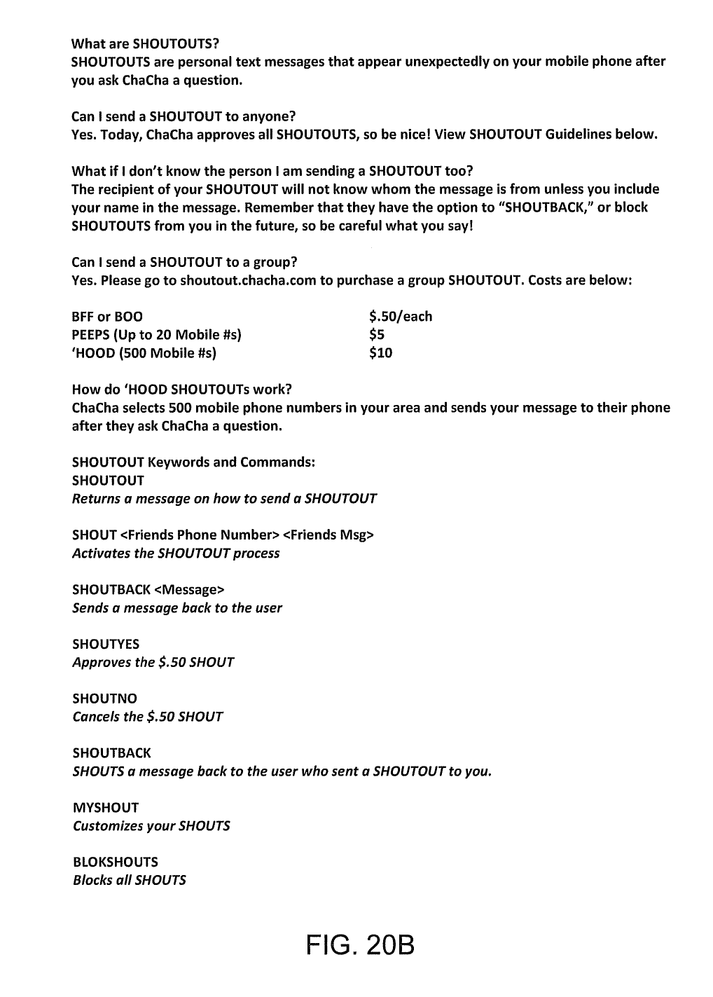

An exemplary sequence of message flows and frequent queries for users of the personal messaging system are illustrated in FIGS. 20A and 20B. As illustrated in FIG. 20A, a user may receive a message inviting the user to try the service, direct a message to a target user, receive notification of approval, and receive notification of delivery. If a target user elects to ‘Shout back’ the role of the target user and the originating user may be reversed, even if the originating user is unknown to the target user. If an originating user elects to cancel a personal message, a command to cancel such as “SHOUTNO” may be provided. Various text commands which may be used to manipulate delivery, check status and manage information of personal messages may be provided as illustrated in FIG. 20A.

As illustrated in FIG. 20B a potential user of a personal messaging service may be provided with instructions and information regarding various forms of the personal messaging service which may be available. The FAQ may for example be provided to users using a webpage associated with a search service.

Simple Messaging Service (SMS) or ‘text’ messaging has become a convenient way for users to obtain information. Generally, the user interface is well known to many people who already use SMS for everyday communication. More than thirty billion SMS messages were sent in 2008. For this reason along with others mentioned above, SMS based search has become popular. Services such as ChaCha and Google SMS have provided hundreds of millions of text responses to text queries. Such services may be advertising supported in order to lower the barriers to use of the service. In such an instance, a text advertising message may be provided to a user prior to and/or as part of a search result. This form of advertising is successful as it allows a user to receive a highly targeted advertisement, which may be the only ad presented.

An advertisement provided to a user as a text message may include a web link (URL), or a telephone number which may be associated with an advertiser who provided the advertisement. These options have some limitations. A URL may require use of a browser, which may be expensive or difficult. A telephone number may be remembered, but may not be traceable to the advertisement which was delivered to the user and thus the advertiser may not be able to measure efficacy of a publisher.

Due to these problems, what is needed is a method and system whereby a user may submit a message which may cause a live connection to be established between the user and a provider identified by the message.

A query is originated from a user device requesting information and provided to a search service. An advertisement is delivered to a user device, which may indicate a response message, which may allow a user to communicate with a provider of goods and/or services a ‘provider’. An advertisement is provided to the user as a text message which may be presented before, after, and/or in combination with a search result. A user may elect to respond with a text message including a response message. A search system may determine that a response message has been received and may establish a voice connection with a provider identified in the response message. A search system may establish a voice connection with a user. A search system may bridge a voice connection between a user and a provider. A response message may be a keyword, or other identifier which is readily remembered, and may be the first and/or only content of a response message. Incoming messages from a user may be parsed for a keyword which is unique to a number of users.

A system is further provided whereby a user or information seeker may submit a request for information, search request, query, or “request” to a search system which determines whether a human assistant, or “guide”, is required to provide a response to the search request. If a guide is required to respond to a user request, the guide may be selected based on keywords, categories, profiles, and/or other information associated with the request and the guide. Information resources, search resources or “resources”, which may assist a guide in obtaining a search result, may be matched to a search request and may be provided to the guide to facilitate a search. A search result, or “result”, which may include any type of media, information, software, etc., which may be delivered to a user is provided to the user responsive to a search request. A search result may include an advertisement. An advertiser may provide advertising media to a search system, and may provide payments to the search system responsive to delivery of advertisements to users.

A database is provided which includes records associated with various items which may be internal information of the search system such as keywords, categories, profiles, etc., and/or external objects or entities such as users, guides, advertisers, resources, providers, and/or systems, and/or devices associated with an object, person or entity. Information indicated in a database may be used to track, record, and optimize usage of any items identified in the database. For example, ratings of guides associated with a category may be used to rank the guides to select a guide to respond to a query associated with the category. Likewise, ratings associated with advertisements might be used to select an advertisement to be presented to a user responsive to a query in order to optimize user response rate and revenue for the search system.

A connection between a user and a provider may be established in various ways. In at least one embodiment, a Voice over Internet Protocol (VoIP) connection is established. A connection to a provider may include establishing a voice connection with a guide who may act as an intermediary to a merchant in order that a user may make a purchase from a merchant which may not provide a voice-based ordering system.

A number of fraud prevention measures may be implemented. A user may be informed that a voice connection will be established prior to the connection being completed, which may allow the user to decline the connection. Any or all of a voice communication session may be recorded in order that success, purchase amount, and/or other information which may be used to measure efficacy may be gathered. Information obtained from providers and/or merchants may be used to determine whether a user is afforded access to a service and/or provider. Information obtained from users may be used to rate and/or rank providers, guides, merchants, advertisers, etc.

Anonymous communications can be established between a user and a provider. This may allow a user to utilize a merchant and provide a method of contacting the user which does not compromise user privacy. Similarly a provider may sell an item and/or service under any desired terms without explicitly revealing the provider as the seller. This might for example allow differentiated pricing, or inventory reduction without commensurate brand image consequences.

As a user is presented with a mnemonic message element (e.g. a text keyword), a connection may be made more easily than via a telephone number which may be long, complex, and difficult to access from a messaging application of a user device. An advertiser and/or provider may promote a brand image while allowing affiliated local outlets to be contacted via the same mnemonic, reducing the need for toll-free access. Tracking phone numbers may not be required as a search system server may provide needed communication cross referencing to a designated local provider if required. Advertising efficacy and pricing may be performed on a cost per call, cost per action, or percentage of purchase basis, which may allow a more tightly coupled and measurable advertising system.

As advertising may be localized, promotional campaigns for regional, national, or international providers may be differentiated based on a local environment. Connections can be optimized in a similar manner to advertising campaigns. For example, if a user location is known, the user may be connected to a local provider using a local phone number, rather than a tracking toll-free number. Likewise, a local provider for a franchise may offer local promotions while keeping the brand equity associated with a short, recognizable brand keyword. The new system provides convenience, privacy, localization, and personalization which internet links or 800 numbers and/or other current technologies may not be able to offer.

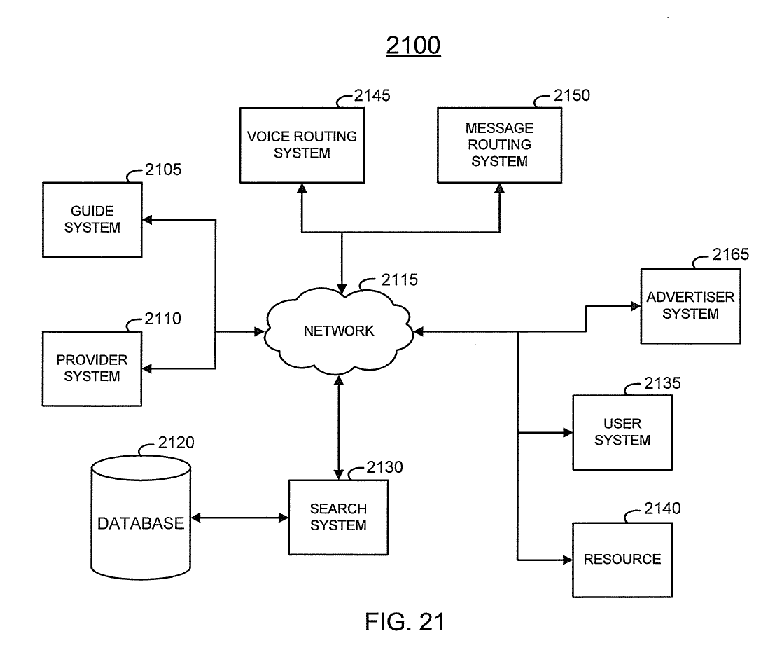

As illustrated in FIG. 21, a system 2100 includes: a guide system 2105, a provider system 2110, a network 2115 such as the Internet, a search system 2130, a user system 2135, a resource 2140, a database 2120 which may comprise various records, a voice routing system 2145, a message routing system 2150, and an advertiser system 2165.

While only a single system associated with a guide, provider, user, resource, advertiser, voice routing system, message routing system and a search system are depicted in FIG. 21, it is within the scope of the disclosure for multiple systems for guide, provider, user, resource, advertiser, voice routing, message routing and search services to be utilized. In particular it is envisioned that many guide, provider, user, resource, and advertiser systems may be implemented. Further, it is expected that multiple voice and message routing services and suppliers may be utilized. The search system 2130 may be a composed of any number of components as described further herein.

Any user system (e.g. the user system 2135) can be used to submit a search request to the search system 2130 and/or receive a search result and/or other information. Any guide system (e.g., the guide system 2105) can be operated by a human searcher to obtain a search result responsive to a request which may have been submitted by an information seeker located at a user system (e.g., the user system 2135). Any resource (e.g., the resource 2140) may be operated by a human provider of information and/or may be an automated system which may provide a search result and/or other information to a guide, provider, advertiser and/or a user. For example, a resource may be a search engine, a database, an RSS feed, an index collection, a local information source of a guide system such as a disk or removable memory, etc. A resource might include printed materials, images, video, and/or audio information, a software application, any information accessible to a guide, a user, a provider, an advertiser, a system and/or any combination thereof.

The network 2115 may be a global public network of networks (the Internet) and/or may consist in whole or in part of one or more private networks and communicatively couples the guide system 2105, the provider system 2110, the user system 2135, the resource 2140, the voice routing system 2145, the message routing system 2150, and the advertiser system 2165 with the other components of the system such as the search system 2130, and the database 2120. The network 2115 may include one or more wireless networks which may enable wireless communication between the various elements of the system 2100. For example, the message routing system 2150 may include systems of wireless service providers and/or wireless messaging aggregators. A wireless service carrier may receive messages from a user device via a wireless network which is a part of the network 2115, and provide the messages to a wireless messaging aggregator via an internet connection which is part of the network 2115. A wireless messaging aggregator may provide user messages to the search system 2130 via an Internet Protocol (IP) connection. The same routing might be used in reverse in order that the search system 2130 may provide a message to the user system 2135 using the network 2115. Similarly a voice communication via wired and/or wireless communication might be established between any elements of the system 2100 using the network 2115 and the voice routing system 2145.

The search system 2130 allows interaction to occur among the guide system 2105, the provider system 2110, the voice routing system 2145, the message routing system 2150, the user system 2135, the resource 2140 and the advertiser system 2165. For example, an information search query or request can be transmitted from the user system 2135 to the search system 2130, where a search query can be accessed by the guide system 2105 and/or the resource 2140. Similarly, a search result produced from the resource 2140 using the guide system 2105 in response to a search query submitted by the user system 2135 may be transmitted to the search system 2130, where it may be stored by the search system 2130 and/or may be transmitted to the user system 2135. An advertisement might be obtained from the advertiser system 2165 and transmitted to the user system 2135 as an SMS or MMS message using the message routing system 2150. Any type of communication between a user, a guide, a provider, an advertiser and a resource may be mediated and/or facilitated by the search system 2130, and/or other elements of the system 2100.

The search system 2130 is communicatively coupled with the database 2120. As will be described herein in further detail below, the database 2120 may include persistently stored information that is processed in association with operation of the embodiments. Although FIG. 21 illustrates the database 2120 as a separate component of the system 2100, the database 2120 may be integrated with the search system 2130. Further, the records maintained in the database 2120 may be stored in any typical manner, including in a Network Attached Storage (NAS), a Storage Area Network (SAN), etc., using any typical or proprietary database software such as DB2®, Informix®, Microsoft® SQLServer™, MySQL®, Oracle®, etc., and may also be a distributed database on more than one server. Elements of the database 2120 may reside in any suitable elements of the system 2100. Any or all elements of the system 2100 may include any part or the entirety of the database 2120.

The user systems 2135, the resource 2140, the guide systems 2105, the provider system 2110, the search system 2130, the voice routing system 2145, the message routing system 2150, and the advertiser system 2165, may include equipment, software, systems and personnel required to send and/or receive messages between a user system, a guide system, a provider system, a resource, an advertiser system, a voice or message routing system and/or the search system using the network 2115. The database 2120 includes information which may allow the search system 2130 to establish communication between any or all of the elements of the system 2100.

A user system, a guide system, a provider system, an advertiser system, and/or a resource may be a desktop or portable PC or Mac®, a mobile phone, a smart phone, a PDA, a server system, a landline phone, a specialized communication terminal, a terminal connected to a mainframe, or any other communication device and/or system. The search system 2130 may include one or more servers, computers, etc. For example, servers such as the PowerEdge® 2900 by Dell, or the BladeCenterJS22 by IBM, or equivalent systems might be used to implement elements of the search system 2130. The search system 2130 may utilize an operating system (OS) such as Microsoft Windows XP, or Linux, etc. Voice routing and packet switching may be accomplished using well established technologies such as those provided by Cisco, or other networking companies. After being presented with the disclosure herein, one of ordinary skill in the relevant art will immediately realize that any viable computer systems or communication devices known in the art may be used as user systems, guide systems, provider systems, advertiser systems, resources, voice routing systems, message routing systems, and/or to implement the search system 2130.

A guide may be required to register with the search system 2130. As part of a registration process, at least one communication method is associated with a guide. In at least one embodiment, a guide may register with the search system 2130 and establish a username and password which are associated with the guide. A guide may login to the search system 2130 using a web browser functionality of the guide system 2105 in order to communicate with the search system 2130. Multiple communication services may be associated with a guide and may allow a communication session to be established between a guide system such as the guide system 2105 and a user system, a provider system, an advertiser system, a resource and/or the search system 2130. Multiple identifiers of a guide may be associated with each other. Information such as IM credentials, an email address, a phone number, a URL, a username, etc., of a guide may be identified which may allow the search system 2130 to establish a communication session between a guide system and a user system, a resource, a provider system, an advertiser system, and/or the search system 2130.

When a guide registers with the search system 2130, the guide may be associated with one or more keywords, categories, and/or other information. For example, a keyword or category may be selected by a guide, or may be associated with a guide based on a test administered to a guide and/or other information provided during and/or after a registration process. Information associated with a guide may be stored in the database 2120 and may be used for purposes such as matching a guide to a user request, determining and/or providing compensation for a guide, communicating with a guide, etc., as will be described further herein below. A guide may be associated with one or more advertisers. Registration, profile, and/or other information of a guide may be provided by an advertiser.

A user may be identified by the search system 2130. When a user system such as the user system 2135 establishes a communication session with the search system 2130, an identifier of a user system is determined. An identifier of a user system may be associated with other information regarding a user. A user system may be identified using an email address, a telephone number, an IM credential, a username, and/or any other identifier which may be used to associate information with a user. Multiple identifiers of a user may be associated with each other. Using information of communication services associated with a user, a communication session may be established between a user system such as the user system 2135 and a guide system, a provider system, an advertiser system, a resource and/or the search system 2130. Information such as a keyword, a category, a user profile, a previous search request, a search result, etc., may be associated with a user. Information of a user may be stored in the database 2120.

A resource, which may be a person, an entity, a search engine, a database, a software application, a corpus of one or more types of media such as text or printed information, images, audio, video, etc., or a combination thereof, may be identified by the search system 2130. Any source of information may be a resource within the context of the disclosure herein. Information of at least one method of communication is associated with a resource which allows a communication session to be established between the search system 2130, the user system 2135, the provider system 2110, the advertiser system 2165 and/or the guide system 2105 and the resource 2140. An identifier of a resource may be associated with other information regarding a resource. A resource may be identified using an email address, a telephone number, an IM credential, a resource username, a URL or other persistent identifier which may be used to associate information with a resource. Multiple identifiers of a resource may be associated with each other. Using the information of communication services associated with a resource, a communication session may be established between a resource such as the resource 2140 and a user system, a guide system, an advertiser system, a provider system and/or the search system 2130. Information such as a keyword, a category, a profile, and/or other information may be associated with a resource. Information of a resource may be stored in the database 2120.

A resource, such as the resource 2140, may include any systems, software, hardware, personnel and/or other facilities which may provide information to a guide, a provider, a user, an advertiser and/or the search system 2130. For example, a resource may be a search engine, a database system, a library, a personal hard drive and/or other local storage, printed materials, recordings of any sort, a software program, a person or persons, an organization, etc. A resource may be freely accessible to any user and/or guide and/or may be available on a restricted basis. The resource 2140 may include resources which are available on an unrestricted and/or restricted basis. A resource may not be accessible using the network 2115, but may be accessible to a selected guide, user, provider, and/or advertiser.

An advertiser may be required to register with the search system 2130. As part of a registration process, at least one communication method is associated with an advertiser. In at least one embodiment, an advertiser may register with the search system 2130 and establish a username and password which are associated with the advertiser. An advertiser may login to the search system 2130 using a web browser functionality of the advertiser system 2165 in order to communicate with the search system 2130. Multiple communication services may be associated with an advertiser and may allow a communication session to be established between an advertiser system, such as the advertiser system 2165, and a user system, a guide system, a provider system, a resource system and/or the search system 2130. Multiple identifiers of an advertiser may be associated with each other. Information such as IM credential, an email address, a phone number, a URL, a username, etc., of an advertiser may be identified which may allow the search system 2130 to establish a communication session between an advertiser system and a user system, a guide system, a provider system, a resource, and/or the search system 2130.

When an advertiser registers with the search system 2130 the advertiser may be associated with one or more keywords, categories, and/or other information. For example a keyword or category may be selected by an advertiser, or may be associated with an advertiser based on activities of an advertiser and/or persons associated with an advertiser and/or other information provided during and/or after a registration process. Information associated with an advertiser may be stored in the database 2120 and may be used for purposes such as matching an advertiser to a request, a user, a guide, a provider, etc., determining and/or obtaining compensation from and/or for an advertiser, communicating with an advertiser, etc., as will be described further herein below. An advertiser may be associated with one or more guides. Registration and/or other information of an advertiser may be provided by a guide and/or other person. An advertiser may provide information of a resource which may be associated with the advertiser, and may provide access information for a resource.

An advertiser system may provide information of any type of content and/or other information which may be associated with sponsorship information. For example, audio, video, web pages, interactive games, software, etc., which might be sponsored by an advertiser, may be provided by an advertiser system such as the advertiser systems 2165.

A provider may be required to register with the search system 2130. As part of a registration process, at least one communication method is associated with a provider. In at least one embodiment, a provider may register with the search system 2130 and establish a username and password which are associated with the provider. A provider may login to the search system 2130 using a web browser functionality of the provider system 2110 in order to communicate with the search system 2130. Multiple communication services may be associated with a provider and may allow a communication session to be established between a provider system such as the provider system 2110 and a user system, a guide system, an advertiser system, a resource and/or the search system 2130. Multiple identifiers of a provider may be associated with each other. Information such as IM credentials, an email address, a phone number, a URL, a username, etc., of a provider may be identified which may allow the search system 2130 to establish a communication session between a provider system and a user system, a guide system, an advertiser system, a resource, and/or the search system 2130.

When a provider registers with the search system 2130, the provider may be associated with one or more keywords, categories, and/or other information. For example, a keyword or category may be selected by a provider, or may be associated with a provider based on activities of a provider and/or persons associated with a provider and/or other information provided during and/or after a registration process. Information associated with a provider may be stored in the database 2120 and may be used for purposes such as matching a provider to a request, a user, a guide, an advertiser, etc., determining and/or obtaining compensation from and/or for a provider, communicating with a provider, etc., as will be described further herein below. A provider may be associated with one or more guides and/or advertisers. Registration and/or other information of a provider may be provided by a guide and/or other person. A provider may provide information of a resource which may be associated with the provider, and may provide access information for a resource.

The search system 2130 may establish a communication session between any user system, guide system, provider system, advertiser system or resource system using information indicated in the database 2120. For example, the user system 2135 may establish a voice communication session with the search system 2130, the search system 2130 may establish a voice communication session between the user system 2135 and the guide system 2105, and the search system 2130 may establish a voice communication session between the user system 2135 and the advertiser system 2165. While a voice communication session is used in this example, any type of communication session using one or more services such as SMS, EMS, MMS, email, IM, chat, web based communication, etc., may be established between any user system, guide system, provider system, advertiser system and/or resource and/or the search system 2130.

Information associated with a user, a guide, a provider, an advertiser, and/or a resource may be obtained in various ways. For example, a registration process may be performed using a web form provided by the search system 2130, and/or information may be obtained from an external database, and/or information may be obtained based on analysis of information indicated by a user, a guide, an advertiser, a provider and/or a resource. A ‘profile’ is one or more characteristics which may be associated with one or more individuals. A profile may include geographic data such as a street address, latitude and longitude, etc., may include demographic information such as age, gender, race, income, family size, political affiliations, etc., may include personality information such as results of psychometric testing, subjective evaluations of an individual, etc., may include affiliation information such as employment, club, activity, societal membership information, information of a device, service, transaction and/or any information which might be associated with a user, a guide, a provider, a merchant, and/or an advertiser.

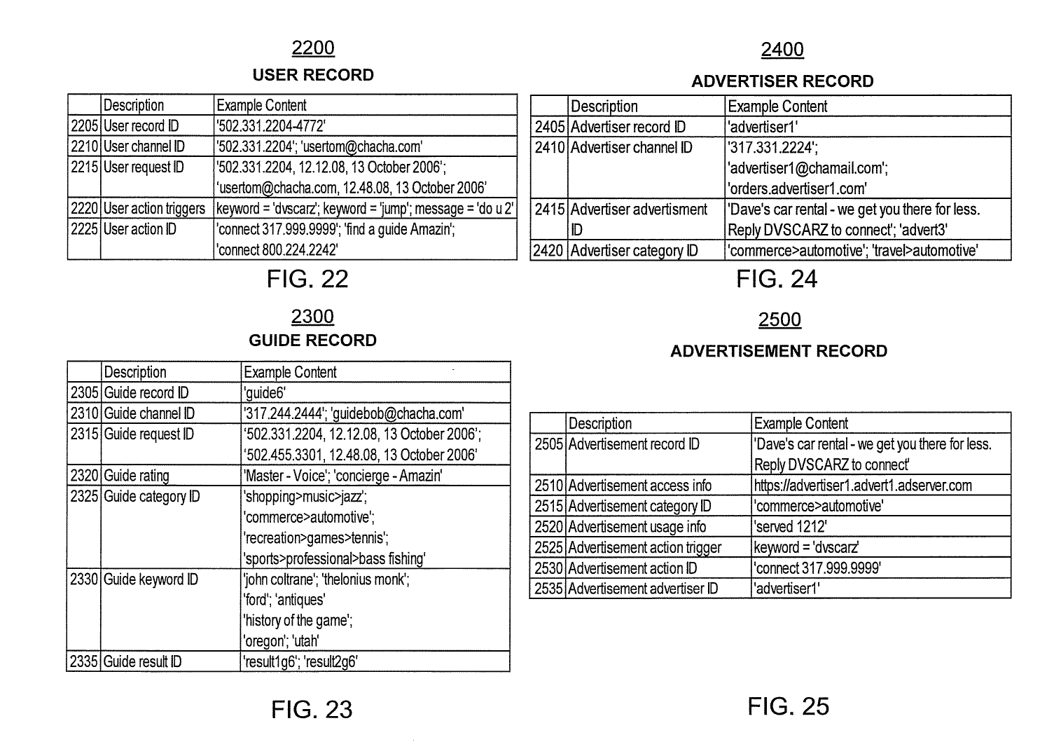

As illustrated in FIG. 22 an exemplary user record 2200 of which one or more may be associated with or resident in the database 1220 (FIG. 21) is provided. The user record 2200 (FIG. 22) may include a user record identifier (ID) field 2205, a user channel ID field 2210, a user request ID field 2215, a user action triggers field 2220, and a user action ID field 2225.

The user record ID field 2205 includes an identifier of a user which is preferably unique and is preferably used consistently. A user record ID serves to distinguish a user record associated with a user from a user record associated with a different user. Any number of characters, numbers, and/or other indicators may be used to indicate a user record ID. In at least one embodiment, a username associated with a user is included in the user record ID field 2205. In at least one embodiment, a phone number associated with a user device is indicated in the user record ID field 2205. Using the example in FIG. 22, ‘502.331.2204-4722’ is the user record ID associated with the user record 2200.

The user channel ID field 2210 may include information of a number of communication services associated with a user. Any information which may be used to establish communication with a user may be indicated in the user channel ID field 2210. For example, a telephone number, an email address, an IM credential, a URL, a username, a password, and/or other communication information may be indicated in the user channel ID field 2210. Using the example in FIG. 22, the phone number ‘502.331.2204’ and the email ‘usertom@chacha.com’ are associated with the user ID ‘502.331.2204-4772’.

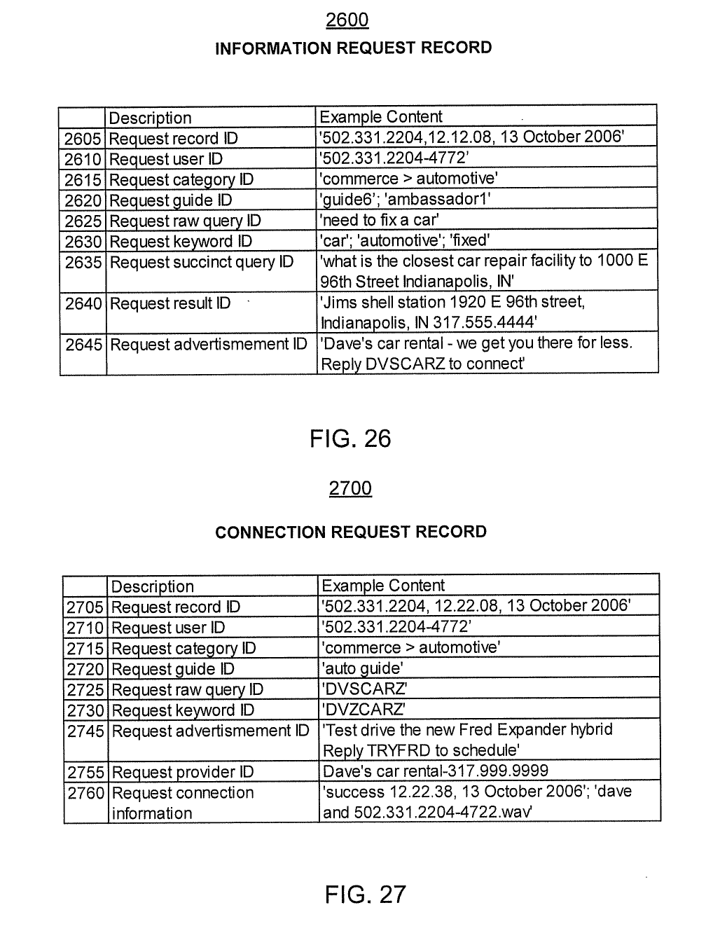

The user request ID field 2215 may include information of a number of requests associated with a user. A user request ID may be, for example, a pointer to a request record such as the information request record 2600 (FIG. 26), or the connection request record 2700 (FIG. 27). If a user submits a request to the search system 2130 (FIG. 21), a request ID may be added to the user request ID field 2215 (FIG. 22). Using the example illustrated, ‘502.331.2204, 12.12.08, 13 October 2006’ and ‘usertom@chacha.com, 12.48.08, 13 October 2006’ are associated with ‘502.331.2204-4722’.

The user action triggers field 2220 may include information of a number of trigger events associated with a user. If a user takes an action which is indicated in the user action triggers field 2220, an associated response indicated in the user action ID field 2225 may be performed. An action may be added to and/or removed from the user action triggers field 2220 based on various criteria. For example, if a user receives a particular advertising message, an action trigger may be associated with the user as further described in the related U.S. patent application Ser. No. 12/568,293, previously mentioned. Using the example in FIG. 22, the triggers keyword=‘dvscarz’, keyword=‘jump’ and message=‘do u 2’ are the trigger actions associated with the user ‘502.331.2204-4722’.

The user action ID field 2225 may include information of an action to be taken responsive to a trigger identified in the user action triggers field 2220. Any sort of action may be initiated responsive to an action identified in the user action triggers field 2220. In at least one embodiment, a detection of a trigger event may cause a corresponding action to be initiated by the search system 2130 (FIG. 21). For example, detection of the keyword ‘dvscarz’ in a message received from the user ‘502.331.2204-4772’ may cause a connection to be established between the user and the phone number ‘317.999.9999’.

As illustrated in FIG. 23, an exemplary guide record 2300 is provided, of which one or more may be associated with or resident in the search database 2120 (FIG. 21). The guide record 2300 (FIG. 23) may include a guide record ID field 2305, a guide channel ID field 2310, a guide request ID field 2315, a guide rating field 2320, a guide category ID field 2325, a guide keyword ID field 2330, and a guide result ID field 2335.

The guide record ID field 2305 preferably contains a unique identifier of a guide, which is preferably used consistently. For example, in at least one embodiment, the guide ID field 2305 can include a randomly generated numerical code, and/or a text string indicating a name associated with a guide. A guide ID serves to distinguish the guide record associated with a guide from a guide record associated with other guides. Other unique identifiers of a guide may be utilized without departing from the spirit and scope of the embodiments. Using the example illustrated in FIG. 23, ‘guide6’ is the guide ID associated with the guide record 2300.

The guide channel ID field 2310 may include information of a device and/or services associated with a guide. Content of the guide channel ID field 2310 may be modified based on actions of a guide. If a guide establishes communication using a device and/or service information regarding the device and/or service, this information may be included in the guide channel ID field 2310. Any type of communication service and/or system may be indicated in the guide channel ID field 2310. For example, a username and/or password associated with a guide may be indicated in the guide channel ID field 2310. Communication services such as Instant Messaging (IM), e-mail, SMS, MMS, EMS, telephone, wireless or wired communication, etc., may be indicated in the guide channel ID field 2310. A telephone number, an email address, an IM provider and login ID, a keyword associated with a service, an IP address, a MAC address, etc., may be indicated in the guide channel ID field 2310. Using the example illustrated in FIG. 23, the phone number ‘317.244.2444’ and the email ‘guidebob@chacha.com’ are associated with the guide ‘guide6’.

The guide request ID field 2315 may include information of a number of requests associated with a guide. Content of the guide request ID field 2315 may be modified based on actions of a guide. If a guide is selected for a request, an identifier of the request may be indicated in the guide request ID field 2315. For example, if a guide produces a search result responsive to a search request, an identifier of the search request may be included in the guide request ID field 2315. A rating and/or ranking associated with a search request associated with a guide may affect compensation for a guide. A request may be associated with a guide based on a vote cast by a guide regarding items associated with the search request. Using the example illustrated in FIG. 23, the requests ‘502.331.2204, 12.12.08, 13 October 2006’ and ‘502.455.3301, 12.48.08, 13 October 2006’ are associated with ‘guide6’. This may indicate that ‘guide6’ has responded to the requests ‘502.331.2204, 12.12.08, 13 October 2006’ and ‘502.455.3301, 12.48.08, 13 October 2006’.

The guide rating field 2320 may include information of a number of ratings associated with a guide. A guide may perform various types of tasks, and may be rated regarding the tasks. For example, a guide may be rated to perform tasks such as transcribing a query from voice to text, responding to requests regarding a particular advertiser or merchant, searching for information, etc. As illustrated in FIG. 23, ‘guide6’ has the rating ‘Master—Voice’ and ‘concierge—Amazin’. This may indicate that ‘guide6’ may be a preferred guide for performing a voice transcription task, and may be able to act as a concierge guide for interactions with the merchant ‘Amazin’. Any guide may perform any type of task. A rating of a guide may be associated with information such as a category, a keyword, a profile, etc. which may be associated with the guide.

The guide category ID field 2325 may include information of a number of categories associated with a guide. Content of the guide category ID field 2325 may be modified based on actions of a guide. A guide and/or other person may select a category and/or keyword associated with a guide. A category may be associated with a guide based on testing of a guide. A category may be associated with a guide based on an affiliate group associated with a guide. For example, if a guide has chosen to be affiliated with affiliate groups associated with a type of sport, a category associated with the type of sport might be associated with the guide. A category associated with a guide may be used to select items which are to be presented to the guide. For example, if a search request is associated with a category, a guide with a high rating associated with the category may be more likely to be selected to respond to the request. Using the example illustrated in FIG. 23, the categories ‘shopping>music>jazz’, ‘commerce>automotive’, ‘recreation>games>tennis’ and ‘sports>professional>bass fishing’ are associated with ‘guide6’.

The guide keyword ID field 2330 may include information of a topic or “interest” or keyword associated with a guide. The content of the guide keyword ID field 2330 may be modified based on actions of a guide. A person may select an interest associated with a guide. For example, a guide may select a topic or keyword to be associated with the guide during a registration process. A topic may be associated with a guide based on testing of a guide. For example, a guide may be required to demonstrate knowledge of a category and/or topic in order to be associated with the topic. Content indicated in the guide keyword ID field 2330 may be compared to content of a search request in order to determine a ranking of a guide for responding to a search request. Using the example illustrated in FIG. 23, the topics ‘john coltrane’, ‘thelonius monk’, ‘ford’, ‘antiques’, ‘history of the game’, ‘oregon’, and ‘utah’ are associated with ‘guide6’. This may for example indicate that ‘guide6’ has indicated an interest in those topics.

The guide result ID field 2335 may include information of a number of results associated with a guide. Content of the guide result ID field 2335 may be modified based on actions of a guide. For example, if a guide produces a search result responsive to a search request, an identifier of the search result may be included in the guide result ID field 2335. A rating and/or ranking associated with a search result associated with a guide may affect compensation for a guide. Likewise a usage indicator associated with a search result provided by a guide may affect a rating and/or ranking associated with a guide. Using the example illustrated in FIG. 23, the results ‘result1g6’ and ‘result2g6’ are associated with ‘guide6’.

As illustrated in FIG. 24 an exemplary advertiser record 2400 of which one or more may be associated with or resident in the database 2120 (FIG. 21) is provided. The advertiser record 2400 (FIG. 24) may include an advertiser record identifier (ID) field 2405, an advertiser channel ID field 2410, an advertiser advertisement ID field 2415, and an advertiser category ID field 2420.

The advertiser record ID field 2405 includes an identifier of an advertiser which is preferably unique and is preferably used consistently. An advertiser record ID serves to distinguish an advertiser record associated with an advertiser from an advertiser record associated with a different advertiser. Any number of characters, numbers, and/or other indicators may be used to indicate an advertiser record ID. In at least one embodiment, a username associated with an advertiser is included in the advertiser record ID field 2405. In at least one embodiment, a phone number associated with an advertiser device is indicated in the advertiser record ID field. Using the example in FIG. 24, ‘advertiser1’ is the advertiser record ID associated with the advertiser record 2400.

The advertiser channel ID field 2410 may include information of a number of communication services associated with an advertiser. Any information which may be used to establish communication with an advertiser may be indicated in the advertiser channel ID field 2410. For example, a telephone number, an email address, an IM credential, a URL, a username, a password, and/or other communication information may be indicated in the advertiser channel ID field 2410. Using the example in FIG. 24, the phone number ‘317.331.2224’, the email ‘advertiser1@chamail.com’, and the URL ‘orders.advertiser1.com’ are associated with ‘advertiser1’.

The advertiser advertisement ID field 2415 may include information of a number of advertisements associated with an advertiser, An advertiser advertisement ID may be, for example, a pointer to an advertisement record such as the advertisement record 2500 (FIG. 25). An advertisement may be provided directly by a merchant, by an advertising agency or service, etc. Using the example in FIG. 24, ‘Dave's car rental—we get you there for less. Reply DVSCARZ to connect’ and ‘advert3’ are associated with ‘advertiser1’.

The advertiser category ID field 2420 may include information of a number of categories associated with an advertiser. Content of the advertiser category ID field 2420 may be modified based on actions of an advertiser. An advertiser and/or other person may select a category and/or keyword associated with an advertiser. For example, a guide and/or a user might select a category associated with an advertiser. A category associated with an advertiser may be used to select items which are to be presented to a person such as a guide, a user, a provider, etc. For example, if a search request is associated with a category, an advertisement of an advertiser with a high rating associated with the category may be more likely to be selected be presented responsive to the request. Using the example illustrated in FIG. 24, the categories ‘commerce>automotive’ and ‘travel>automotive’ are associated with ‘advertiser1’.

As illustrated in FIG. 25, an exemplary advertisement record 2500 of which one or more may be associated with or resident in the database 2120 (FIG. 21) is provided. The advertisement record 2500 (FIG. 25) may include an advertisement record ID field 2505, an advertisement access info field 2510, an advertisement category ID field 2515, an advertisement usage info field 2520, an advertisement action trigger field 2525, an advertisement action ID field 2530, and an advertisement advertiser ID field 2535.

The advertisement record ID field 2505 includes an identifier of an advertisement which is preferably unique and is preferably used consistently. An advertisement ID serves to distinguish an advertisement record associated with an advertisement from an advertisement record associated with a different advertisement. Any number of characters, numbers, and/or other indicators may be used to indicate an advertisement record ID. In at least one embodiment, a name selected by an advertiser associated with an advertisement is included in the advertisement record ID field 2505. Using the example in FIG. 25, ‘Dave's car rental—we get you there for less. Reply DVSCARZ to connect’ is the advertisement record ID associated with the advertisement record 2500.

The advertisement access information field 2510 may include information regarding how an advertisement may be accessed. For example, the advertisement access information may indicate a server, URL, password, etc., which may be used to obtain information of an advertisement. Using the example in FIG. 25, the URL <https://advertiser1.advert1.adservercom> is associated with the advertisement record 2500.

The advertisement category ID field 2515 may include information of a number of categories associated with an advertisement. Content of the advertisement category ID field 2515 may be modified based on actions of an advertiser. An advertiser and/or other person may select a category and/or keyword associated with an advertisement. For example, a guide and/or a user might select a category associated with an advertisement, an advertiser might associate a category with an advertisement explicitly, a category might be associated with an advertisement based on analysis of content of the advertisement, etc. A category associated with an advertisement may be used to select items which are to be presented to a person such as a guide, a user, a provider, etc. For example, if a search request is associated with a category, an advertisement with a high rating associated with the category may be more likely to be selected be presented responsive to the request. Using the example illustrated in FIG. 25, the category ‘commerce>automotive’ is associated with the advertisement record 2500.

The advertisement usage info field 2520 may include information regarding usage of an advertisement. For example, if an advertisement has been provided to a user, information regarding a number of times the advertisement has been supplied may be indicated in the advertisement usage info field 2520. Any type of usage indication may be used. Using the example in FIG. 25, ‘served 1212’ may indicate that the advertisement associated with the advertisement record 2500 has been served to a user one thousand two hundred and twelve times. Usage information may be used for various purposes such as determining efficacy of advertising, compensation for a guide, a provider, the search system, etc.

The advertisement action trigger field 2525 may include information of a response, action, stimulus or trigger associated with an advertisement. For example, if an advertisement includes a keyword which may be used to trigger an action responsive to a message including the keyword, the keyword may be indicated in the advertisement action trigger field 2525. Using the example in FIG. 25, the keyword ‘dvscarz’ is associated with the advertisement ‘Dave's car rental—we get you there for less. Reply DVSCARZ to connect’.

The advertisement action ID field 2530 may include information of an action, response, process, or response which is to be associated with a user responsive to an advertisement being provided to the user. Using the example illustrated in FIG. 25, if the advertisement ‘Dave's car rental—we get you there for less. Reply DVSCARZ to connect’ is presented to a user, the action ‘connect to 317.999.9999’ may be executed responsive to a message from the user including the keyword ‘dvscarz’.

The advertisement advertiser ID field 2535 may include information of an advertiser associated with an advertisement. For example, the advertisement advertiser ID field 2535 may include a pointer to a number of advertiser records such as the advertiser record 2400. Using the example in FIG. 25, ‘advertiser1’ is associated with the advertisement ‘Dave's car rental—we get you there for less. Reply DVSCARZ to connect’.

As illustrated in FIG. 26, an exemplary information request record 2600 of which one or more may be associated with or resident in the database 2120 (FIG. 21) is provided. An information request record may be used to record information of processing a request and providing a search result and/or other item to a user responsive to a request. The information request record 2600 (FIG. 26) may include a request record ID field 2605, a request user ID field 2610, a request category ID field 2615, a request guide ID field 2620, a request raw query ID field 2625, a request keyword ID field 2630, a request succinct query ID 2635, a request result ID 2640 and a request advertisement ID field 2645.

The request record ID field 2605 includes an identifier of a request which is preferably unique and is preferably used consistently. A request record ID serves to distinguish a request record associated with a request from a request record associated with a different request. Any number of characters, numbers, and/or other indicators may be used to indicate a request record ID. In at least one embodiment, user ID and a time stamp with a request is included in the request record ID field 2605. Using the example in FIG. 26, ‘502.331.2204, 12.12.08, 13 October 2006’ is the request record ID associated with the request record 2600.

The request user ID field 2610 may include an identifier of a number of users associated with a request. For example, the request user ID field may include a pointer to a user record such as the user record 2200 (FIG. 22) which may be used to obtain information regarding a user. Using the example in FIG. 26, the user ‘502.331.2204-4722’ is associated with the query ‘502.331.2204, 12.12.08, 13 October 2006’.

The request category ID field 2615 may include an identifier of a category associated with a request. A category may be associated with a request in various ways. For example, a category may be associated with a request based on an automated and/or human assisted analysis of information of a query such as a keyword, a profile, a history, a user, etc., which may be used to determine a number of categories to be associated with a query. In at least one embodiment, an automated analysis may be performed, which may be followed by a human assisted analysis. An ambassador guide, who may be a specialist in query processing, may be assigned to a request in order to determine a category associated with a request. Using the example in FIG. 26, the category ‘commerce>automotive’ is associated with the request ‘502.331.2204, 12.12.08, 13 October 2006’.

The request guide ID field 2620 may include information of a number of guides associated with a request. Any number of guides may be associated with a request. For example a guide may be associated with a request if the guide is selected to respond to the request. Using the example in FIG. 26, ‘guide6’ and ‘ambassador1’ are associated with ‘502.331.2204, 12.12.08, 13 October 2006’. This may indicate that ‘ambassador1’ has expedited the request ‘502.331.2204, 12.12.08, 13 October 2006’, and ‘guide6’ has provided a search result responsive to the request.

The request raw query ID field 2625 may include information of a raw query associated with a request. A “raw query” is any information provided by a user. A guide (e.g., an expediter or ambassador, a transcriber, a generalist guide, etc.) may process a raw query, which may assist in providing a search result. Any type of information such as audio, video, image, text, or other media may be indicated in the raw query ID field 2625. Using the example in FIG. 26, ‘need to fix a car’ is the raw query ID associated with the request ‘502.331.2204, 12.12.08, 13 October 2006’.

The request keyword ID field 2630 may include information of a number of keywords associated with a request. A keyword may be associated with a request automatically by parsing and/or analysis of a request and/or using the assistance of a guide. A keyword may be an explicit and/or implicit element of a raw query and/or a succinct query. A keyword may include multiple words up to and including the entire content of a query. Using the example in FIG. 26, the keywords ‘car’, ‘automotive’, and ‘fixed’ are associated with the request ‘502.331.2204, 12.12.08, 13 October 2006’.

The request succinct query ID field 2635 may include information of a succinct query associated with a request. A “succinct query” is a query which is based at least in part on a raw query provided by a user. A succinct query may be used to more efficiently index, map, or submit a query to a resource, a guide, an advertisement, and/or other item. An ambassador guide or expediter may generate and/or select a succinct query to be associated with a request, and/or an automated process may associate a succinct query with a request. Using the example in FIG. 26, the succinct query ‘what is the closest car repair facility to 1000 E 96th Street, Indianapolis, IN’ is the succinct query associated with the request ‘502.331.2204, 12.12.08, 13 October 2006’.

The request result ID field 2640 may include information of a number of results associated with a request. For example, text, a URL, audio, video, images, and/or other information which may provide information associated with a request may be indicated in the request result ID field 2640. Any number of results may be associated with a request. In at least one embodiment, a text message which indicates a precise, direct, brief, or succinct response to a request may be indicated in the request result ID field 2640. Using the example in FIG. 26, ‘Jim shell station 1920 E 96th street, Indianapolis, IN 317.555.4444’ is the result associated with the request ‘502.331.2204, 12.12.08, 13 October 2006’.

The request advertisement ID field 2645 may include information of a number of advertisements associated with a request. For example, an interstitial, trailer, and/or follow-on type advertisement may be associated with a request. In at least one embodiment, association of an advertisement with a request may cause an action trigger and an action to be associated with a user. Using the example illustrated in FIG. 26, the advertisement ‘Dave's car rental—we get you there for less. Reply DVSCARZ to connect’ is associated with the request ‘502.331.2204, 12.12.08, 13 October 2006’, which may cause the action trigger ‘keyword=‘dvscarz’’ and the action ‘connect 317.999.9999’ to be associated with the user ‘502.331.2204-4772’.

As illustrated in FIG. 27 an exemplary connection request record 2700 of which one or more may be associated with or resident in the database 2120 (FIG. 21) is provided. A connection request record may be used to record information of processing a request and connecting a user to a provider. The connection request record 2700 (FIG. 27) may include a request record ID field 2705, a request user ID field 2710, a request category ID field 2715, a request guide ID field 2720, a request raw query ID field 2725, a request keyword ID field 2730, a request advertisement ID field 2745, a request provider ID field 2755, and a request connection information field 2760.

The request record ID field 2705 includes an identifier of a request which is preferably unique and is preferably used consistently. A request record ID serves to distinguish a request record associated with a request from a request record associated with a different request. Any number of characters, numbers, and/or other indicators may be used to indicate a request record ID. In at least one embodiment, user ID and a time stamp with a request is included in the request record ID field 2705. Using the example in FIG. 27, ‘502.331.2204, 12.22.08, 13 October 2006’ is the request record ID associated with the request record 2700.

The request user ID field 2710 may include an identifier of a number of users associated with a request. For example, the request user ID field may include a pointer to a user record such as the user record 2200 (FIG. 22) which may be used to obtain information regarding a user. Using the example in FIG. 27, the user ‘502.331.2204-4722’ is associated with the query ‘502.331.2204, 12.22.08, 13 October 2006’.

The request category ID field 2715 may include an identifier of a category associated with a request. A category may be associated with a request in various ways. For example, a category may be associated with a request based on an automated and/or human assisted analysis of information of a query such as a keyword, a profile, a history, a user, etc., which may be used to determine a number of categories to be associated with a query. In at least one embodiment, an automated analysis may be performed, followed by a human assisted analysis. An ambassador guide, who may be a specialist in query processing, may be assigned to a request in order to determine a category associated with a request. Using the example in FIG. 27, the category ‘commerce>automotive’ is associated with the request ‘502.331.2204, 12.22.08, 13 October 2006’.

The request guide ID field 2720 may include information of a number of guides associated with a request. Any number of guides may be associated with a request. As the request ‘502.331.2204, 12.22.08, 13 October 2006’ includes an action trigger (i.e., the keyword DVSCARZ), a guide may not be selected to respond to the request. For example, the guide ‘auto guide’ is indicated in the request guide ID field 2720. This may indicate that a guide is not required to respond to the request ‘502.331.2204, 12.22.08, 13 October 2006’.

The request raw query ID field 2725 may include information of a raw query associated with a request. The raw query associated with the request ‘502.331.2204, 12.22.08, 13 October 2006’ includes the action trigger ‘dvscarz’, which may indicate that creation of a vetted query may be performed automatically.

The request keyword ID field 2730 may include information of a number of keywords associated with a request. The keyword ‘dvscarz’ is the entire query associated with the request ‘502.331.2204, 12.22.08, 13 October 2006’.

The request advertisement ID field 2745 may include information of a number of advertisements associated with a request. The advertisement ‘test drive the new Fred Expander hybrid Reply TRYFRD to schedule’ is associated with the request ‘502.331.2204, 12.22.08, 13 October 2006’. The advertisement ‘test drive the new Fred Expander hybrid Reply TRYFRD to schedule’ may cause an advertisement to be presented to the user ‘502.331.2204-4722’ before, during and/or after a connection is established responsive to the trigger action ‘keyword=‘dvscarz’’, and may cause a number of trigger actions to be associated with ‘502.331.2204-4722’.

The request provider ID field 2755 may include information of a number of providers associated with a request. A provider may be an advertiser, a guide and/or a merchant, etc. Information of a provider may be indicated by an identifier such as the guide record ID of the guide record 2300 (FIG. 23). For example, the guide ‘guide6’ might be selected as a provider for the merchant ‘Amazin’ as indicted in the guide record 300. A provider may register with the search system 2130 (FIG. 21). As illustrated in FIG. 27, ‘Dave's car rental—317.999.9999’ is the provider ID associated with the request ‘502.331.2204, 12.22.08, 13 October 2006’. This may indicate that ‘Dave's car rental—317.999.9999’ has been connected to the user ‘502.331.2204-4722’ responsive to the request ‘502.331.2204, 12.22.08, 13 October 2006’.

The request connection information field 2760 may include information regarding a connection which is established responsive to a request. Information regarding whether a connection was successful, duration of a connection, content of a communication session, etc., may be indicated in the request connection information field 2760. Using the example in FIG. 27, ‘success 12.22.38, 13 October 2006’ and ‘dave and 502.331.2204-4722.wav’ are indicated in the request connection information field 2760, which may indicate that a connection was successfully established at 12.22.38, 13 October 2006, and a recording of the connection may be found in the file ‘dave and 502.331.2204-4722.wav’.

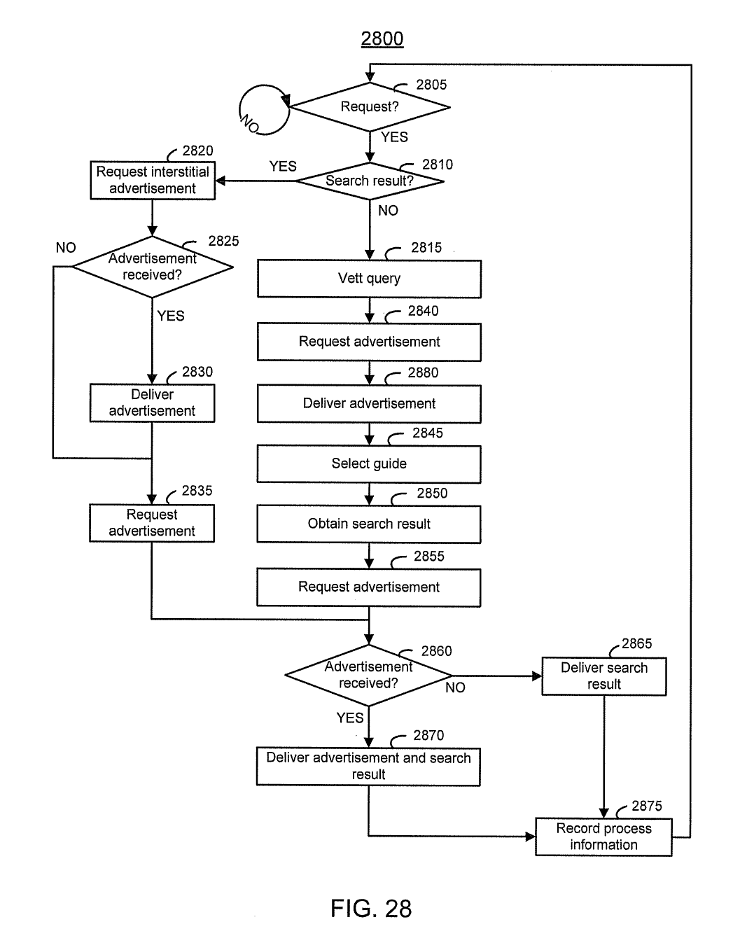

As illustrated in FIG. 28, a process 2800 for processing a request is provided. The process 2800 may be performed in whole or in part by any suitable element of the system 2100 (FIG. 21). In at least one embodiment, the process 2800 is operative on a server associated with the search system 2130.

In operation 2805 (FIG. 28), a determination is made as to whether a request is received. If it is determined in operation 2805 that a request is not received, control remains at operation 2805 and process 2800 continues. If it is determined in operation 2805 that a request is received, control is passed to operation 2810 and process 2800 continues.

The determination in operation 2805 may be made using various criteria. In at least one embodiment, if a message is received at a server associated with the search system 2130 (FIG. 21), it may be determined that a request is received. For example, if an email message, an SMS, EMS, and/or MMS message, an IM, an IP message, and/or a voice message is received at an address associated with the search system 2130, it may be determined that a request is received.

In operation 2810, a determination is made as to whether a search result is available. If in operation 2810 it is determined that a search result is not available, control is passed to operation 2815 and process 2800 continues. If in operation 2810 it is determined that a search result is available, control is passed to operation 2820 and process 2800 continues.

The determination in operation 2810 may be made using various criteria. In at least one embodiment, comparison to a database of previous queries, automated processing, processing by an external resource and/or any combination thereof may be applied to a query to determine if a search result is available.

In operation 2815, a query is vetted. Vetting of a query may include various forms of processing which may be performed automatically and/or using the assistance of a person. The vetting process results in the association of a structured query and/or a category with a request. Control is passed to operation 2840 and process 2800 continues.

In operation 2820, an advertisement is requested. In at least one embodiment, an interstitial ad is requested. An “interstitial ad” is an advertisement which is presented prior to a search result or in between delivery of information. In at least one embodiment, an interstitial ad may be targeted based on content of a search result identified in operation 2810. Control is passed to operation 2825 and process 2800 continues.

In operation 2825, a determination is made as to whether an advertisement is received. If in operation 2825 it is determined that an advertisement is not received, control is passed to operation 2835 and process 2800 continues. If in operation 2825 it is determined that an advertisement is received, control is passed to operation 2830 and process 2800 continues.

The determination in operation 2825 may be made based on various criteria. In at least one embodiment, if an advertisement is not received at a server associated with the search system 2130 from a server associated with an advertiser system, for example, the advertiser system 2165 (FIG. 21) within a pre-determined time interval following a request, it may be determined that an advertisement is not received. In at least one embodiment, if a user has a status indicator which indicates that interstitial ads are not to be served to the user, it may be determined that an advertisement is not received. In at least one embodiment, if an advertisement received has been previously provided to a user, it may be determined that an advertisement is not received.

In operation 2830, an advertisement is delivered. In at least one embodiment, more than one advertisement may be provided. Content of an advertisement may be modified based on a time interval, user history, etc. Any service associated with a user may be used to deliver an advertisement to the user. Control is passed to operation 2835 and process 2800 continues.

In operation 2835, an advertisement is requested. A “contextual ad” is an advertisement which is presented simultaneously with a search result. A contextual ad may for example be a text message which is appended to a response to a request to create a longer message which is provided as an SMS message response to a user. In at least one embodiment, a contextual ad may be requested in operation 2835. In at least one embodiment a programmatic delay may be executed in operation 2835, which may allow a user sufficient time to process information of an advertisement delivered in operation 2830. Control is passed to operation 2860 and process 2800 continues.

In operation 2840, an advertisement, for example an interstitial ad, is requested. In at least one embodiment, an interstitial ad may be targeted based on results of a query vetting process. Control is passed to operation 2880 and process 2800 continues.

In operation 2880 an advertisement is delivered. In at least one embodiment, multiple advertisements are delivered to a user during a time interval which is required to select a guide and/or obtain a search result. Control is passed to operation 2845 and process 2800 continues.

In operation 2845, a guide is selected to respond to a request. A guide may be selected based on various criteria. For example, a first available guide, a highest ranking guide associated with a category associated with a request, a guide who most closely matches a profile associated with a user associated with a request, and/or a guide meeting combinations of such criteria may be selected to respond to a request. Multiple guides may respond to a request. Control is passed to operation 2850 and process 2800 continues.

In operation 2850, a search result is obtained. A search result may be obtained based on any action of a guide. In at least one embodiment, a guide may obtain a text snippet and a reference URL from a web page as a search result. A search result may include any media such as audio, video, text, graphics, computer readable media, scripting language such as Java® or Flash®, etc., which may be indicated to a user. Control is passed to operation 2855 and process 2800 continues.

In operation 2855, an advertisement is requested. In at least one embodiment a contextual ad is requested. In at least one embodiment, the request may include information regarding a result which may be used to select an advertisement. For example, the search system 2130 (FIG. 21) may include an indicator of a category, profile, etc. associated with a request and/or search result in a request message provided to the advertising server 2165. A category, a profile, a constraint and/or other information associated with a search result may be used to select an advertisement. For example, if a URL associated with a search result is associated with an advertiser, an advertisement from the advertiser may be ranked higher, or if a search result is obtained for resource associated with an age group, an advertisement associated with the age group may be ranked higher. Control is passed to operation 2860 and process 2800 continues.

In operation 2860, a determination is made as to whether an advertisement is received. If in operation 2860 it is determined that an advertisement is not received, control is passed to operation 2865 and process 2800 continues. If in operation 2860 it is determined that an advertisement is received, control is passed to operation 2870 and process 2800 continues.

The determination in operation 2860 may be made based on various criteria. In at least one embodiment, if an advertisement is not received at a server associated with the search system 2130 (FIG. 21) from a server associated with an advertiser system (e.g. the advertiser system 2165) within a pre-determined time interval following a request, it may be determined that an advertisement is not received. In at least one embodiment, if a user has a status indicator which indicates that contextual ads are not to be served to the user it may be determined that an advertisement is not received. In at least one embodiment, if an advertisement received has been previously transmitted to a user, it may be determined that an advertisement is not received.

In operation 2865, a search result is delivered to a user. A search result may be transmitted or provided using any communication service and/or system associated with a user. Control is passed to operation 2875 and process 2800 continues.

In operation 2870, a search result and/or an advertisement is delivered to a user. In at least one embodiment, a contextual ad is provided to a user. A search result and/or a contextual ad may be provided using any service and/or device or system associated with a user. Control is passed to operation 2875 and process 2800 continues.

In operation 2875, process information is recorded. For example, information of a guide, a user, an advertisement and/or other item is recorded. Information regarding usage of an advertisement, a selection by a guide and/or a selection by a user may be recorded using persistent storage. For example, information of advertisements delivered to a user, search resources used by a guide, etc., may be recorded in the database 2120 (FIG. 21). Control is passed to operation 2805 and process 2800 continues.

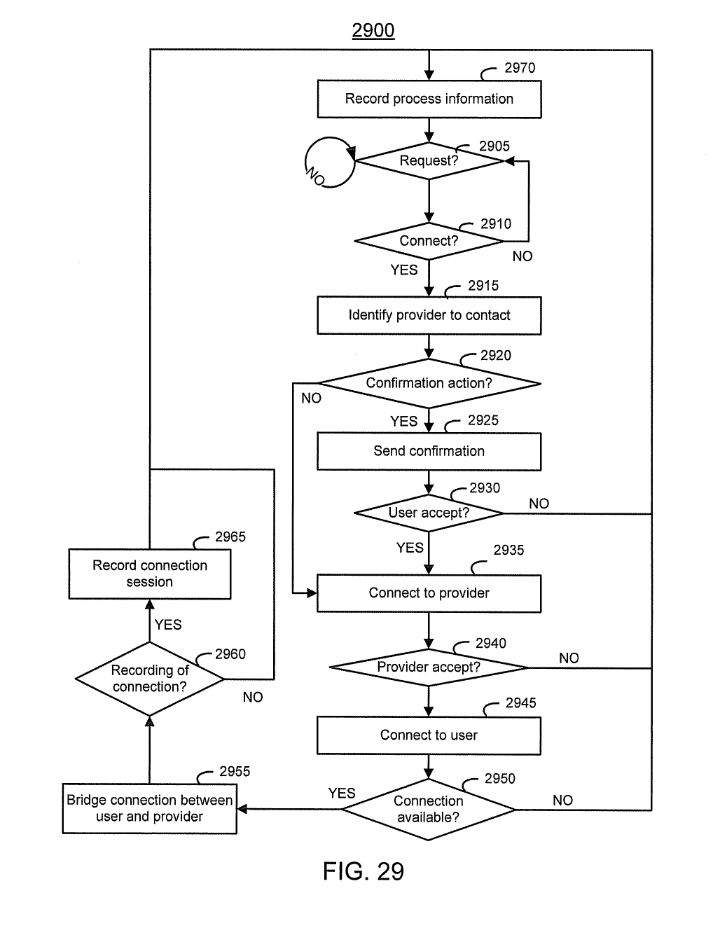

As illustrated in FIG. 29, a process 2900 for processing a request is provided. The process 2900 may be performed in whole or in part by any suitable elements of the system 2100 (FIG. 21). In at least one embodiment, the process 2900 is operative on a server associated with the search system 2130.

In operation 2905 (FIG. 29), a determination is made as to whether a request is received. If it is determined in operation 2905 that a request is not received, control remains at operation 2905 and process 2900 continues. If it is determined in operation 2905 that a request is received, control is passed to operation 2910 and process 2900 continues.

The determination in operation 2905 may be made using various criteria. In at least one embodiment, if a message is received at a server associated with the search system 2130 (FIG. 21), it may be determined that a request is received. For example, if an email message, an SMS, EMS, and/or MMS message, an IM, an IP message, and/or a voice message is received at an address associated with the search system 2130 it may be determined that a request is received.

In operation 2910 (FIG. 29), a determination is made as to whether a connection is requested. If it is determined in operation 2910 that a connection is not requested, control is passed to operation 2905 and process 2900 continues. If it is determined in operation 2910 that a connection is requested, control is passed to operation 2915 and process 2900 continues.

The determination in operation 2910 may be made based on various criteria. In at least one embodiment, content of a text message received from a user system is compared to templates associated with the user to determine whether a connection is requested. In at least one embodiment, this may allow detection of a keyword of a text message to initiate a voice connection between a user and a provider. A connection may be made using any available communication service.

In operation 2915, a provider to be contacted is identified. In at least one embodiment, a provider may be identified based at least in part on content of a message received in operation 2905. Location information, profile information, historical information, etc., associated with a request may be used to determine at least in part a provider to be contacted. For example, a provider in closer proximity to a user, or a provider previously contacted, or a provider with similar characteristics to a user associated with a request may be preferentially selected to be contacted. Compensation associated with a provider may be used at least in part to identify a provider to be contacted. For example, a provider who has paid a premium for listing may receive preference. Control is passed to operation 2920 and process 2900 continues.

In operation 2920, a determination is made as to whether a confirmation action is required. If in operation 2920 it is determined that a confirmation action is not required, control is passed to operation 2935 and process 2900 continues. If in operation 2920 it is determined that a confirmation action is required, control is passed to operation 2925 and process 2900 continues.

The determination in operation 2920 may be made based on various criteria. For example, the search system 2130 (FIG. 21) may require a confirmation message to be sent to a user, a user may elect to receive a confirmation message and/or a provider may require a confirmation message, etc. A “confirmation message” is a message which may be provided to a user when a user has requested to establish a connection which allows the user to validate a connection request.

In operation 2925, a confirmation message is sent. A confirmation message may include a text message which may be sent to a user system prior to establishing a connection such as a voice connection to the user system. A confirmation message may request a response from a user prior to establishing a voice connection. Control is passed to operation 2930 and process 2900 continues.

In operation 2930, a determination is made as to whether a confirmation message is accepted. If in operation 2930 it is determined that a confirmation message is not accepted, control is passed to operation 2970 and process 2900 continues. If in operation 2930 it is determined that a confirmation message is accepted, control is passed to operation 2935 and process 2900 continues.

The determination in operation 2930 may be made based on various criteria. For example, it may always be determined that a user accepts a confirmation message, a user may be required to respond to a confirmation message within a time interval, a user may be required to respond with a message, and/or an attempt to establish a voice connection to a user system may be used to determine user acceptance, etc.

In operation 2935, a connection is established with a provider. A connection to a provider is preferably an interactive connection. In at least one embodiment, a voice connection is established with a provider system. A call may be placed to a telephone device, and/or a VoIP connection may be established with a provider. An Instant Message or ‘chat’ and/or other type of real-time interactive communication may be established. Control is passed to operation 2940 and process 2900 continues.

In operation 2940, a determination is made as to whether a provider accepts a connection. If in operation 2940 it is determined that a provider does not accepts a connection, control is passed to operation 2970 and process 2900 continues. If in operation 2940 it is determined that a provider accepts a connection, control is passed to operation 2945 and process 2900 continues.

The determination in operation 2940 may be based on various criteria. For example, a provider may be unavailable for any reason, may determine that a number of calls received has exceeded a value, that a user is not desirable, etc. In at least one embodiment, a provider may be required to establish a level of service in order to receive connection requests.

In operation 2945, a connection is established with a user. A connection to a user is preferably an interactive connection. In at least one embodiment, a voice connection is established with a user system. A call may be placed to a telephone device, and/or a VoIP connection may be established with a user. An Instant Message and/or other type of real-time interactive communication may be established. Control is passed to operation 2950 and process 2900 continues. It is important to note that contact information of a user and/or a provider need not be shared in order to establish a communication session.

In operation 2950, a determination is made as to whether a connection between a user and a provider is available. If in operation 2950 it is determined that a connection between a user and a provider is not available, control is passed to operation 2970 and process 2900 continues. If in operation 2950 it is determined that a connection between a user and a provider is available, control is passed to operation 2955 and process 2900 continues.

The determination in operation 2950 may be made based on various criteria. For example, if a user accepts a connection and a provider accepts a connection it may be determined that a connection is available. An indication by a user and/or a provider may be used to determine if a connection is available.

In operation 2955, a connection between a user and a provider is bridged. A voice connection which may have been established by the search system 2130 (FIG. 21) with a user system and/or a provider system may be modified in order that the user system and the provider system may communicate directly. A search system may be able to continue to monitor traffic and/or record any elements of a communication session between a user system and a provider system. Control is passed to operation 2960 and process 2900 continues.

In operation 2960, a determination is made as to whether a connection is to be recorded. If in operation 2960 it is determined that a connection is not to be recorded, control is passed to operation 2970 and process 2900 continues. If in operation 2960 it is determined that a connection is to be recorded, control is passed to operation 2965 and process 2900 continues.

The determination in operation 2960 may be made based on various criteria. For example, if a user and/or a provider consent to recording of any and/or all of a communication session, it may be determined that a connection is to be recorded, or if it is determined that a cost of recording is high, it may be determined that a connection is not to be recorded.

In operation 2965, a connection session is recorded. Any or all of a communication session may be recorded. A recording of a communication session may be used to measure success of a connection between a provider and a user. A recording may be used to determine compensation for the search system 2130, a provider, an advertiser, a guide, etc. Billing and access to services may be affected by information obtained from a recording of a connection. Control is passed to operation 2970 and process 2900 continues.

In operation 2970, process information is recorded. For example, the database 2120 (FIG. 21) may be updated to indicate actions by a user, a provider, and/or a search service. An indication of success and/or failure of a connection, a transaction, a provider, a merchant, etc. may be recorded. For example, if a provider has successfully connected to a user, compensation due to a search system providing a connection may be recorded, a rating of a provider may be increased if the provider successfully met a user request, a permission of a user may be reduced if a user makes a connection which has a short duration and/or is rated poorly by a provider and/or merchant. Any information regarding the process 2900 may be recorded. Control is passed to operation 2905 and process 2900 continues.

A trigger action which initiates a connection may be used to determine a provider that is connected. A trigger action may be used to differentiate connections established with the same provider. For example, if the keyword ‘MIKE’ and the keyword ‘DAVE’ were associated with the same destination phone number, a connection request initiated by ‘MIKE’ could be distinguished from a request initiated by ‘DAVE’ without the need for separate tracking phone numbers. This feature might be used to differentiate various publishers, targeting, etc. which might indicate efficacy of advertising, etc.

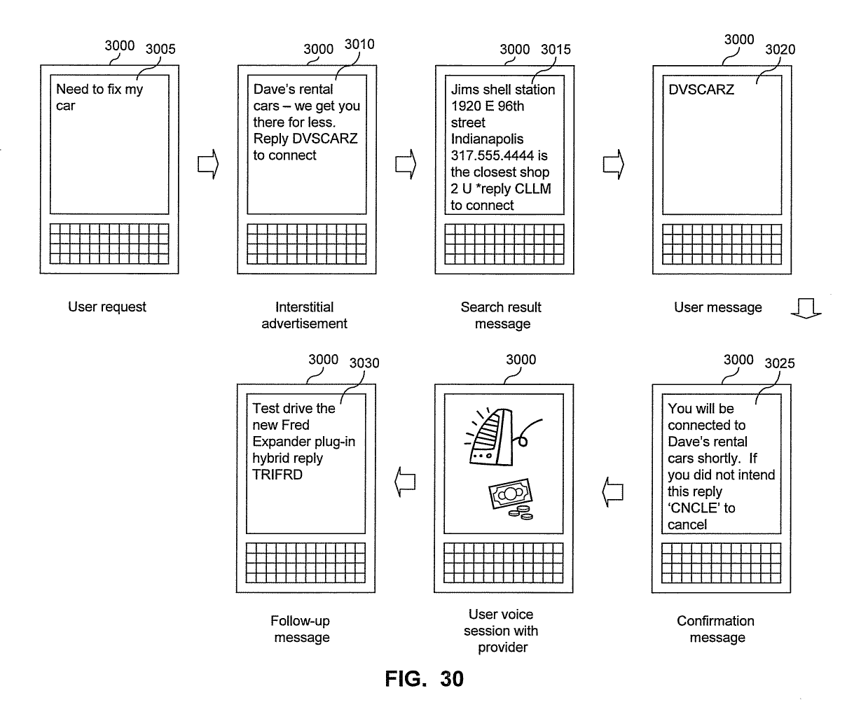

An exemplary sequence of messages which may establish a voice connection between a user system and a provider system is illustrated in FIG. 30. While a specific example of text or SMS messaging and a voice connection is used for the purposes of illustration, no limitation is implied thereby. Any type of messaging service, and any type of interactive communication service may be used within the scope and spirit of this disclosure.

The user device 3000 may transmit the information request message 3005. The message may be routed via the message routing system 2150 (FIG. 1) to the search system 2130. The search system 2130 may respond with the advertising message 3010 (FIG. 30) which may include an indicator regarding how a voice connection to a provider may be established. For example, the keyword DVSCARZ may be used to indicate the desire to establish a voice connection. The search system 2130 (FIG. 21) may subsequently respond with the search result message 3015 (FIG. 30) which may include an indicator regarding how a voice connection may be established with a different provider. A user may reply with the trigger action message 3020 which may initiate a voice connection between the user device 3000 and a provider system such as the provider system 2110 (FIG. 21).

The search system 2130 may establish a voice connection to a provider and/or may respond with the confirmation message 3025 (FIG. 30) to indicate that a voice connection is to be established with a user system. For example, a call may be placed by the search system 2130 (FIG. 21) using the voice routing system 2145 to the provider system 2110. Subsequently the search system 2130 may establish a voice connection with the user device 3000 (FIG. 30) based on, for example, the caller information obtained from the information request message 3005. After a voice session between a user system and a provider system is established, a message such as the follow-up message 3030 may be transmitted to the user device 3000.

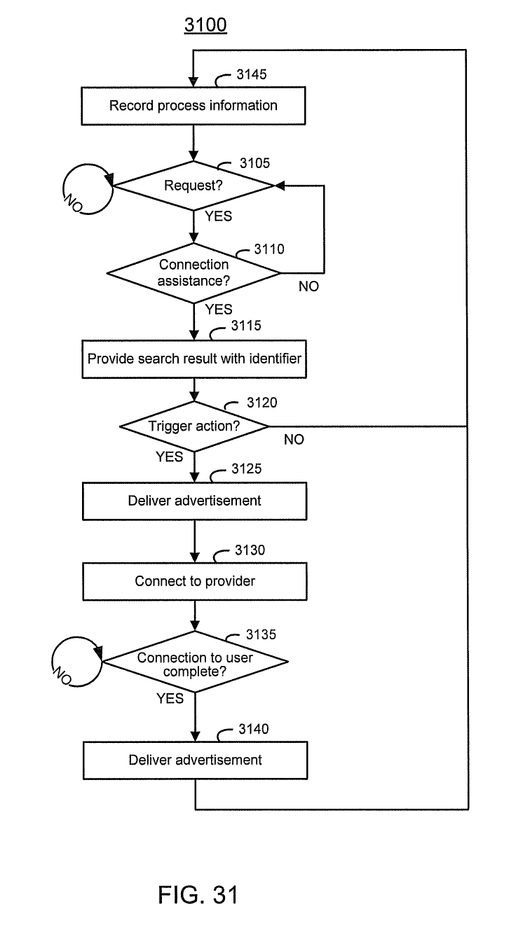

As illustrated in FIG. 31, a process 3100 for responding to a request is provided. The process 3100 may be performed in whole or in part by any suitable elements of the system 2100 (FIG. 21). In at least one embodiment, the process 3100 is operative on a server associated with the search system 2130.

In operation 3105 (FIG. 31) a determination is made as to whether a request is received. If it is determined in operation 3105 that a request is not received, control remains at operation 3105 and process 3100 continues. If it is determined in operation 3105 that a request is received, control is passed to operation 3110 and process 3100 continues.

The determination in operation 3105 may be made using various criteria. In at least one embodiment, if a message is received at a server associated with the search system 2130 (FIG. 21), it may be determined that a request is received. For example, if an email message, an SMS, EMS, and/or MMS message, an IM, an IP message, and/or a voice message is received at an address associated with the search system 2130 it may be determined that a request is received.

In operation 3110 (FIG. 31), a determination is made as to whether connection assistance is requested. If it is determined in operation 3110 that connection assistance is not requested, control is passed to operation 3105 and process 3100 continues. If it is determined in operation 3110 that connection assistance is requested, control is passed to operation 3115 and process 3100 continues.

The determination in operation 3110 may be made based on various criteria. In at least one embodiment, content of a text message received from a user system is compared to templates associated with the user to detect or determine whether connection assistance is requested. For example, if a user sends a message in a standardized format, the message may be parsed or analyzed to determine that connection assistance is requested. In at least one embodiment, a guide may determine whether connection assistance is requested. Any type of connection information may be requested, for example, a telephone number, an IM address, an email address, or other form of information which may allow a user to connect to a provider and/or a different user may be requested.

In operation 3115, a search result including an identifier is provided to a user. A search result may be provided automatically and/or using the assistance of a human searcher as previously described herein. Connection information or an identifier may include a phone number, an IM credential, an IP address, etc. An identifier may include a keyword, a short code address, etc. In at least one embodiment, an identifier may include a keyword which may be included in a text message. Control is passed to operation 3120 and process 3100 continues.

In operation 3120, a determination is made as to whether a trigger action is detected. If in operation 3120 it is determined that a trigger action is not detected, control is passed to operation 3145 and process 3100 continues. If in operation 3120 it is determined that a trigger action is detected, control is passed to operation 3125 and process 3100 continues. According to an embodiment, a setting may be associated with a user that causes the trigger action when determining that the user is associated with the request received.

The determination in operation 3120 may be made based on various criteria. In at least one embodiment, a message received from a user system or device may be compared or matched to trigger actions associated with the user device in order to determine whether a trigger action is received.

In operation 3125, an advertisement is delivered. In at least one embodiment, a voice or audio connection is established between the search system 2130 (FIG. 21) and a user system such as the user system 2135. An audio advertisement may be provided to the user using a voice connection. Any type and/or number of advertisements may be delivered. Likewise, a video, image, or other media advertisement suitable for a user device may be provided to the user. Control is passed to operation 3130 and process 3100 continues.

In operation 3130, a connection is established with a provider. A connection to a provider is preferably an interactive connection. In at least one embodiment, a voice connection is established with a provider system. A call may be placed to a telephone device, and/or a VoIP connection may be established with a provider. An Instant Message and/or other type of real-time interactive communication may be established. Any communication service associated with a user system and a provider may be utilized to establish a connection. Control is passed to operation 3135 and process 3100 continues.

In operation 3135 a determination is made as to whether a connection to a user is complete. If in operation 3135 it is determined that a connection to a user is not complete, control is passed to operation 3135 and process 3100 continues. If in operation 3135 it is determined that a connection to a user is complete, control is passed to operation 3140 and process 3100 continues.

The determination in operation 3135 may be based on various criteria. For example, a search system may monitor a connection as described herein with respect to FIG. 29, a provider may indicate to a search system that a connection is complete, or a time period may expire, etc.

In operation 3140, an advertisement is delivered. In at least one embodiment, a voice connection is established between the search system 2130 (FIG. 21) and a user system such as the user system 2135. A messaging advertisement such as an SMS, EMS, MMS or IM advertisement may be delivered to a user. An audio advertisement may be provided to the user using a voice connection. Any type and/or number of advertisements may be delivered to a user in operation 3140. Likewise, a video, image, text and/or other media advertisement suitable for a user device may be provided to the user. Control is passed to operation 3145 and process 3100 continues.

In operation 3145, process information is recorded. For example, the database 2120 (FIG. 21) may be updated to indicate actions by a user, a provider, and/or a search service. An indication of success and/or failure of a connection, a transaction, a provider, etc., may be recorded. For example, if a provider has successfully connected to a user, compensation due to a search system providing a connection may be recorded, a rating of a provider may be increased if the provider successfully met a user request, a permission of a user may be reduced if a user makes a connection which has a short duration and/or is rated poorly by a provider and/or merchant. Any information regarding the process 3100 may be recorded. Control is passed to operation 3105 and process 3100 continues.

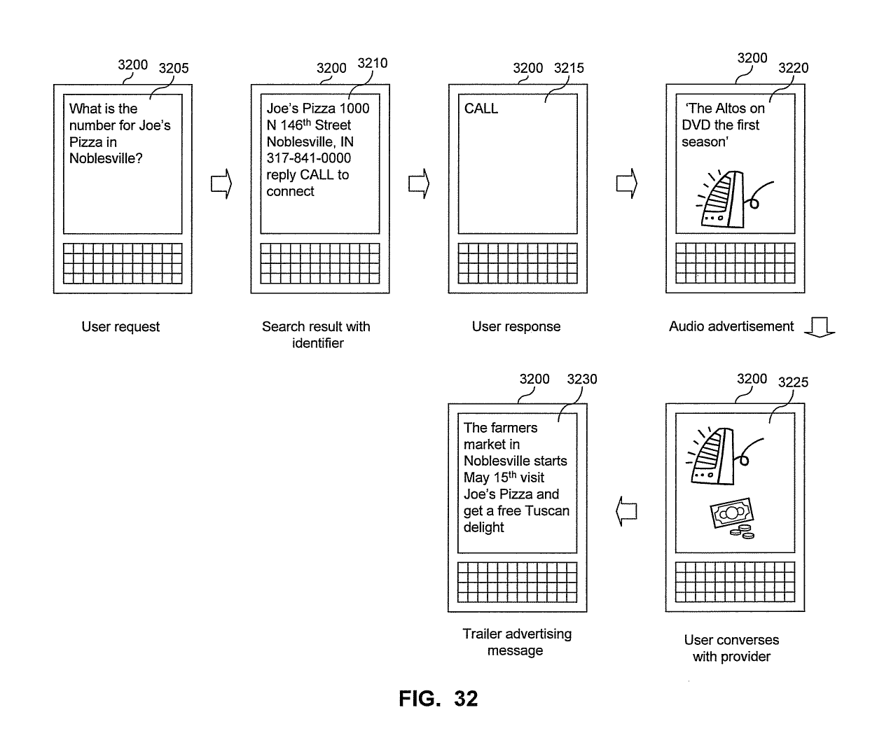

An exemplary sequence of messages which may establish a connection between a user system and a provider system is illustrated in FIG. 32. While a specific example of text or SMS messaging and a voice connection is used for the purposes of illustration, no limitation is implied thereby. Any type of messaging service, and any type of interactive communication service may be used. A connection may be established which delivers advertisements to a user responsive to a request for connection assistance. A user is connected to a provider responsive to a user determination that a connection is to be made. Responsive to the request, a number of advertisements are delivered to a user, and the user is connected to a provider designated by the user. The response indicated may persist for any length of time, as a trigger action associated with a user.

The user device 3200 may transmit the connection assistance message 3205. The connection assistance message 3205 may be routed via the message routing system 2150 (FIG. 21) to the search system 2130. The search system 2130 may respond with the search result message 3210 (FIG. 32) which may include an indicator regarding how a connection to a provider may be established. For example, the keyword CALL may be used to indicate the desire to establish a voice connection. A user may reply with the trigger action message 3215 which may initiate a voice connection between the user device 3200 and the search system 2130 (FIG. 21) and/or an advertiser system such as the advertiser system 2165. The search system 2130 and/or an advertiser system may provide an advertisement. For example an audio advertisement such as the audio advertisement 3220 (FIG. 32) may be provided to a user device prior to establishing a voice connection between a user system and a provider system.

The search system 2130 (FIG. 21) may establish a voice connection to a provider. In at least one embodiment, a conversation message such as an audio conversation may occur between a user and a provider. For example, the conversation message 3225 (FIG. 32) may allow a transaction or activity to occur between a user and a provider. Subsequently the search system 2130 (FIG. 21) may establish a connection with the user device 3200 (FIG. 32) based on the caller information obtained from the connection assistance message 3205, for example. An advertisement such as the trailer advertising message 3230 may be delivered to the user system 3200 before, during, and/or after a connection between a user and a provider. In at least one embodiment, an SMS based advertisement may be delivered to a user system subsequent to completion of a voice connection of a user system and a provider system.

Using the method and systems disclosed herein, a real time communication session may be established between a user system and a provider system responsive to content of a message provided by a user system. In at least one embodiment, a message is transmitted to a user system responsive to a request for information which includes information of a keyword and/or other message content which may be used to initiate a voice connection to a provider responsive to a message including the specified information. Using the system, a user may receive information of a provider in an SMS message and may initiate a phone call between the user and a provider of a product and/or service advertised in the message. Connection information may be provided using electronic and/or traditional media.

The system and method allow an advertiser to connect with users of a text based mobile search system without having to obtain a significant toll-free number which is easily remembered. Using a simple keyword a user may respond to an advertisement simply and directly, regardless of the age of the advertisement message. It is not necessary for a user to remember a URL or phone number. An advertiser may advertise locally, regionally and/or nationally while offering a local connection without the cost of routing calls locally. As the response may be a few letters, which may be a significant word, a user may respond to a text advertisement as easily as clicking on a hyper link in a browser. Likewise, brand image for a local business may be improved by association with significant, memorable keywords. Because a response is readily traceable to an advertisement, advertising efficiency may be more effectively measured.

A user may be afforded access to more services more easily. If a user device and/or data package does not support internet browsing with a small screen and limited keypad, simple text messaging may be a highly effective means for locating a supplier of a product or service and readily contacting the provider by a voice connection. A human assistant may be provided which may allow a user to obtain a product and/or a service. A human assistant may provide selection and product information, and pass a user to a live assistant and/or automated system for processing sensitive (or secure) user information which may be required to complete a transaction.

The method and system affords the ability to anonymously connect between a user and a provider. As such the provider may not be a specific provider of a product or service. Revenue for a search service may be increased as providers compete for the opportunity to be connected to customers who have indicated intent to purchase a product and/or service.

While the system has been described in the context of an information search system, other forms of advertising might utilize the same system. For example, a billboard, television advertisement, and/or other information display might provide information of a keyword which might be transmitted to connect with a provider of products or services.

Using the methods and systems described herein users of search services are able to exchange targeted messages on a demand basis. Social messages may be exchanged without unwanted clutter. As attention is given on a demand basis, users are less likely to be subjected to ‘spam’ or nuisance messaging.

As the messaging is a form of premium communication, a benefit may be provided to the recipient of a message. For example, access to services, software, or other forms of compensation (or credit) may be provided to a target user in conjunction with a personal message.

Targeted personal advertising which is intended for persons meeting specified criteria may be delivered. A user is provided with the ability to create and direct the distribution of a message. A response mechanism is provided whereby recipients may selectively communicate with an originator of a personal advertisement.

A system is provided whereby a user may receive targeted personal messages or personal ads when accessing a publishing service such as a search system. A user may deliver personal advertisement(s) such as employment, sales, etc. to a targeted group of users. A user originating a personal advertisement may remain anonymous to a recipient, or may reveal selected identifying information of the originating user to the recipient. A recipient may receive a benefit for accepting a message. A recipient may determine a threshold for compensation required to communicate with the recipient. The new system may be utilized in a web, mobile, email, IM and/or mixed media publishing environment.

A publisher may augment advertising revenues by use of premium messages which take priority over other advertisements. A user may provide compensation to another user by delivery of an advertising message.

Any or all of the operations described herein may be implemented via one or more hardware components. However, the present invention is not limited to any specific implementation of an operation. For example, one or more operations discussed herein may be implemented via software executed on a device while others may be executed via a specific hardware device.

According to an embodiment, the present invention may be implemented using a program stored, for example, in a computer-readable storage medium such as a CD-ROM, etc., or using one or more specialized terminals, devices or systems that is enabled to execute operation(s) described herein. The storage or recording medium used in an embodiment can be selected from among various persistent computer-readable media including, a disk, a DVD, an internal storage device (memory such as RAM or ROM) in a computer, etc.

As mentioned above, the embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

Further, according to an aspect of the embodiments, any combinations of the described features, functions and/or operations can be provided.

The many features and advantages of the claimed invention are apparent from the detailed specification and thus, it is intended by the appended claims to cover all such features and advantages of the claimed invention that fall within the true spirit and scope of the invention. Further, since numerous modifications and changes will readily occur to those skilled in the art, it is not desired to limit the invention to the exact construction and operation illustrated and described for the disclosed embodiments, and accordingly all suitable modifications and equivalents may be resorted to, falling within the scope of the claimed invention. It will further be understood that the phrase “at least one of A, B and C” may be used herein as an alternative expression that means “one or more of A, B and C.”

What is claimed is:

1. A method of delivering personalized advertising, comprising:
receiving a message for delivery from an originator; and
triggering the delivery of the message to a recipient in response to receiving a request from the recipient.

2. The method of claim 1, comprising:
receiving information of the message to be delivered to the recipient from the originator;
selecting the message from a plurality of advertisements available for the recipient based on the information of the message from the originator; and
providing the message and the response to the request to the recipient when the request is received.

3. The method of claim 1, wherein the message is targeted to the recipient and the message is delivered to the recipient when accessing a search related service.

4. The method of claim 1, wherein the message includes an anonymous identifier of the originator used to establish communication with the originator.

5. The method of claim 1, comprising:
receiving targeting information for the message; and
selecting the recipient based on a ranking of the recipient associated with the targeting information excluding content of the request.

6. The method of claim 1, comprising;
selecting the message based on a ranking of the message including only messages from originators purchasing less than a pre-determined number of messages.

7. The method of claim 5, comprising:
reviewing content of the message by a human guide; and
determining whether to deliver the message based on the review.

8. The method of claim 5, comprising:
receiving information of a compensation amount associated with the message;
assigning the compensation amount to the recipient.

9. The method of claim 1, wherein the recipient is the originator.

10. The method of claim 5, wherein the targeting information is location information and the message is location sensitive.

11. The method of claim 5, wherein the information of the message is provided using an SMS message from the originator.

12. The method of claim 5, comprising:
providing a message to the originator when the message is provided to the recipient;
determining whether the recipient has taken an action indicated in the message; and
establishing an anonymous communication session between the originator and the recipient based on the action.

13. The method of claim 5, comprising:
selecting the message based on a ranking of the message including only messages from originators purchasing less than a pre-determined number of messages;
reviewing content of the message by a human guide;
determining whether to deliver the message based on the review;
receiving information of a compensation amount associated with the message;
assigning the compensation amount to the recipient;
obtaining location information as part of the targeting information;
evaluating whether the recipient has sufficient accrued compensation to receive the response;
delivering the response based on the evaluation result;
indicating an SMS message response including the keyword as the action;
establishing a voice communication session responsive to the action; and
assigning the compensation amount to the recipient based on a response of the recipient.

14. A system, comprising:
a search system receiving information of a message, selecting a recipient, and providing the message to the recipient;
an originator device providing information of the message and information for selection of the recipient; and
a recipient device providing a request and receiving the message and a response to the request.

15. The system of claim 14, comprising:
a guide device receiving the message, providing the response and reviewing the message; and
a database including recorded information of the originator device, the guide device and the recipient device.

16. A persistent computer readable medium storing therein a program for causing a computer to execute an operation including delivery of a personal advertisement, comprising:
receiving a request;
identifying a user submitting the request;
selecting a personal advertisement targeted to the user; and
providing the personal advertisement to the user.

17. The computer readable medium of claim 16, comprising:
preferentially selecting the personal advertisement from among a plurality of advertisements including generic advertisements; and
selecting the personal advertisement based on a ranking of the user for the personal advertisement.

18. The computer readable medium of claim 16, comprising:
associating a monetary value with a provider of the personal advertisement;
linking an action to the monetary value;
correlating the action with the user;
establishing whether the user has performed the action; and
crediting the monetary value to the user based on the establishing.

19. The computer readable medium of claim 16, comprising:
associating a profile with the advertisement; and
choosing the user based on the profile.

20. The computer readable medium of claim 19, comprising:
associating geographic information with the profile;
associating an affiliation with the profile;
associating a keyword with the advertisement; and
choosing the user based on the keyword.

21. The computer readable medium of claim 16, comprising:
providing an instruction with the personal advertisement;
discerning whether the instruction has been followed;
providing a notification to an address associated with the personal advertisement based on the discerning;
receiving a broadcast message; and
delivering the broadcast message to a plurality of users based on the instruction.

22. The computer readable medium of claim 16, comprising:
preferentially selecting the personal advertisement from among a plurality of advertisements including generic advertisements;
selecting the personal advertisement based on a ranking of the user for the personal advertisement;
associating a monetary value with a provider of the personal advertisement;
linking an action to the monetary value;
correlating the action with the user;
establishing whether the user has performed the action;
crediting the monetary value to the user based on the establishing;
associating a profile with the advertisement;
choosing the user based on the profile;
associating geographic information with the profile;
associating an affiliation with the profile;
associating a keyword with the advertisement;
choosing the user based on the keyword;
providing an instruction with the personal advertisement;
discerning whether the instruction has been followed;
providing a notification to an address associated with the personal advertisement based on the discerning;
receiving a broadcast message;
delivering the broadcast message to a plurality of users based on the instruction; and
providing information of the personal advertisement, the profile, and the broadcast message to a system administrator;
verifying by the administrator that the personal advertisement, the profile and the broadcast message are accepted; and
delivering a report to the address based on the verifying.
